(19) United States
(12) Patent Application Publication
(10) Pub. No.: US 2023/0355032 A1
(43) Pub. Date: Nov. 9, 2023

(54) APPLIANCE WITH MODIFIED PROPORTIONAL-INTEGRAL CONTROL

(71) Applicant: Spectrum Brands, Inc., Middleton, WI (US)

(72) Inventors: Noah C. Pulvermacher, Madison, WI (US); Benjamin M. Cleppe, Verona, WI (US); Drew W. Heidenreich, Monona, WI (US); Sean P. Holinka, Madison, WI (US); Jacob D. Smith, Monona, WI (US); Maciej Murzynski, Verona, WI (US); Grant T. Oberhauser, Madison, WI (US); Firdaus S. Nandoliya, Verona, WI (US); David W. Everett, Verona, WI (US)

(21) Appl. No.: 18/029,296

(22) PCT Filed: Sep. 28, 2021
(86) PCT No.: PCT/US2021/052320

§ 371 Date: Mar. 29, 2023

Related U.S. Application Data
(60) Provisional application No. 63/149,517, filed on Feb. 15, 2021.
(60) Provisional application No. 63/084,826, filed on Sep. 29, 2020.

(51) Int. Cl. A47J 36/32; A47J 27/00

(52) U.S. Cl. CPC A47J 36/32; A47J 27/004; A47J 2202/00

(57) ABSTRACT

An electrical appliance includes a controller operatively connected to a power circuit, a control circuit, a power source, a sensor for sensing a parameter level, and an active element. The controller is configured to receive an input of the parameter level from the sensor and to output a duty cycle for controlling a power level of the active element via the control circuit at various times to achieve a target set point of the parameter, the duty cycle based on proportional and integral control. The controller uses the proportional control and the integral control when the control circuit is energized, and accumulates integral error only when a parameter process variable sensed by the sensor is determined to be within an interval of the target set point.

### CROSS REFERENCE TO RELATED APPLICATIONS

This application claims priority to and the benefit of U.S. Provisional Patent Application No. 63/084,826, filed Sep. 29, 2020, and U.S. Provisional Patent Application No. 63/149,517, filed Feb. 15, 2021, the entire contents of which are incorporated herein by reference in their entireties.

### FIELD

The present application relates to electric appliances, and more particularly to electric appliances that include improved control schemes that utilize direct or indirect variable feedback from one or more variable that is measured and controlled.

### BACKGROUND

Cooking appliances come in various configurations and types, and can be powered by electricity in domestic or commercial settings. Some types of cooking appliances include slow cookers, roasters, fryers, grills, steamers, and the like. Some cooking appliances, such as multi-cookers, can provide functionality of one or more cooking appliance types in a single appliance, and can incorporate heating control functionality that permits specialized cooking aspects. In some cases, accessories and/or parts are exchanged while using a multi-purpose heating unit, power unit, and/or control unit.

In existing arrangements, temperature feedback can be achieved using a temperature-sensing probe inserted into a cooking chamber that can help a controller sense and cook a food product, such as a protein or meat product, by comparing a desired cook temperature of the food product with the actual temperature of the food product up until the desired temperature is achieved. Moreover, controllers can comprise cooking mode instructions, such as saved in memory along with a microprocessor, that control power to one or more heating elements in order to get the food up to the desired temperature and/or to control the time period of the cooking with either a set temperature, such as low, medium, or high. Slow cookers, for example, typically control heat at one of three settings for a desired cooking period. Controllers have been developed so that a slow cooker may revert to a low or warm mode after a desired cooking period at a selected temperature has been attained. It is known that control of electrical appliances can use various control schemes, but each typically has one or more drawbacks.

Furthermore, existing electrical appliances, and in particular cooking appliances, have required the sensing probe to be a separate sensor located externally to the appliance housing, creating additional complexity and steps for a user desiring to heat a food product. Existing cooking appliances without probes exist, but are limited to preset cooking programs that are restricted to a set time, set temperature, or some approximation of a desired cooking program without closed-loop control that senses a status of the food product being heated. Therefore, there is a desire for a control setup for a cooking appliance that utilizes internal or indirect temperature sensing to the appliance housing which offering benefits of direct probe-based heat sensing, including without the introduction or utilization of such a direct probe.

There is also a desire for improvement to appliances and devices that include control of motors and/or other active elements.

### SUMMARY

The present application relates to improved control schemes for appliances such as cooking appliances that can cook in any of a variety of cooking modes and settings, and more particularly to an electric cooking appliance with indirect temperature sensing and control. Controllers for such cooking appliances are also contemplated. For example, a food product being cooked or submerged within a liquid by which the food product is heated according to a modified proportional-integral or proportional-integral-derivative control scheme that can automatically compensate for changes in the system.

The present invention also relates to improved control for cooking appliances that have multiple cooking modes that are based on user selected choices, including the cooking mode and the desired doneness or temperature of the food product to be cooked. Preferably, plural cooking modes are provided to be selected that provide temperature feedback information without the use of an external, direct-sensing probe inserted into a cooking vessel. A control module can be mounted to the cooker and programmed to control the multiple cooking modes and the internal temperature sensor can be operatively connected to the control module to provide sensed temperature data for use in the various cooking modes. Preferably, the cooking modes without a direct sensing probe include the heating of a cooking vessel within the cooker for heating the food product or a liquid within the cooking vessel to a desired temperature and to permit the user greater flexibility in cooking options and to vary option at time during the cooking processes. Moreover, the cooking modes preferably also provide functionality to control the cooking processes after a selected temperature is attained.

Described herein are also examples of improved proportional-integral (PI) and proportional-integral-derivative (PID) control that address the shortcomings of existing proportional, PI, and PID control schemes. In short, presented herein are improved PI/PID control schemes that selectively either accumulate or do not accumulate integral error during appliance operation in order to reap the benefits of PI/PID control while addressing the integral wind-up drawback of PI/PID control, while also addressing the steady state error offset drawback of proportional control schemes. By utilizing the improved PI/PID control, a temperature can beneficially maintain a narrow range of temperature (or other set variable) control without the complexity of an external probe being introduced into the cooking vessel.

Aspects of the invention described herein are directed in particular to modular cooking appliances with improved PI control that are designed to reduce production cost while having maximum functionality and easy-to-clean parts by an end user. An example cooking appliance can be a multi-cooker that includes a single bowl that can be easily cleaned in contrast to existing multi-cookers. Digital or mechanical control components, and associated heating controls that interface with an internal temperature sensor, e.g., a negative temperature coefficient (NTC) resistor/thermistor, are contemplated. Manual or automatic inputs are also contemplated. Various cooking modes and settings are contemplated. Furthermore, various digital displays can be used, or a simple knob or dial can be utilized.

The example cooking appliances can include separable parts that allow for cleaning or washing some parts only without affecting others. A passive cooking vessel and active power and control units can be completely separated so that the cooking vessel, which includes a bowl unit (e.g., a pot) and a base unit, can be submersible and easily washed without exposing control or power components to liquids during cleaning. Therefore, various parts of the modular cooking appliance can be completely conveniently immersed in liquid or placed in a dishwasher for cleaning. In some aspects, the heating controls can be removable from the cooking vessel using a friction-connected probe or a control module that is entirely removable from the cooking vessel as a unit using fasteners. For example, the temperature sensor located internally to the cooking appliance can be separate or separable from the cooking vessel to allow for easy cleaning and the like.

Other types of appliances and more general electrical devices, including appliances that incorporated electric motors and other types of electrically powered and controlled active elements are also contemplated herein.

According to a first aspect of the present invention, an electrical appliance is disclosed. According to the first aspect, the electrical appliance includes a controller operatively connected to a power circuit, a control circuit, a power source, a sensor for sensing a parameter level, and an active element. Also according to the first aspect, the controller is configured to receive an input of the parameter level from the sensor and to output a duty cycle for controlling a power level of the active element via the control circuit at various times to achieve a target set point of the parameter, the duty cycle based on proportional and integral control. And also according to the first aspect, the controller uses the proportional control and the integral control when the control circuit is energized, and accumulates integral error only when a parameter process variable sensed by the sensor is determined to be within an interval of the target set point.

According to a second aspect of the present invention, a controller for use with an electrical appliance is disclosed. According to the second aspect, the controller includes a processor operatively connected to a memory. According to the second aspect, the controller is operatively connected to a power circuit, a control circuit, a power source, a sensor for sensing a parameter level, and an active element. The controller is also configured to receive an input of the parameter level from the sensor and to output a control signal for controlling a power level of the active element at various times via the control circuit to achieve a target set point of the parameter, the control signal output based on proportional and integral control. Still according to the second aspect, the controller uses the proportional control and the integral control when the control circuit is powered on, and accumulates integral error only when a process variable sensed by the sensor is determined to be within an interval of the target set point.

According to a third aspect of the present invention, a method of controlling an electrical appliance is disclosed. According to the third aspect, the method includes receiving an input of a parameter level from a sensor. The method also includes outputting a control signal for controlling a power level of an active element at various times via the control circuit to achieve a target set point of the parameter, the control signal output based on proportional and integral control. The method also includes accumulating integral error only when a parameter process variable sensed by the sensor is determined to be within an interval of the target set point. The method also includes controlling the active element based on at least the accumulated integral error to approach the target set point of the parameter.

According to a fourth aspect of the present invention, an electrical heating appliance. According to the fourth aspect, the electrical heating appliances includes a controller operatively connected to a power circuit, a control circuit, a power source, a sensor for sensing a parameter level, and an active element. Also according to the fourth aspect, the controller is configured to receive an input of the temperature level from the sensor and to output a control signal for controlling a power level of the heating element at various times via the control circuit to achieve a target set point of the temperature, the control signal output based on proportional and integral control. Still according to the fourth aspect, the controller uses the proportional control and the integral control when the control circuit is powered on, and accumulates integral error only when a temperature process variable sensed by the sensor is determined to be within an interval of the target set point temperature.

According to a fifth aspect of the present invention, an electrical appliance is disclosed. The electrical appliance includes a controller operatively connected to a power circuit, a control circuit, a power source, a sensor for sensing a parameter level, and an active element. According to the fifth aspect, the controller is configured to receive an input of the parameter level from the sensor and to output a duty cycle for controlling a power level of the active element at various times via the control circuit to achieve a target set point of the parameter, the duty cycle based on proportional and integral control. Still according to the fifth aspect, the controller uses the proportional control and the integral control when the control circuit is energized, and accumulates integral error only when a parameter process variable sensed by the sensor is determined to be within an interval of the target set point. Yet still according to the fifth aspect, the controller controls the power source at a loop iteration time that is shorter than a cycle time of the duty cycle.

According to a sixth aspect of the present invention, an electrical appliance is disclosed. According to the sixth aspect, the electrical appliance includes a controller operatively connected to a power circuit, a control circuit, a power source, a sensor for sensing a parameter level, and an active element. According to the sixth aspect, the controller is configured to receive an input of the parameter level from the sensor and to output a power level to the active element corresponding to a target rotational speed for controlling a power level of the active element via the control circuit at various times to achieve a target set point of the parameter, the power level based on proportional and integral control. Still according to the sixth aspect, the controller uses the proportional control and the integral control when the control circuit is energized, and accumulates integral error only when a parameter process variable sensed by the sensor is determined to be within an interval of the target set point.

According to a seventh aspect of the present invention, an electrical device is disclosed. According to the seventh aspect, the electrical device includes a controller operatively connected to a power circuit, a control circuit, a power source, a sensor for sensing a parameter level, and an active element. Also according to the seventh aspect, the controller is configured to receive an input of the parameter level from the sensor and to output a control signal to the active element corresponding to a target set point of the parameter level for controlling a power level of the active element via the control circuit at various times to achieve the target set point of the parameter, the power level based on proportional and integral control. Still according to the seventh aspect, the controller uses the proportional control and the integral control when the control circuit is energized, and accumulates integral error only when a parameter process variable sensed by the sensor is determined to be within an interval of the target set point.

According to an eighth aspect of the present invention, an electrical appliance is disclosed. According to the eighth aspect, the electrical appliance includes a controller operatively connected to a power circuit, a control circuit, a power source, a sensor for sensing a parameter level, and an active element. Also according to the eighth aspect, the controller is configured to receive an input of the parameter level from the sensor and to output a control signal for controlling a power level of the active element at various times via the control circuit to achieve a target set point of the parameter, the control signal based on proportional and integral control. Still according to the eighth aspect, the controller controls the power source at a loop iteration time that is shorter than a cycle time of the duty cycle.

These and various other features and advantages will be apparent from a reading of the following detailed description.

### BRIEF DESCRIPTION OF THE DRAWINGS

The present invention will be further explained with reference to the appended Figures, wherein like structure is referred to by like numerals throughout the several views, and wherein:

FIG. 1 is a partially exploded perspective view of a slow cooker appliance including a temperature probe that is usable with multiple cooking modes, according to various embodiments of the present invention.

FIG. 2 is a front view of the slow cooker of FIG. 1 with a control module mounted on a front surface of a cooker body, according to various embodiments.

FIG. 3 is a front view of the control module showing the various control buttons, display, and indicator lights that are associated with various cooking modes of the present invention.

FIG. 4 is an illustration of a process for the control module that can be used when cooking with the temperature probe.

FIG. 5 is a chart showing the various factors and variables that are relied upon within the process of FIG. 4.

FIG. 6 is a table containing certain constants that are also relied upon within the process of FIG. 4, which are based upon the cooking mode and temperatures selected by a user.

FIG. 7 is a lookup table for integral constant versus temperature setting for use with the process of FIGS. 4-6, according to various embodiments.

FIG. 8 is an example polynomial function for determining the integral constant, according to various embodiments.

FIG. 9 is a more detailed view of a selection of the process of FIG. 4, according to various embodiments.

FIG. 10 is a chart showing temperature versus time for an example appliance configured to use the process of FIG. 4, according to various embodiments.

FIG. 11 is a chart showing improvements to overshoot in proportional-integral control according to the process of FIG. 4, according to various embodiments.

FIG. 12 is a front perspective view of an embodiment of a modular cooking appliance, according to various embodiments.

FIG. 13 is a top perspective view of the modular cooking appliance of FIG. 12, according to various embodiments.

FIG. 14 is a bottom perspective view of the modular cooking appliance of FIG. 12, according to various embodiments.

FIG. 15 is a top perspective view of a bowl unit of the modular cooking appliance of FIG. 6, according to various embodiments.

FIG. 16 is a bottom perspective view of a bowl unit of FIG. 15, according to various embodiments.

FIG. 17 is a top perspective view of a lid of the modular cooking appliance of FIG. 12, according to various embodiments.

FIG. 18 is a top perspective view of a base unit of the modular cooking appliance of FIG. 12, according to various embodiments.

FIG. 19 is a bottom perspective view of the base unit of FIG. 18, according to various embodiments.

FIG. 20 is a top reverse perspective view of the modular cooking appliance of FIG. 12 with certain components removed to reveal the base unit of FIG. 18 shown in combination with a control unit knob and a heating unit, according to various embodiments.

FIG. 21 is a perspective view of a removable analog control unit shown with a heating unit for use with the modular cooking appliance of FIG. 12, according to various embodiments.

FIG. 22 is a perspective view of a removable digital control unit shown with a heating unit for use with the modular cooking appliance of FIG. 12, according to various embodiments.

FIGS. 23A and 23B are cross-section views of an example modular cooking appliance, showing internal temperature sensing options, according to various embodiments.

FIG. 24 is a top perspective view of an alternative embodiment of a modular cooking appliance, according to various embodiments.

FIG. 25 is a bottom perspective view of the modular cooking appliance of FIG. 24, according to various embodiments.

FIG. 26 is a front perspective view of the modular cooking appliance of FIG. 24 with a probe unit removed, according to various embodiments.

FIG. 27 is a top perspective view of a probe unit for use with the modular cooking appliance of FIG. 24, according to various embodiments.

FIG. 28 is a reverse top perspective view of a base unit, probe unit, and heating unit for use with the modular cooking appliance of FIG. 24, according to various embodiments.

FIG. 29 shows an example control scheme similar to FIG. 4, adapted for use in a sous-vide slow cooker embodiment as described herein.

FIG. 30 is a chart showing the various factors and variables that are relied upon within the process of FIG. 29, according to various embodiments.

FIG. 31 shows a negative temperature coefficient contact position for a removable plate contact grill, according to various embodiments.

FIG. 32 shows another negative temperature coefficient measurement location for a removable probe surface grill, according to various embodiments.

FIG. 33 shows an example graph illustrating various damping levels, according to various embodiments.

FIG. 34 shows example temperature feedback for an iron, according to various embodiments.

FIG. 35 is an illustration of a process for to control module that can be used when using a mixer, according to various embodiments.

FIG. 36 is an example flow-through heater, according to various embodiments.

FIG. 37 is an example resistance vs. temperature chart for a PTC resistor, according to various embodiments.

FIG. 38 is a schematic view of an example DC motor, according to various embodiments.

FIG. 39 is circuitry for measuring a motor speed using commutation power spikes, according to various embodiments.

FIG. 40 shows measured tachometer rate vs. commutator spike rate for measuring a motor speed using commutation power spikes, according to various embodiments.

FIG. 41 shows performance of PID control to a set point with various disturbances while measuring a motor speed using commutation power spikes, according to various embodiments.

FIG. 42 shows a conventional temperature control scheme compared graphically to an example PID temperature control scheme contemplated herein.

FIGS. 43-47 show various examples of “bang-bang” control, with and without dead band.

FIGS. 48 and 49 show an example of duty cycle used to turn a discrete output into a continuous output is shown, according to various embodiments.

FIGS. 50 and 51 illustrate the proportional term of PID control in additional detail, according to various embodiments.

FIGS. 52 and 53 illustrate the illustrate term of PID control in additional detail, according to various embodiments.

FIGS. 54 and 55 illustrate the derivative term of PID control in additional detail, according to various embodiments.

FIG. 56 shows continuous and discrete equations for PID temperature control, according to various embodiments.

FIG. 57 shows a correspondence between an actual measured temperature and a set temperature in an example modular cooker, according to various embodiments.

FIG. 58 shows a comparison of water temperature vs. time for a cooking appliance where a loop time is either equal to or less than a cycle time.

### DETAILED DESCRIPTION

The methods and features described herein are applicable to appliances and other electrical devices. Like components are labeled with like numerals throughout the several figures.

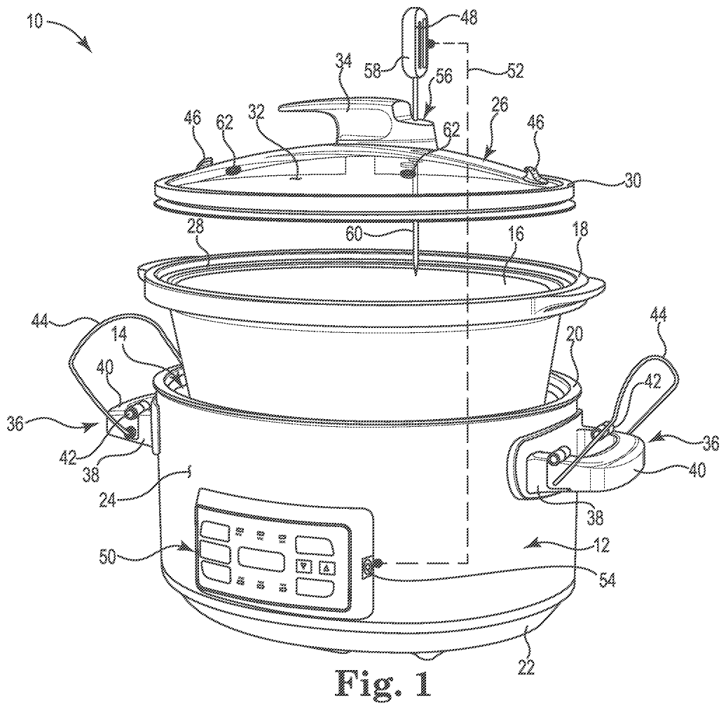

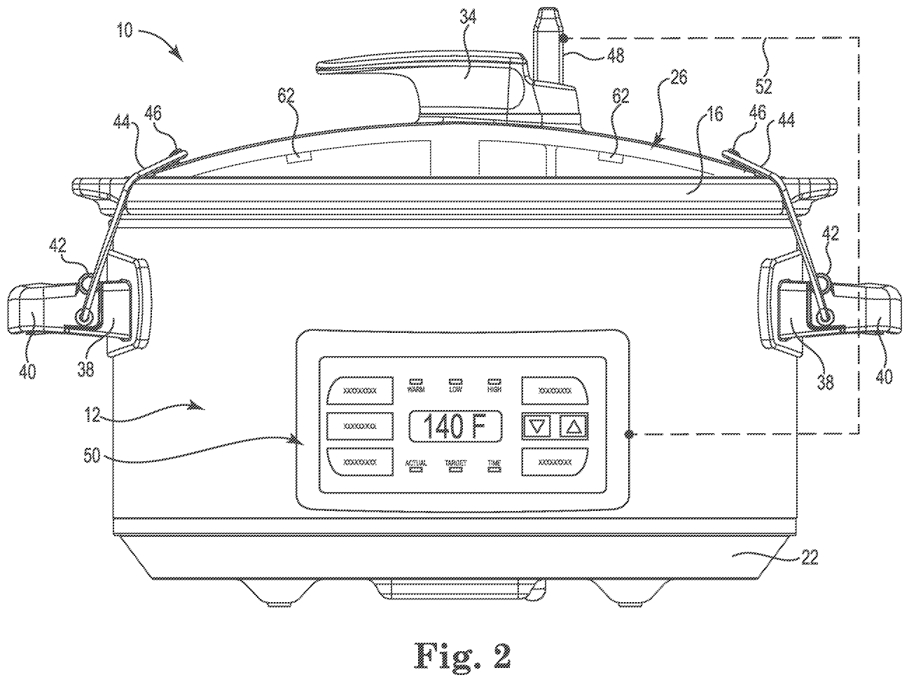

Disclosed is an example of an electrical appliance, a slow cooker 10 as shown in FIGS. 1 and 2 having a cooker body 12 creating an internal cavity 14 within which a heating element (not shown) is provided for heating the internal cavity 14 and where a direct temperature sensing probe 48 can be utilized in various examples. A cooking vessel 16 is removably positioned within the internal cavity 14 as such can be conventionally supported relative to the heating element so that the cooking vessel 16 heats up to heat food as provided within the cooking vessel 16 for cooking. The cooking vessel 16 preferably includes a perimetric flange 18 that sits on top of an upper edge 20 of the cooker body 12 to position the cooking vessel 16 above the heating element. The slow cooker 10 can incorporate any proportional-integral, proportional-integral-derivative, or any other control schemes described herein.

Referring still to the slow cooker 10, the cooker body 12 can be conventionally constructed as having a base portion 22 and a sidewall portion 24 that creates the internal cavity 14. The sidewall portion 24 preferably comprises an outer shell as can be composed of plastic, stainless steel, other metals, ceramic or the like that is designed for decorative and cleaning purposes. The sidewall portion 24 is also preferably insulated so that heat transferred to the cooking vessel 16 is not also transferred to the external surface of the sidewall portion 24. An inner surface of the sidewall portion 24 defines the size and shape of the internal cavity 14.

The slow cooker 10 also comprises a lid 26 that sits, in the illustrated embodiment, within a recess 28 of the cooking vessel 16 for closing the cooking vessel 16 during cooking. The lid 26 preferably is composed of a frame 30 that is connected with a transparent cover 32 that can be arranged in any number of different designs. A transparent cover 32 can comprise glass, plastic, or the like so that food can be seen as it is being cooked. A handle 34 is also preferably provided as connected with the frame 30 for grasping of the lid 26.

The lid 26 is also preferably latched to the cooker body 12 so that the slow cooker 10 is portable without spilling of food as can be moved during cooking or afterwards such as for serving the cooked food at a different location from cooking. In the illustrated embodiment, cooker body handles 36 can be provided as secured to the cooker body 12 at opposed locations for providing such portability. Specifically, a fixed handle portion 38 can be secured to the cooker body 12 that is pivotally connected with a movable handle portion 40 by way of pivot axle 42. Each movable portion 40 also preferably includes a bail 44 that is pivotally connected with the movable portion 40 to loop over and grasp a hook portion 46 of the lid frame 30 when the movable portion 40 is pivoted upwards. The connection of the bail 44 with the movable portion 40 is arranged so that when the movable portion 40 is moved to a lower position (as in FIG. 2) the bail 44 is sufficiently springy to act as an over center spring latch mechanism for creating a bias and holding the lid 26 to the cooker body 12. Upward movement of the movable portion 40 releases the latch mechanism.

The lid 26 also can accommodate the use of a direct temperature sensing probe 48. The direct temperature sensing probe 48, if utilized, can be operatively connected with a control module 50 (e.g., a controller), such as shown on a front side of the cooker body 12 of the slow cooker 10. Electrical connection and/or data transmission connection can be provided by a communication link 52 as shown as a dashed line within FIGS. 1 and 2. Preferably the communication link 52 simply comprises an electrical cord that provides sensed temperature information from the temperature probe 48 to the control module 50 so that the direct temperature probe 48 and communication link 52 can act as a feedback circuit for the control module 50. With an electrical cord as the communication link 52, it is preferable that one or both ends of the cable comprise insertable plugs (not shown) that are received within a complementary jack 54 as shown in FIG. 1. Alternatively, the communication link 52 can comprise a wireless connection, such as utilizing Bluetooth or Wi-Fi (e.g., 802.11), Li-Fi technology or other known or developed wireless standards or links, including near-field communication (NFC) or infrared radiation (IR). Various cooking modes can be supported by the provision of such actual sensed temperature information from the temperature probe 48 as will be discussed in greater detail below. Whatever communication link 52 is used, what is important is that the sensed temperature information, in whatever form, is provided to the control module 50.

In order to accommodate the temperature sensing probe 48, the lid 26 can comprise any number of openings through the lid 26. In other embodiments no probe 48 is used that passes through the lid 26, and a temperature sensor is instead internal to cooker 10 and proximate to cooking vessel 16. If used, such a probe 48 may comprise a handle portion 58 fixed with an extension element 60 having a temperature sensor (not shown) near its tip as such temperature probes themselves are well known. One such opening 56 is shown provided through a portion of the lid handle 34. The opening 56 preferably is sized and shaped to accommodate passing of the extension element 60 without allowing significant passage of gases or liquids from the cooking vessel 16 during cooking. An elastic or flexible component (not shown), such as a rubber grommet or O-ring, can be provided for such purpose. By providing the opening 56 at the lid handle 34, a central location for the probe 48 to extend into the cooking vessel 16 is made. The probe 48 preferably has a length of its extension element 60 based upon the positioning of the direct temperature sensor within liquid or solid food during a cooking operation. For example, the tip of the probe extension element 60 having the temperature sensor could be designed to be positioned in close proximity to a bottom of the cooking vessel 16 or within a desired range of expected liquid or solid food within the cooking vessel 16.

Additional openings are also preferably provided such as shown at 62, an arrangement of such openings 62 preferably being such that the probe 48 can be inserted through the lid 26 for extending within liquid or solid food within the cooking vessel 16 at different locations and potentially different angles. Preferably, a pair of openings 62 are provided to each side of the lid handle 34 with each spaced radially similarly from the center of the lid 26. Such an arrangement allows the probe to be entered into a solid food or liquid from different angles and positioning of the food within the cooking vessel 16. Each opening 62 preferably also is sized and shaped to accommodate the extension element 60 of the probe 48 without allowing significant passage of gases or liquids from the cooking vessel during cooking. Also, an elastic or flexible component, such as a rubber grommet or O-ring, can be provided for such purpose and to allow the angle of the extension element 60 toward food within the cooking vessel 16 to be adjusted. The openings 62 can be otherwise provided in different arrangements including plural openings at differing radial spacing from the lid's center point. Plural sensors can be provided in various embodiments, including a first sensor and a second sensor (e.g., operatively connected to a controller), where the heating element is powered according to at least one of the first and second sensors.

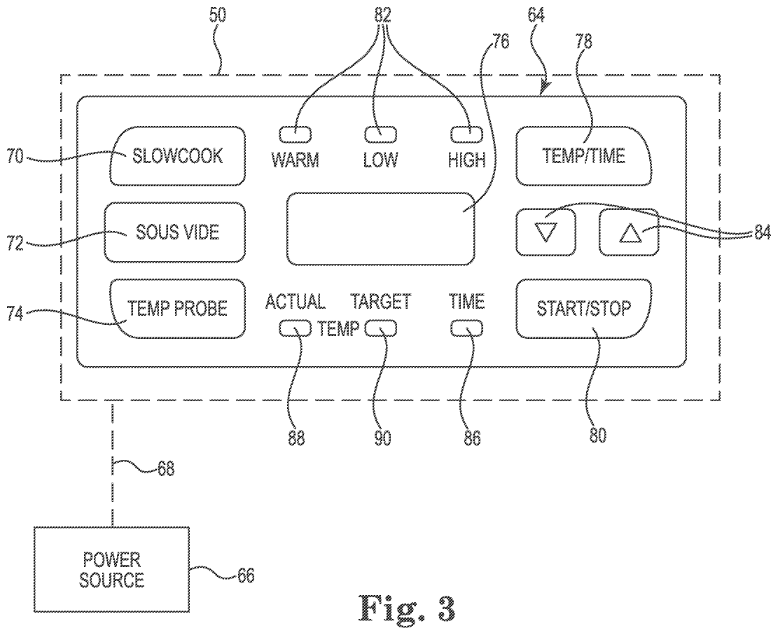

The control module 50 is preferably connected to the cooker body 12 at a front location of the slow cooker 10 as shown in FIGS. 1 and 2 for easy access of its control interface 64 by a user as schematically illustrated in FIG. 3. The control module 50 is illustrated as electrically connectible with an electric power source 66 by way of a conventional electrical connection at 68, which electrical connection could comprise a wiring harness designed for and routed within the slow cooker 10 leading to a plug for connection with line power. The control module 50 can include a hardware microprocessor and memory as operatively connected together, the memory including programming that may comprise software or firmware for controlling any number of cooking modes when executed by the processor, such as those described below.

The user interface 64 can set up any number of cooking modes, but preferably includes selection buttons 70, 72, and 74 for at least a slow cook mode, a sous-vide mode, and a direct temperature probe mode, respectively, as shown in the preferred user interface 64 of FIG. 3. Details of each of these preferred cooking modes will be described below. It is noted that the user interface 64 can utilize any known or developed manner for user selection, such as including a touchscreen, capacitive or resistive touch buttons, electrical or electro-mechanical buttons, facial and/or gesture recognition, voice recognition, or the like.

Preferably, the user interface 64 also includes a display screen 76 as can comprise light-emitting diode (LED), organic light-emitting diode (OLED), liquid crystal display (LCD), or other suitable known or developed display technology. Additional control buttons can include a toggle button 78 for temperature or time selection, a start/stop button 80, heat selection indicators 82, up and down user selection buttons 84 for choosing time or temperature depending on the toggle button 78, a time indicator 86 that is lit when a time is displayed, and temperature indicators 88 and 90 that are lit when displaying actual and target temperatures, respectively.

As noted above, the slow cooker 10 is preferably set up with operating parameters for at least a slow cooking mode, a sous-vide mode, and a direct temperature probe 48 (inserted into vessel 16) mode. Each of these modes is user selectable based upon an initial selection of one of the selection buttons. 70, 72, and 74. The sous-vide mode and the temperature probe mode each utilize the direct temperature probe 48 to provide actual sensed temperature feedback to the control module 50. The slow cooking mode is a traditional slow cooker mode.

The temperature probe mode utilizes the direct temperature sensing probe 48 as such temperature probe 48 can be inserted through one of the openings 56 or 62 and into a food product, such as a piece of meat. This allows the user to accurately gauge the internal temperature of the food product. Once the temperature is set by the user, the user can leave the slow cooker 10 and the slow cooker 10 will heat the food product to the desired temperature and hold it at that temperature until the user turns the slow cooker 10 off. One advantage is that the user only needs to set the temperature (e.g., in target temperature or doneness) and the process creates a tender finished food product with no overcooking or drying out of the food product.

More specifically, one preferred manner to operate the temperature probe (direct into vessel and/or food product) mode is described as follows. Many variations to the preferred manner are contemplated. The user will initially connect the slow cooker 10 to power upon which a default display can be provided in the display screen 76, such as a series of flashing dashes. A food product or any mixture of food products are added to the cooking vessel 16 which may or may not be positioned within the slow cooker 10. If not, the cooking vessel 16 is then positioned within the slow cooker 10. After putting the lid 26 on the cooking vessel 16, the temperature probe 48 is inserted into the food product by which cooking temperature is to be targeted, most likely a protein or meat product. The multiple locations of the holes or openings 56 or 62 allow probe positioning from a number of locations and angles.

The user would then select the direct temperature probe button 74 and the indicator light 90 (such as an LED) below target temperature will light up. The user is thus notified that the slow cooker 10 is ready for setting of the desired cooking temperature of the food product. A default temperature such as 180 degrees Fahrenheit (° F.) (82.2° C.) can be displayed and user manipulation of the up and down arrows 84 can be used to manipulate the displayed target temperature in desired increments such as one ° F. (0.55° C.) increments. A preferred temperature range for selection by the user is between 100° F. and 195° F. (37.8 and 90.6° C.). The display preferably flashes the target temperature at this time until the user sets the target temperature by pressing the stop/start button 80. After that, the LED actual temperature indicator 88 will light up as the probe is now sensing the food product actual temperature, which temperature will be displayed now and throughout the cooking process. Also, after the start/stop button 80 is pressed, a control program will be initiated and followed.

The control module 50 will continue to follow the selected control program or process (discussed in greater detail below) until the direct temperature probe 48 senses that the food product has reached the desired target temperature. The display will display the actual temperature along the way with the actual temperature indicator LED 88 lit. Once the target temperature is sensed, the slow cooker 10 will switch to a time mode during which the temperature of the food product will be maintained. The object of this mode is to keep the food product at the desired temperature for a period of time in order to create a tender finished food product without overcooking. Preferably, at the attainment of the target temperature, an audible alarm will let the user know the target temperature has been attained and the display will switch to a timing mode and will display a counter counting up from zero as a timer. The timer can then count upward until a maximum time period, such as 99:59. At any time during the timing mode, the user can select the start/stop button 80 to stop cooking or the slow cooker 10 will turn off after reaching the maximum time period preferably along with an audible alarm as well. Audible alerts can be provided in any number of process steps.

Additionally, it is preferred that the target temperature can be changed after switching to the timing mode. The user can change the target temperature after the timer has started counting upward by selecting the temp/time button 78 once. The display will show the initial target temperature. The user would then be required to manually change the target temperature higher or lower by pressing the up and down arrows 80 to a new target temperature. The new target temperature may flash on the display for a few seconds before resetting. Preferably also, the display will again show the timer counting up as from when the initial target temperature was reached without resetting the timer to zero (unless the cooking program is actually restarted).

It is also contemplated to add a user selected time aspect to the direct temperature probe mode. For example, after the target temperature is set as described above and prior to pressing the stop/start button 80, the user could select the temp/time button 78 to allow a time entry. Such a time entry could be a substitute for the default timer aspect for continued heating of the food product after the target temperature is attained. The user would instead at the initial cooking stage select both the target temperature and the time to maintain that target temperature to cook a food product at a desired temperature and time. A time would be selected similarly by the up and down arrow buttons 84 after which time selection is complete starting the cooking process as above by then pressing the stop/start button 80. The cooking process would proceed similarly but with a set time to maintain the target temperature. It is contemplated that the target temperature could then be manually revised during the time period as above. It is also contemplated that the set time could be also reset during the time period after target temperature is achieved, such as by pressing the temperature/time button twice during the set time period. The display could change to show the set time period and could allow change by the arrows 84 similarly as above for the target temperature.

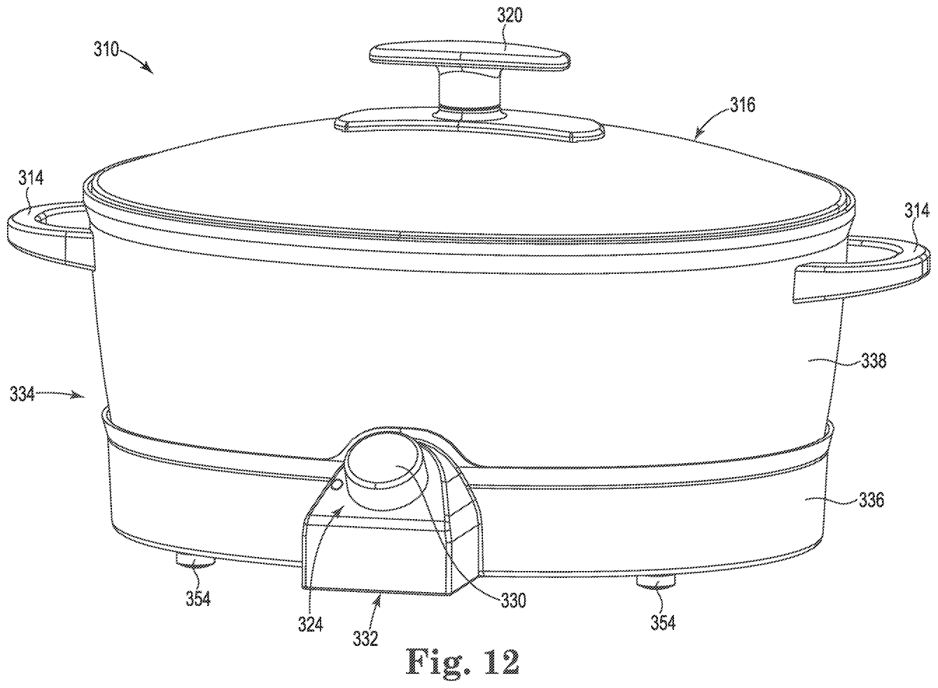

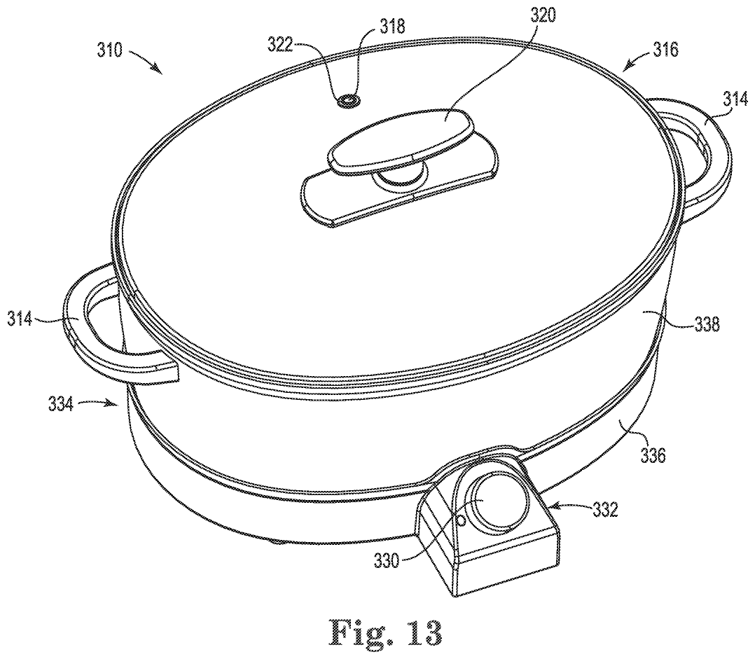

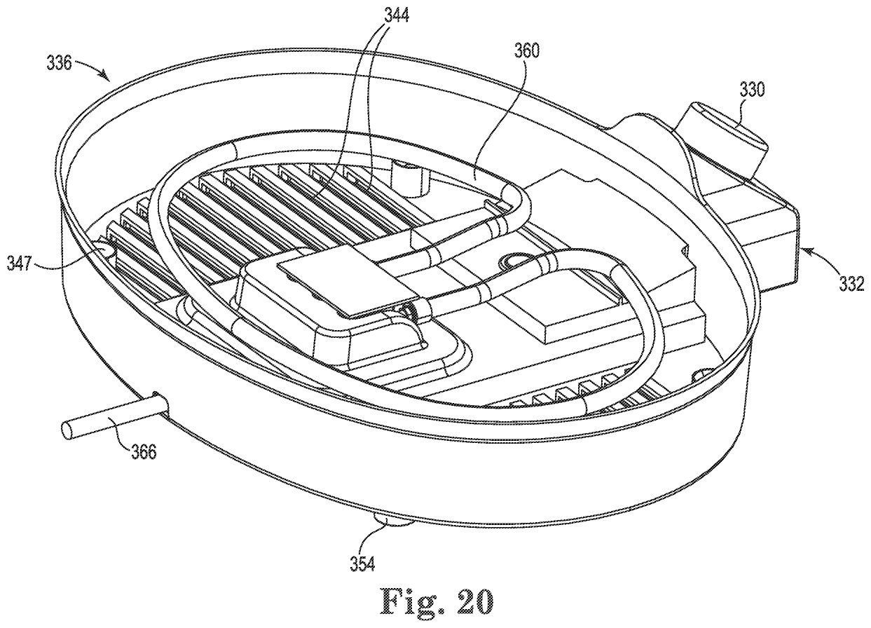

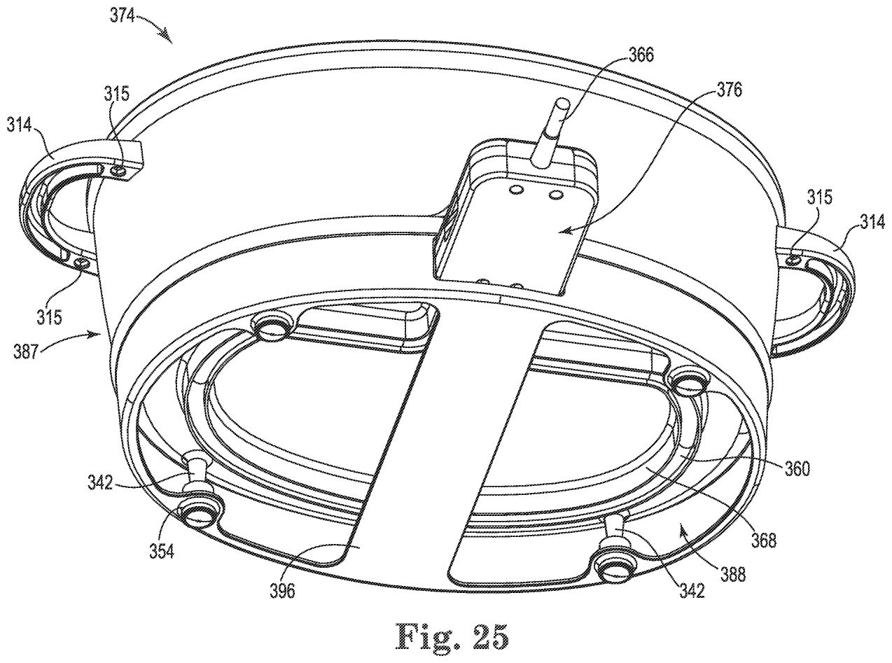

In certain embodiments, the sous-vide mode also utilizes the direct temperature probe 48 to provide sensed temperature feedback to the control module 50 in much the same way as the temperature probe mode. As discussed below in greater detail (e.g., FIGS. 12-30), other embodiments are contemplated in which control schemes disclosed herein are utilized for sous-vide or other cooking modes without utilizing a direct temperature sensing probe 48 that is internal to the cooking vessel 16, and instead utilize an indirect temperature sensor and corresponding cooking mode and control.

An example manner to operate the sous-vide mode using the direct temperature sensing probe 48 in the vessel 16 is described as follows. As above, the user will initially connect the slow cooker 10 to power upon which a default display can be provided in the display screen 76, such as a series of flashing dashes. A food product as provided within a sealed bag or the like is added to the cooking vessel 16 which may or may not be positioned within the slow cooker 10. Water, other liquid, or any flowable material is added to the cooking vessel of sufficient quantity to immerse the sealed bag and food product. If not done earlier, the cooking vessel 16 can then positioned within the slow cooker 10. After putting the lid 26 on the cooking vessel 16, the probe 48 is preferably inserted through the hole 56 that is provided through a portion of the lid handle 34. The use, in particular, of the hole 56 as opposed to the lid holes 62 is that the lid handle 34 and the hole 56 are preferably designed so that the extension element 60 and in particular the end portion thereof with a temperature sensor is positioned proximate to the bottom of the cooking vessel 16 so as to be immersed as well within the water surrounding the sealed bag and cooking product. The lid handle 34 and the hole 56 are preferably designed along with the length of the direct temperature probe 48 to position the temperature sensor proximate to the bottom of the cooking vessel 16 for measuring water temperature. The hole 56 can be designed to sufficiently frictionally hold the extension element 60 to be adjustable by some degree to further accommodate desired positioning of the temperature sensor within the water level.

The user would then select the sous-vide button and the indicator LED 90 below target temperature will light up. The user is thus notified that the slow cooker 10 is ready for setting of the desired cooking temperature of the water and ultimately, the food product. A default temperature such as 135° F. (57.2° C.) can be displayed and user manipulation of the up and down arrows 84 can be used to manipulate the displayed target temperature in desired increments such as one degree F. increments. A preferred temperature range for selection by the user is between 100° F. (37.8° C.) and 195° F. (90.6° C.). The display preferably flashes the target temperature at this time until the user sets the target temperature by pressing the time/temp button 78. After pressing the time/temp button 78, a desired immersion cooking time would be selected similarly by the up and down arrow buttons 84. For sous-vide cooking, a minimum time can be based on known immersion cooking times for different food products to a desired doneness. Continued cooking beyond the minimal time does not change the food product doneness as the temperature is maintained at the desired doneness temperature. The time can be set by changing the time one minute at a time, which function can switch to a larger interval, such as ten-minute increments after so many one-minute increments. A maximum time is preferably defined, such as twenty hours. Once the time selection is complete the cooking process can be started by then pressing the stop/start button 80.

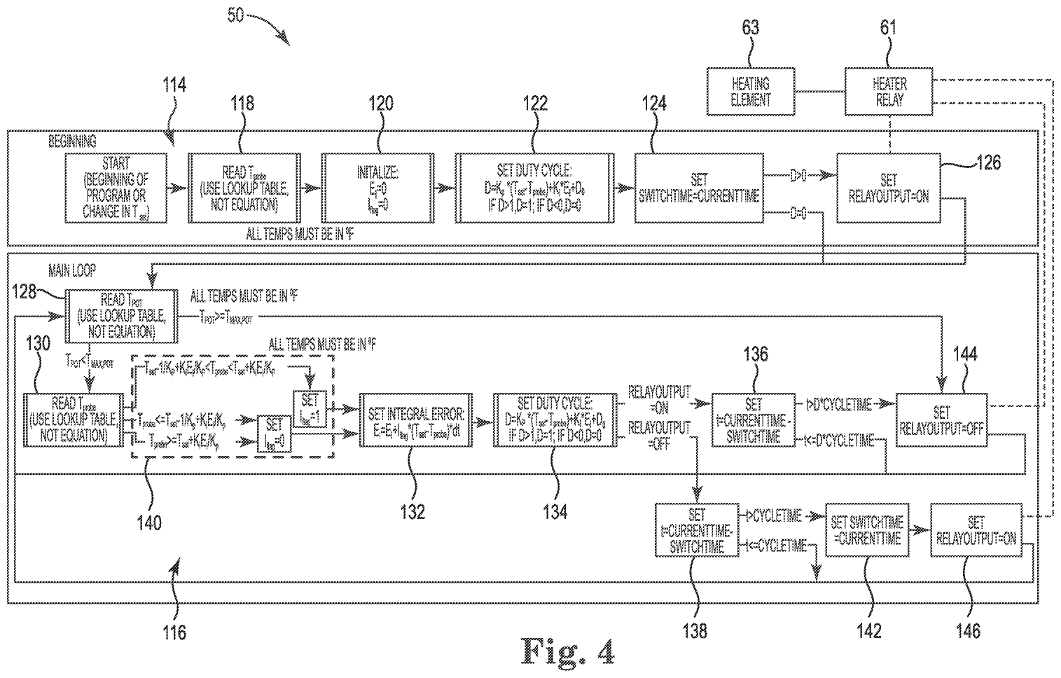

After that, the actual temperature LED indicator 88 will light up as the direct sensing probe 48 is now sensing the water actual temperature, which temperature will be displayed now and until the selected water temperature is reached. When the water temperature reaches the set temperature, slow cooker 10 will preferably provide an audible alert and the set time will start counting down. Also, after the start/stop button 80 is pressed, a control program according to the control module 50 of FIG. 4 will be initiated and followed.

The control module 50 will continue to follow the control program, instructions, or process (discussed in greater detail below) until the direct temperature probe 48 senses that the water temperature has reached the desired target temperature. The display will display the actual temperature along the way with the actual temperature indicator LED 88 lit. Once the target temperature is sensed, the slow cooker 10 will switch to a time mode during which the temperature of the water will be maintained to keep the food product at the desired temperature for a period of time in order to create a tender finished food product without overcooking.

The target temperature can also preferably be changed during the heating up of the water to the target temperature or after switching to the timing mode. The user can change the target (or set) temperature by selecting the temp/time button 78 once. The display will show the initial target temperature. The user would then be required to manually change the target temperature higher or lower by pressing the up and down arrows 80 to a new target temperature. The new target temperature may flash for a few seconds before resetting. Preferably also, the display will again show actual temperature or the timer counting down.

A traditional slow cook mode does not utilize the direct temperature probe 48, but instead requires user input of both a predefined heat level for cooking and a cook time. Specifically, once the slow cooker 10 is powered up, a user would select one of three predefined cooking temperatures, warm, low, and high by pressing the slow cook button 70 one, two, or three times, respectively. Some predefined temperatures and/or other variations include warm, low, and high settings. The LED indicator lights 82 will show which predefined temperature has been selected. A warm cycle is initiated by a single press of the slow cook button 70 lighting the warm indicator 82. Audible alerts can be incorporated and utilized throughout in any suitable capacity.

In order to control the slow cooker 10 according to the various programs discussed above, various control schemes can be performed by the control module 50, which can be embodied in or otherwise include a controller having at least a hardware processor and a memory operatively connected thereto.

It is known in the art that control, and in particular digital control, can be enacted using various types and complexities. Typical examples include the increasingly more complex 1. proportional (P), 2. proportional-integral (PI), and 3. proportional-integral-derivative (PID) control schemes. It is often preferable to utilize the simplest control scheme that meets the requirements of a particular usage, as increased control complexity can also require more extensive tuning and setting of various control constants to achieve effective control. A controller embodying P, PI, or PID control (or any combination or variations thereof) can measure process conditions and calculate feedback and adjust output to cause and control a process level variable such that it matches a target set point. Various control schemes can be implemented with temperature sensor(s) located in various locations within the cooker 10, such as internal to a cooker housing and adjacent to a cooking vessel 16, or in the form of a probe 48 as described above.

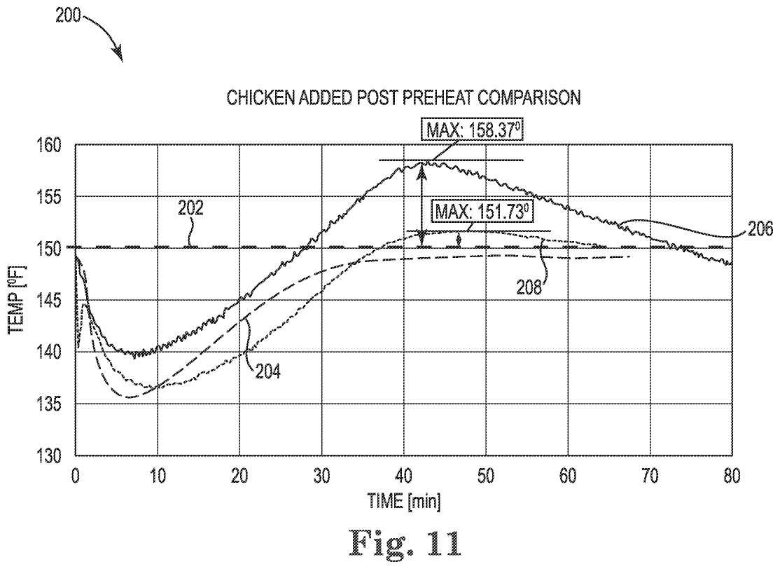

Proportional control (P) of electric appliances benefits from simplicity, but has limitations including the well-known “steady-state error” problem. With proportional (P) only controls, the control algorithm is generally dependent on pre-defined constants. Therefore, if the duty cycle D=Kₚ*(Tₛₑₜ−T_{probe})+Dₒ, Dₒ can be either too low or too high to reach the desired steady temperature. This is therefore the cause of the steady-state error problem. In proportional (P) control, Dₒ (initial duty cycle) is generally defined by thorough testing but it cannot account for all use cases or unit to unit variation in the way that K_{I} can respond to the temperature history. In other words, proportional (P) control is best suited for situations where a degree of offset is acceptable and not detrimental to practical performance. In some situations, however, the offset is not desirable, such as where a user wishes to maintain an appliance temperature at a precise level, and even after one or more temperature-affecting events (e.g., the introduction of a food product). In order to compensate for the steady state error problem of proportional (P) control, an integral aspect of PI control can be introduced. However, the integral aspect of PI control suffers from its own limitation, known as integral wind-up or accumulation. Integral wind-up is a well-known drawback to PI control. Sometimes integral wind-up can be more problematic where an appliance is operating on a power source at a relatively low nominal voltage, among other situations. As shown in chart 200 of FIG. 11, the improvements described below in various embodiments of the present invention avoid excessive overshoot temperatures compared to traditional PI control schemes, while also avoiding the steady state error problem of the simpler proportional control. Overshoot temperatures in heated appliances are generally undesirable and are preferably minimized where possible.

With reference now in particular to FIGS. 4-11, an example program or process for the control module 50 to control the slow cooker 10 is illustrated that is used when cooking with the direct temperature probe 48 (as opposed to an indirect sensor internal to cooker 310 such as described below), such as for either of the direct temperature probe mode or the sous-vide mode. In this embodiment, actual direct temperature data of the food product or cooking liquid (water) being heated is preferably monitored and thus known in real time. The control module 50 can be embodied in a controller that is operatively connected to a power circuit, a control circuit, a power source, any other sensor for sensing a parameter level (e.g., a probe or Hall-effect sensor), and an active element (e.g., a heating element, electric motor, controller, etc.). The purpose of the process is to controllably bring either the food product directly or the water to indirectly heat the food product up to temperature over a time period by heating the active element to a target set point for a period of time or until the item to be heated reaches a certain temperature. The current heating level is also referred to herein as a process variable.

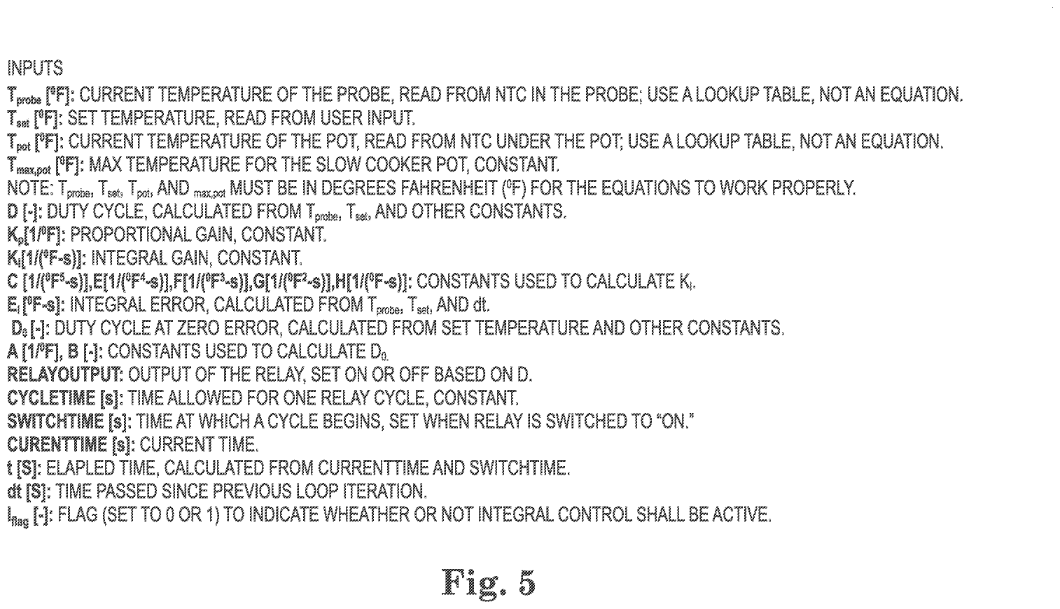

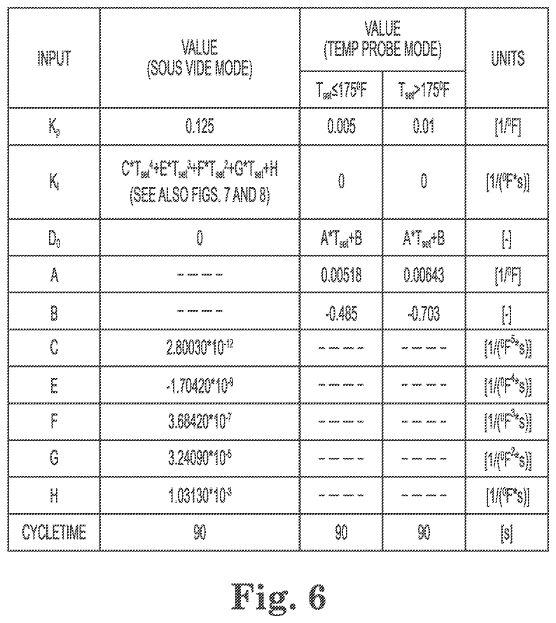

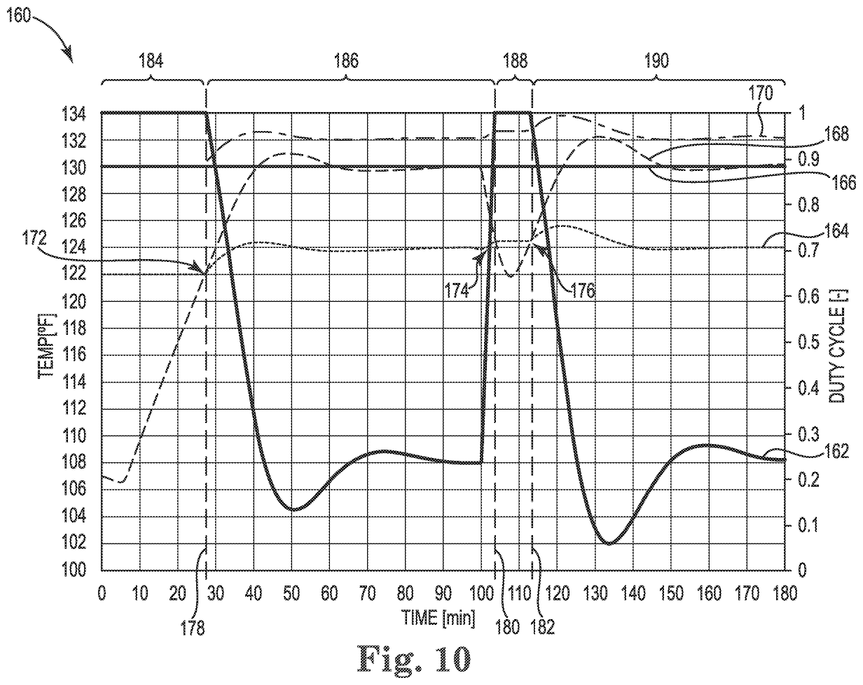

The basic control function is to turn on and off a heater switching device, relay 61 as shown schematically electronically connected with the control module 50 running the heater control process/programming and connected with an active element, e.g., a heating element 63. The process comprises an initiation portion 114 leading up to a repeated main loop 116. FIGS. 2-9 illustrate the factors and variables as are relied upon within the control process of FIG. 4. FIG. 10 illustrates an example of the operation and of the process graphically when a food item is introduced, and FIG. 11 illustrates improved performance of the process compared to traditional proportional and PI control. A number of constants are also set out within the tables of FIGS. 5 and 6, which are selected based upon the cooking mode selected by the user and on the set temperatures also selected by the user.

Described herein are examples of improved PI control that address the shortcomings of both proportional and PI control schemes. In short, presented herein is an improved PI control scheme that selectively accumulates and does not accumulate integral error during appliance operation in order to reap the benefits of PI control while addressing the integral wind-up feature and potential drawback. An interval of a target set point is defined such that as a sensed temperature of a process variable reaches a certain defined level plus or minus the set point the integral error begins to accumulate until the process variable passes outside the interval. The example control module 50 embodies one example PI control scheme with an incrementally controlled duty cycle as contemplated herein. In various embodiments, the interval can be defined based on at least a proportional constant, an integral constant, and an integral error. In further embodiments, the interval is further defined based on the target set point and the sensed process variable. In yet further embodiments, the interval is defined as having a minimum defined as the target set point minus a reciprocal of (one divided by) a proportional gain constant plus the integral constant times the integral error divided by the proportional constant, and the interval is defined as having a maximum defined as the target set point plus the integral constant times the integral error divided by the proportional constant. In some cases, it can be beneficial to bolster the disclosed improved PI control schemes with a derivative factor, in which case PID control would be utilized. It is to be understood that embodiments herein that refer to PI control can also be used with PID control with the addition of the derivative control.

As shown, the control module 50 of the slow cooker 10, when the control circuit is energized, comprises an initiation portion 114 and a main loop 116 that can be repeated any number of times. The initiation portion 114 sets up the main loop 116 once the start/stop button 80 is pressed to start either the direct temperature probe mode or the sous-vide mode. At step 118, the temperature output of the temperature probe 48 is read and obtained by the control module 50. In step 120 an integral error (E_{I}) is set to zero, and an integral flag (I_{flag}) is also set to zero. In step 122, an initial duty cycle (D) value is determined based primarily on a proportional constant (K_{P}) times the difference between the user set temperature and the directly sensed temperature at the probe plus the integral constant (K_{I}) times the integral error (E_{I}). Also at step 122, if the duty cycle (D) would exceed 1 (e.g., 100% power) or be less than 0 (e.g., less than 0% power), the duty cycle (D) is set to physical limits to 1 and 0, respectively. Step 124 sets a switch time (time when a cycle begins based on the heater relay 61 being switched on) to be current time. If then the duty cycle (D) value is greater than zero the heater relay 61 is turned on and the switch time cycle begins. From there, the main loop 116 controls the incremental changes to the heating element 63 by turning off and on the heater relay 61.

The main loop 116 starts at step 128 by reading a temperature of the slow cooker 10 at the bottom of the cooker body 12 below the cooking vessel 16, such as by way of a conventional negative temperature coefficient (NTC) resistor or sensor, such as a thermistor. The thermistor can sense a temperature directly or indirectly and can be located proximate or within an interior of a cooking vessel or plate. The thermistor can be located adjacent to the vessel and external or internal to the vessel, in thermal connection therewith, within or near a side portion of the vessel, or any other suitable location. If the sensed temperature of the slow cooker 10 is greater than a predetermined maximum temperature (determined to keep the cooker from overheating), then the heater relay is switched off at step 144. That would restart the main loop 116 and the heating element 63 would not be turned on until the slow cooker 10 temperature is again below the maximum. As shown in FIG. 4, a direct temperature sensing configuration is described. An indirect temperature sensing configuration is described below with reference to at least FIGS. 12-32, etc.

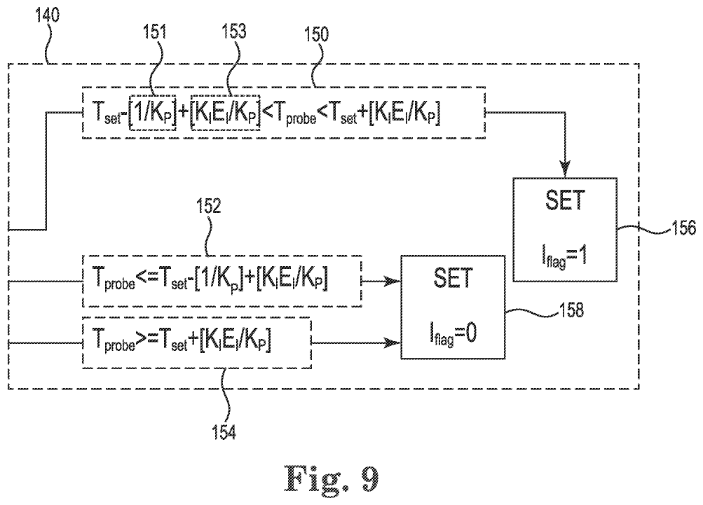

If the slow cooker 10 is found to be below the maximum cooker temperature at step 128, another duty cycle (D) would be determined for incremental continued heating of the heating element 63 via relay 61. At step 130, the temperature probe temperature is read, and compared to a minimum and a maximum threshold temperature as shown in more detail in FIG. 9. Based on the comparison at 140, the integral flag (I_{flag}) is set to 0 (off) or 1 (on) for the duty cycle (D) to be set at 134 after the integral error (E_{I}) is set based on the integral flag (I_{flag}) at step 132.

Based on equations at 140, the probe temperature (T_{probe}) is compared to the set temperature (Tₛₑₜ) based on arithmetic formulas shown at 140. At step 134, the new, main loop duty cycle (D) is determined in a similar manner as in the initiation portion 114. If the relay output is on at that time, step 136 follows; if not, step 138 follows. In either case a comparison is made of the elapsed time of the current cycle to determine whether the heater relay 61 is to be switched off as at step 144 or on as in step 146 following a cycle clock reset step at 142. At the end of each decision step made at step 144 or step 146 the process returns to the beginning of the main loop 116. By such a control process, the heating element 63 is selectively modulated to obtain the user selected cooking temperature (either of the food product or the immersion water) within the slow cooker 10 and to thereafter maintain the set temperature based on actual temperature sensed data from the direct probe 48.

In various embodiments, the presently disclosed approach of updating the operation of the slow cooker 10 each duty cycle (D) at 134 can be at a faster than the frequency of the duty cycle itself. In more detail, the duty cycle value D updates several times during each duty cycle time (cycleTime) (which can be 90 seconds for the example slow cooker 10). This means that rather than calculating duty cycle value (D) at the beginning of the duty cycle (D) and then prescribing the on time and not allowing it to change until the next duty cycle (D) has begun, in various embodiments D is continuously or repeatedly updated several times faster than the duty cycle (D) time itself. Therefore, the duty cycle (D) does not turn off the heating element of the slow cooker 10 for the present duty cycle (D) until time (t)>D*cycleTime. This arrangement allows the slow cooker 10 control to respond faster than waiting for a full duty cycle (D) to pass at 134 to make adjustments during cooking. In existing arrangements, therefore, the control of the heated appliance would lag by cycleTime.

According to various embodiments, the control module 50 sets a power level of the active element (e.g., heating element, electric motor, controller, etc.) using the reading of the parameter at the sensor using a lookup table.

With reference again to FIG. 9, the equations at 140 are shown in greater detail. In particular, three calculations at formulas 150, 152, and 154 provide an integral error accumulation formula 150 (Tₛₑₜ−(1/K_{P})+(K_{I}*E_{I}/K_{P})<T_{probe}<Tₛₑₜ+(K_{I}*E_{I}/K_{P})), a minimum probe temperature not reached formula 152, and a maximum probe temperature exceeded at formula 154. If the probe temperature (T_{probe}) is found to be within the parameters of formula 150, the integral flag (I_{flag}) is set to 1 at 156 and a loop iteration of the present duty cycle (D) would accumulate integral error (E_{I}) until another cycle is initiated. The loop iteration during the duty cycle (D) can provide a finer granularity control between duty cycles (D), including shorter refresh iterations or intervals, and even continuous control in certain embodiments using continuously accumulated integral error (E_{I}). The loop iteration can have a loop iteration time, which can be defined as a time since the previous loop iteration. On the other hand, if the probe temperature (T_{probe}) is too low as calculated at formula 152, or too high as in formula 154, the integral flag (I_{flag}) is set to zero at 158, and the loop iteration of the current duty cycle (D) does not accumulate integral error (E_{I}) to be used to adjust proportional control feedback. Each of formulas 150, 152, and 154 include the threshold at 153, defined as the integral constant (K_{I}) times the integral error (E_{I}), the product of which is divided by the proportional constant (K_{P}).

Formulas 150, 152, and 154 are based on physical limitations of the calculated duty cycle (D) at 134. In essence, once the physical limitations of duty cycle (D) were calculated, formulas 150, 152, and 154 are formula at 134 rearranged into three inequality ranges where D<0, 0<D<1, or D>1. Formula 152 (T_{probe}≤Tₛₑₜ−(1/K_{P})+(K_{I}*E_{I}/K_{P})) can be designated a lower limit band, which represents a point below which the value of duty cycle (D) would always be greater than 1. If the water being heated by slow cooker 10 were currently at 130° F. (54.4° C.) and set to 150° F. (65.6° C.), the desired output from the proportional control would be D=K_{P}*(Tₛₑₜ−T_{probe})−0.125*20=2.5, which is not physically possible as it is beyond the maximum value of 1 (which represents 100%, or an “always-on” duty cycle).

Similarly, formula 154 (T_{probe}≥Tₛₑₜ+(K_{I}*E_{I}/K_{P})) can be designated an upper limit band, above which the output would be a negative duty cycle (D), which is also not physically possible. Typical integral control cannot account for the error accumulation, so flagging the accumulation of integral error (E_{I}) on and off as described herein provides an effective and efficient solution to the known drawbacks to integral-based control. Thus, accumulation of integral error (E_{I}) can be flagged on and off without flagging the integral control off entirely, and thus the integral constant (K_{I}) times the integral error (E_{I}) still contributes to the duty cycle (D) when the sensed temperature is outside of an integral error accumulation band defined by the formulas 150, 152, and 154, without creating discontinuities in the duty cycle (D) as the sensed temperature crossed in and out of the integral error accumulation band. The values produced at formulas 150, 152, and 154 are therefore moving reference points that automatically adjust for a given system based on the integral error (E_{I}). Alternatively, the duty cycle (D) could represent an input of the formulas shown at 134. For example, if D>1, or D<0, the I_{flag}=0, and if 0<D<1, then the I_{flag}=1. Therefore, as duty cycle (D) is set to 0 or 1, it is truncated when beyond the known physical limitations of electrical appliances and their operation. In yet further embodiments, a fixed range can be set (e.g., Tₛₑₜ−10<T_{probe}<Tₛₑₜ+5) or an additional gain (G) could be included to further tune the system (e.g., Tₛₑₜ−G*((1/K_{P})+(K_{I}*E_{I}/K_{P}))<T_{probe}<Tₛₑₜ+G*(K_{I}*E_{I}/K_{P})).

Formulas 150 and 152 also include the interval formula 151, which sets a minimum threshold for accumulating integral error (E_{I}) as a reciprocal of the proportional constant (K_{P}), e.g., 1 divided by K_{P}. In various embodiments, therefore, the maximum threshold set at 154 is spaced from the minimum threshold set at 152 by the interval defined at 151. As shown in FIG. 4, above, following the setting of integral flag (I_{flag}) to 1 or 0, the process continues to step 132.

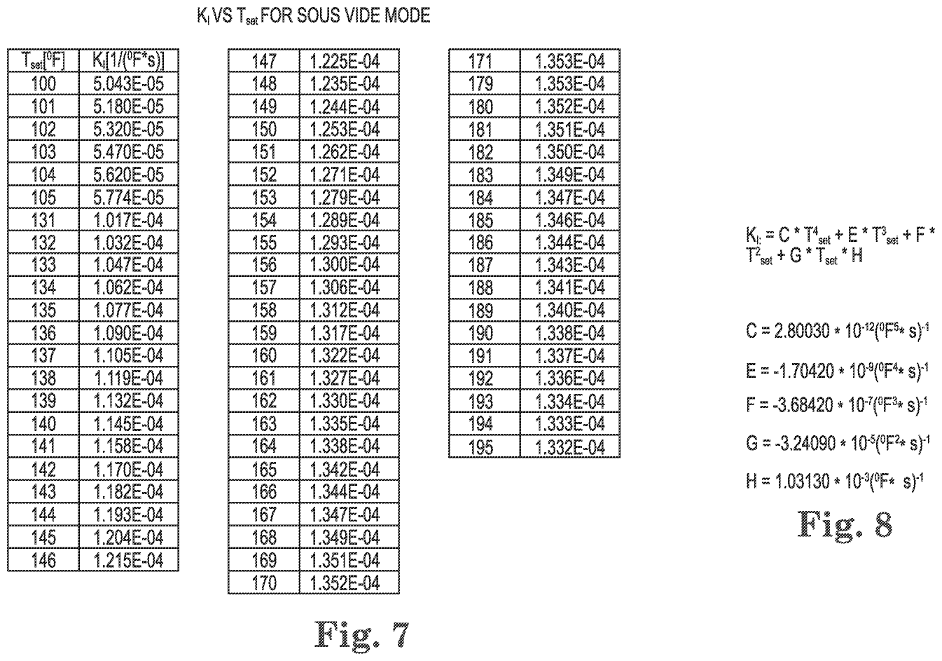

FIG. 7 is a lookup table for integral constant (K_{I}) versus temperature setting for use with the process of FIGS. 4-6, according to various embodiments. The example lookup table shown integral constant (K_{I}) versus temperature setting (e.g., set point Tₛₑₜ) for a direct-probe sous-vide mode of the cooker 10. In various embodiments, if using the lookup table, linear interpolation can be used to find the integral constant (K_{I}) when a value for temperature setting (Tₛₑₜ) is not present in the lookup table.

FIG. 8 is an example polynomial function for determining the integral constant (K_{I}) in accordance with the inputs of FIG. 6, according to various embodiments. The polynomial function of FIG. 8 can be used for finding the integral constant (K_{I}) as an alternative to a lookup table as shown in FIG. 7. In various embodiments, a polynomial function for determining the integral constant (K_{I}) can utilize constants C, E, F, G, and H, along with associated order polynomial equations relating to Tₛₑₜ. As shown, the integral constant (K_{I}) is determined using all the terms C, E, F, G, and H, and their respective Tₛₑₜ polynomial function. In other examples, one or more of terms C, E, F, G, and H can be ignored or set to zero, or otherwise the polynomial equation of the associated constant can be removed entirely. In one example, the following equation can be used to find K_{I}, K_{I}=C*T⁴ₛₑₜ+E*T³ₛₑₜ (thus the F, G, and H terms would be optionally omitted). In yet further embodiments, any order function, such as 5th, 6th, 7th, 8th, 9th, 10th, etc., can be used to determine the integral constant based on the Tₛₑₜ.

FIG. 10 is a chart 160 showing temperature versus time for an example appliance (e.g., slow cooker 10) configured to use the process of FIG. 4, according to various embodiments. As shown, 162 is an example duty cycle (D), 164 is a low temperature threshold, 166 is a set temperature (Tₛₑₜ), 168 is a water temperature (e.g., T_{probe}), and 170 is a high temperature threshold.

According to FIG. 10, four distinct sections according to the x-axis (time in minutes) are shown. The sections as described below are defined as either accumulating or not accumulating integral error (E_{I}). A first section 184 is shown before the water temperature crosses the low temperature threshold 164 at crossover point 172. As shown no integral error (E_{I}) is accumulated in section 184. As shown in section 184, the duty cycle (D) 162, low temperature threshold 164, high temperature threshold 170, and set point 166 are all at constant respective temperatures during the time of section 184.

A second section 186 is shown following section 184 temporally and separated by crossover point 172. As shown, only the temperature set point 166 remains constant in section 186. As the water temperature 168 reaches the low temperature threshold 164 and crosses over at 172, integral error (E_{I}) begins to accumulate, causing a rate of increase in the water temperature 168 to slow, and the low temperature threshold 164 to increase accordingly. The high temperature threshold 170 is spaced from the low temperature threshold 166 and increases and decreases in parallel together. In section 186 the water temperature 168 substantially reaches steady-state equilibrium before an item to be heated is introduced to the water before crossover point 174. When the item is introduced, the item is typically and as shown at a lower temperature than the steady-state water being heated, and therefore a temperature shock cools the water temperature 168 precipitously. As shown, the water temperature 168 decreases below the low temperature threshold 164 at second crossover point 174, entering section 188 is briefly entered, and then crosses back above the threshold 164 at third crossover point 176, upon which section 190 is entered.

After the cooling temperature shock of the item entering the water, the water temperature 168 again reaches a steady-state in section 190 during which the item is heated and/or cooked, e.g., using the slow cooker 10.

In section 188, the duty cycle (D) is at a full 1, or 100% operation, as shown by duty cycle scale on the right side of the y-axis of chart 160. As described herein, a duty cycle (D) preferably is constrained to a range of 0-100%, and any readings above 100% or below 0% are truncated as practical limits. Although not shown, if the water temperature 168 were to exceed the high temperature threshold 170 the integral error (E_{I}) would cease to accumulate unless or until the water temperature 168 decreased below the high temperature threshold 170.

FIG. 11 is a chart 200 showing improvements to overshoot in proportional-integral (PI) control according to the process of FIG. 4, according to various embodiments. A shown, a quantity of chicken, an example food item, was added after preheating the slow cooker 10 described herein. As shown, a set point 202 (Tₛₑₜ) is set to around 150° F. (65.6° C.) and various control schemes were utilized to ascertain the relative performance of proportional control at 204. As shown, line 204 representing a test using only proportional control never reaches the set point 202 of 150° F. (65.6° C.). This example shows the problem of steady state error, and this problem is addressed by PI control because it actively adapts with to the integral error (E_{I}) variable.

Traditional PI control is shown at line 206, and the improved and modified PI control with wind-up limits is shown at line 208, as described herein. Comparing the traditional PI control at 206 to the modified PI control at 208, it was shown that the maximum overshoot temperature was beneficially reduced from about 158.37° F. (70.2° C.) (about 8.37° F. [4.65° C.] overshoot) to about 151.73° F. (66.5° C.) (about 1.73° F. [0.96° C.] overshoot), a significant improvement over the traditional PI control scheme at 206.

Although lines 206 and 208 are shown as descending below set point (Tₛₑₜ) 150° F. (65.6° C.) at about 70 minutes in FIG. 11, the lines 206 and 208 would each increase back to steady state at 150° F. after the initial overshoot. As shown at 168 of FIG. 10, the improved PI curve 208 would eventually reach steady state at the set point.

A benefit of the temperature profile includes achieving only a minor temperature overshoot of 0.5-2.5° F. (0.28-1.39° C.). This reduced overshoot has benefits. First, it ensures that a timer will consistently trigger at the correct set temperature no matter the load condition. Secondly, the improved PI with reduced overshoot will reach the set point faster than if it were designed to taper at but not surpass the set temperature (Tₛₑₜ of 150° F. [65.6° C.] in this case). Even though line 206 would eventually balance out, a user generally prefers that a temperature of the electric appliance to vary less far from the desired setting.

As shown and described herein, slow cooker 10 is one possible representative example of an appliance with a direct probe sensing feature. In particular, slow cooker 10 is an electrically-powered and heated appliance. Although embodiments of electrical appliances and controllers described herein use heating and temperature as parameters to be controlled, any other type of electric or electronic appliance can be controlled using the same or similar techniques. For example, a motor speed, torque, and/or power level can be controlled. Other examples of heated appliances contemplated herein include but are not limited to: multi-cookers, pressure-cookers, air fryers, deep fryers, rice cookers, sous-vide appliances, stove top resistive or induction heaters, induction ovens, electric or gas heated ovens, sandwich grills, toasters, waffle irons, toaster ovens, hair straighteners, hair dryers, heat guns, curling irons, irons and steamers (including steam stations), coffee makers, space heaters, water heaters and boilers, etc. and combinations thereof.

Yet further examples of appliances, heated or otherwise, contemplated herein include other types of electrical appliances, such as those equipped with electrical motors; these include mixers, food processors, blenders, fans and blowers, full-size and hand-held vacuum cleaners, sewing machines, electric toothbrushes, power drills, power screwdrivers, impact drills, clothes washers, clothes driers, reciprocating and circular saws, sanders, televisions or other displays, refrigerators, air-conditioners, heat pumps, vehicles, etc. and combinations thereof. Those of skill in the art would readily understand that the modified PI control schemes disclosed herein apply to any suitable type of electrical appliance, provided certain adjustments and adaptations are made that are covered by this description. Furthermore, while precision-based benefits are described herein, energy savings can also be achieved by utilizing the improved PI control schemes described herein. E.g., energy can be saved by avoiding unnecessary powering a heating element or motor when there is little to no benefit of exceeding a desired power or temperature set point or level.

In addition, and for clarity, certain examples are provided below, with additional and/or specific detail and variations according to particular implementations.

Certain illustrative embodiments of the present disclosure are cooking appliances that benefit from simple, less complex construction and also easy cleaning aspects that result from the modularity. Various embodiments of modular cooking appliances are described herein, including multi-cookers with separate components. Also described are various improved PI and PID control schemes that can operate with or without a probe directly inserted into an interior of the modular cooking appliance, and that instead utilize various indirect sensing configurations.

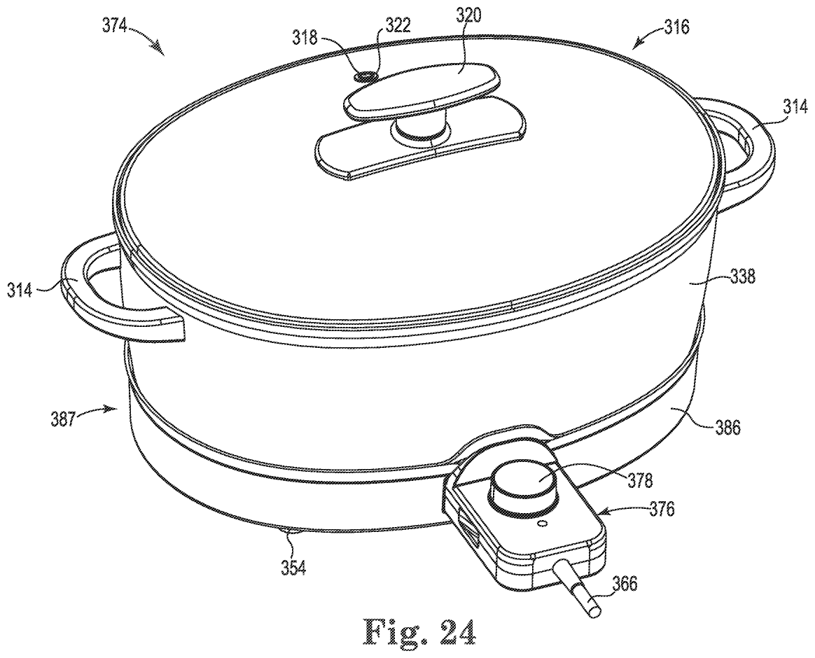

One example of a modular, indirect-temperature-sensing cooking appliance 310 in shown with respect to FIGS. 12-23B. As shown, the modular cooking appliance 310 is an example of a multi-cooker with separable components. Various aspects of modular cooking appliance 310 can also be incorporated into the modular cooking appliance 374 described below in FIGS. 24-28.

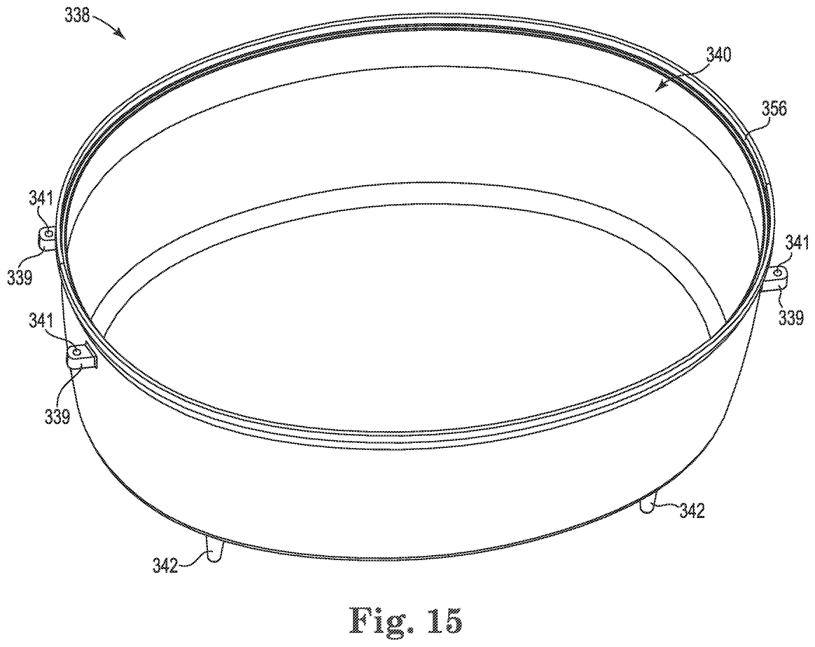

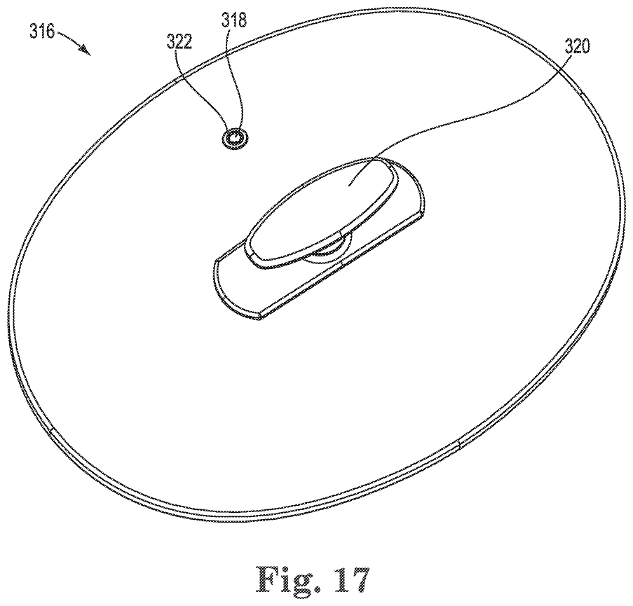

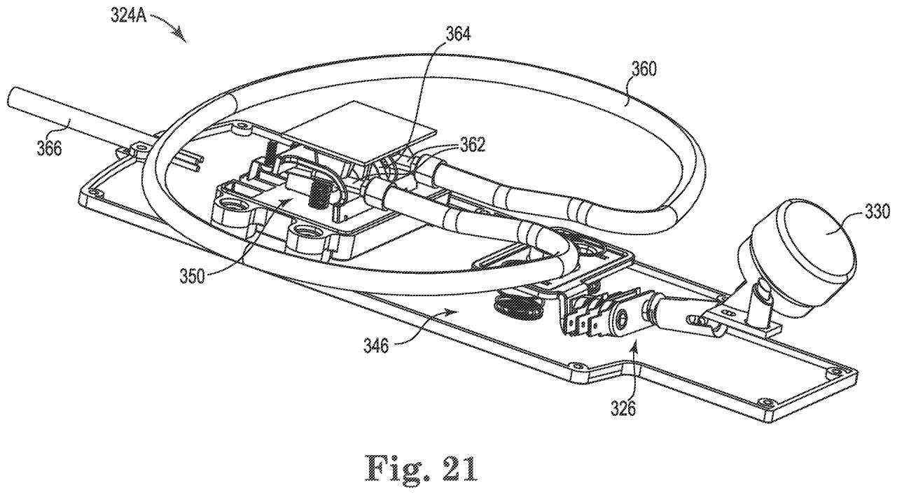

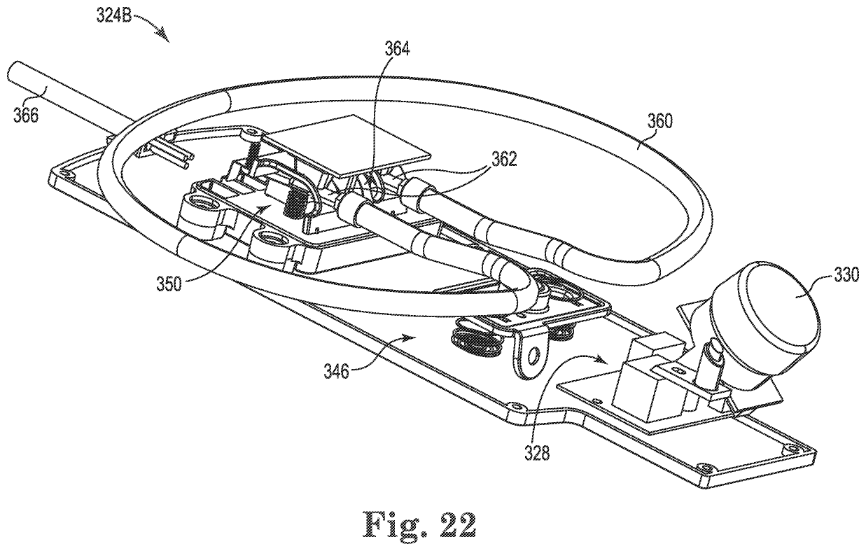

The modular cooking appliance 310 generally includes a cooking vessel 334 that comprises a bowl unit 338 and a base unit 336. The bowl unit 338 is configured to receive a food product (not shown) and can have a preferred capacity of approximately seven liters, or more or less depending on configuration. The bowl unit 338 can have a thickness of approximately 1-2 mm, or more or less depending on configuration. The bowl unit 338 is configured to interface with and be supported by the base unit 336 of the cooking vessel 334, as described in greater detail below. A removable lid 316 with an aperture 318 (see, e.g., FIG. 17) when in place upon an upper rim 356 (see FIG. 15) of the bowl unit 338 at least partially covers an interior 340 of the bowl unit 338 otherwise exposed at an open top of the bowl unit 338. A control housing 332 portion of the base unit 336 at least partially encloses or supports a control unit 324 that can include various controls such as a knob 330 for use by a user and various analog or digital control (see FIGS. 21 and 22) and power components, such as power unit 350 described below. The control housing 332 can also interface with and at least partially support a removable panel 346 and control unit 324, described in greater detail below. Embodiments that utilize automatic or digital control interfaces are also contemplated herein. Various functions can be displayed and/or selected. Handles 314 for grasping and lifting of the cooking vessel 334 of the modular cooking appliance 310 can be located at distal ends of the cooking vessel 334 (e.g., of the bowl unit 338).

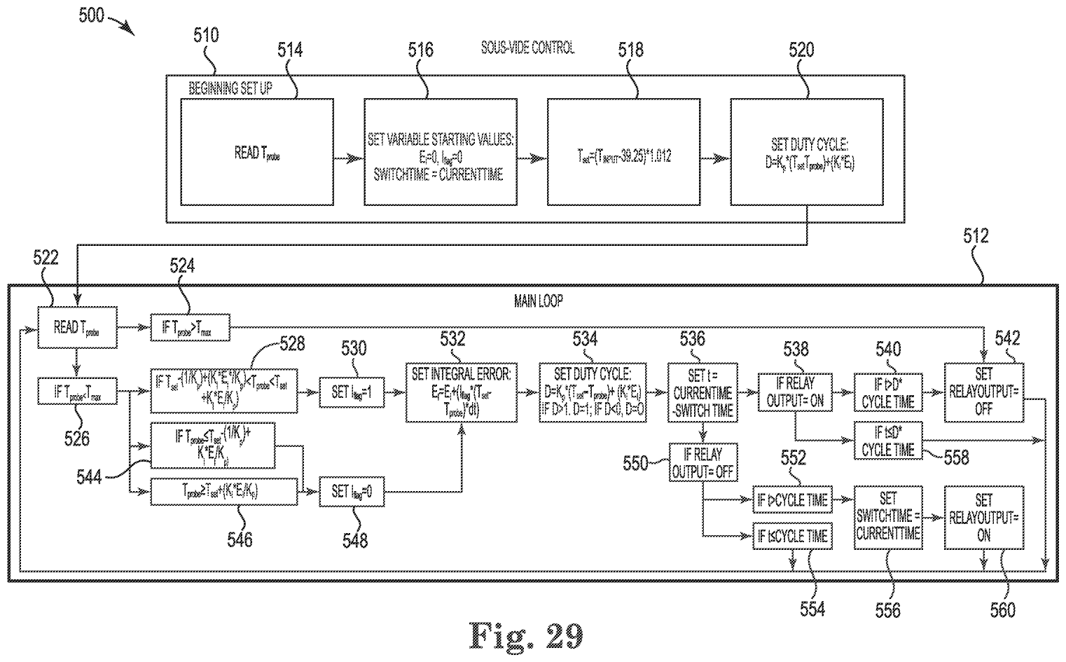

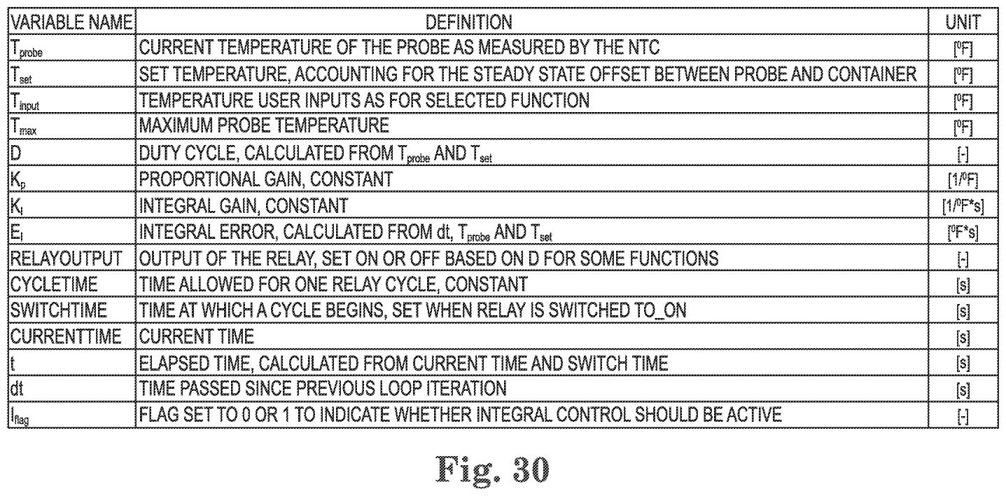

The sous-vide direct-sensor cooking process of FIG. 4 can also be carried out using an indirect control configuration where a temperature sensing device located internal to appliance 310 and outside the cooking vessel or bowl unit 338 itself. See FIGS. 29 and 30 below for an example of sous-vide control using indirect temperature sensing. As described herein, an offset equation can then be utilized to correlate and control actual cooking temperature to indirectly sensed internal temperature to the slow cooker 10 using various control schemes described below.

Selected components of the modular cooking appliance 310 are selectively separable from one another by a user, as desired from time to time. Components can be separable by simply lifting vertically, e.g., using one or more handles such as handles 314. Alternatively, components can be fastened to one another in various embodiments.

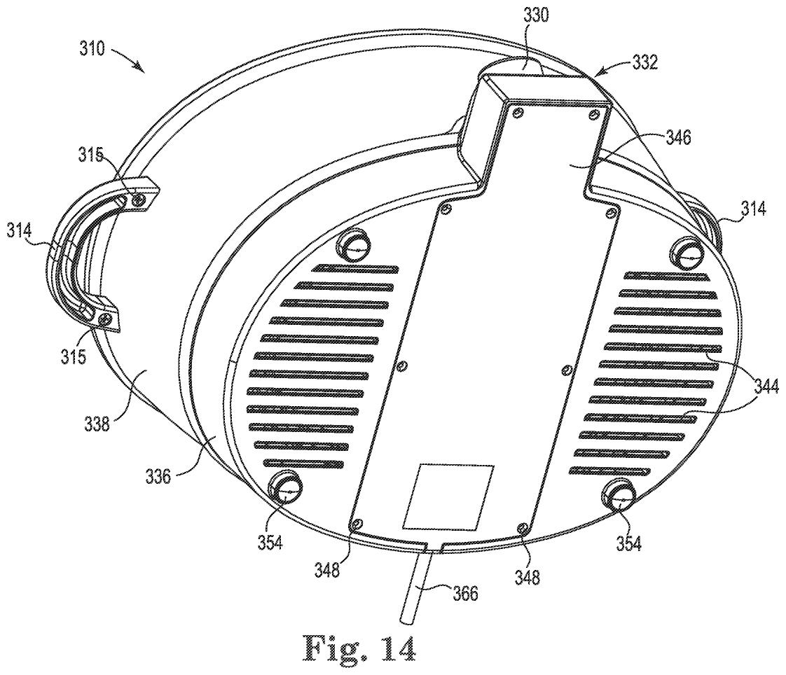

In particular, the bowl unit 338 of the cooking vessel 334 may become significantly dirty, stained, or soiled after single or multiple and/or extended uses in heated cooking. Therefore, it is desirable to easily remove the bowl unit 338 for cleaning of the interior portion 340 that contacts the food product in particular. The cleaning can be beneficially conducted in an automatic dishwashing appliance or can be washed by hand in a kitchen sink. The base unit 336 itself is also preferably removable from the bowl unit 338 for cleaning, etc. The bowl unit 338 can be held to the base unit 336 by gravity in some embodiments, or the bowl unit 338 and base unit 336 can be snapped or otherwise fastened together such as including mechanical fasteners, release mechanisms, or the like. Further, the control unit 324 and heating unit 360 are preferably removable from the cooking vessel 334 entirely by removing fasteners 348 (see FIG. 14) that hold a control unit removable panel 346 (including any other components attached thereto) to the base unit 336. For example, the control unit 324 may comprise a number of components, including a control knob 330 or other user-manipulated device/display and control circuitry and/or a microprocessor or other integrated circuitry, a power unit 350 and connectivity features to connect with the heating unit 360, all mounted, directly or indirectly, to a top surface of the removable panel 346 (See FIGS. 21 and 22). The fasteners 348 can be screws as shown, or can include other mechanical fastening arrangements and types, such as snap-fit fasteners and the like. A user can therefore easily separate the portions of the modular cooking appliance 310 that may require cleaning without requiring also placing other portions in the dishwasher, for example.

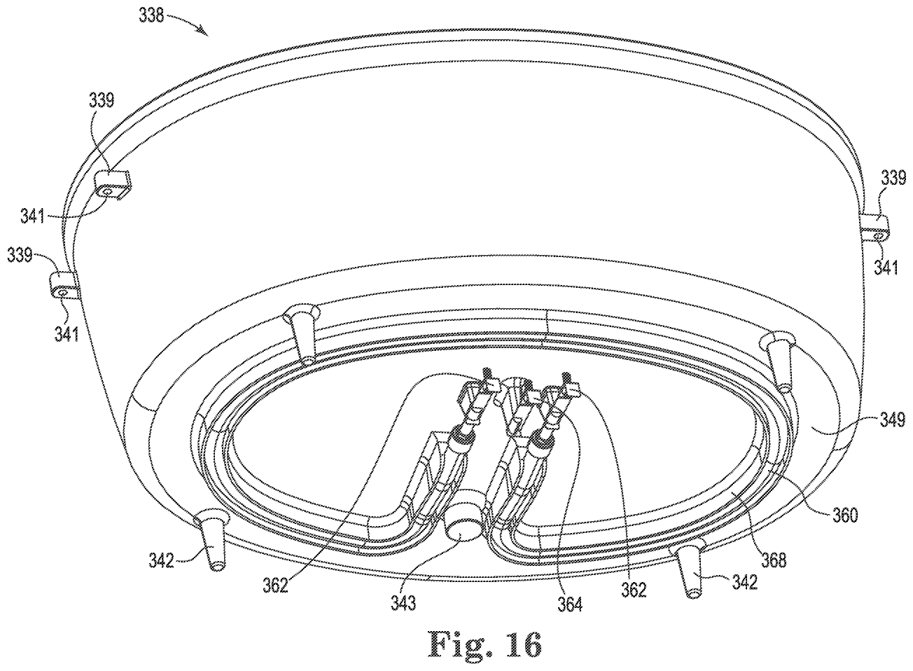

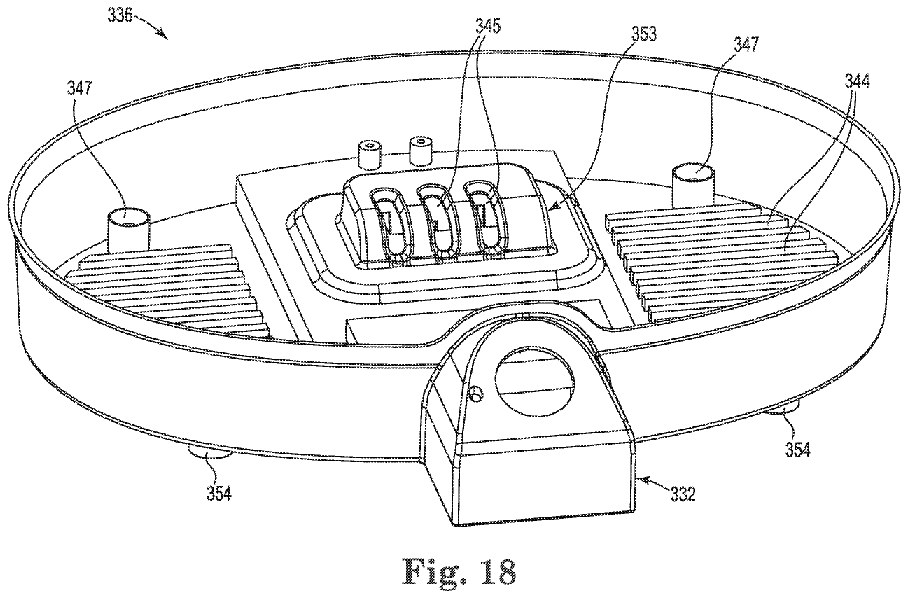

The bowl unit 338, as shown best with respect to FIGS. 15 and 16, has an interior 340, flanges 339 for attachment to handles 314, and apertures 341 in the flanges 339 for receiving a screw or other fastener 315 for attaching the handles 314 to flanges 339 of the bowl unit 338. A lower portion 349 of the bowl unit 338 also can include one or more generally downwardly-extending bowl standoffs 342 (e.g., 4 as shown) that are configured to interface with a counterpart female portion 347 (see, e.g., FIG. 18) of the base unit 338 to stabilize mounting of the bowl unit 338 to the base unit 336, and/or to guide installation of the bowl unit 338 to the base unit 336 in a correct alignment and position by a user. In some embodiments, the bowl standoffs 342 are gravity or friction fit to the corresponding female portions 347, and in other embodiments a mechanical fastener or the like can hold the bowl unit 338 to the base unit 336 until a user may desire to separate the modular components.

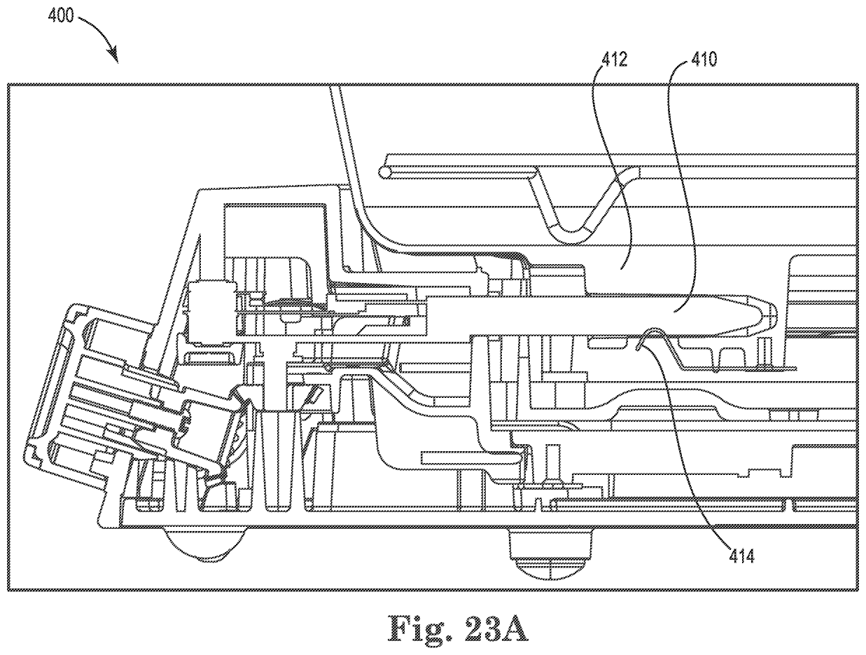

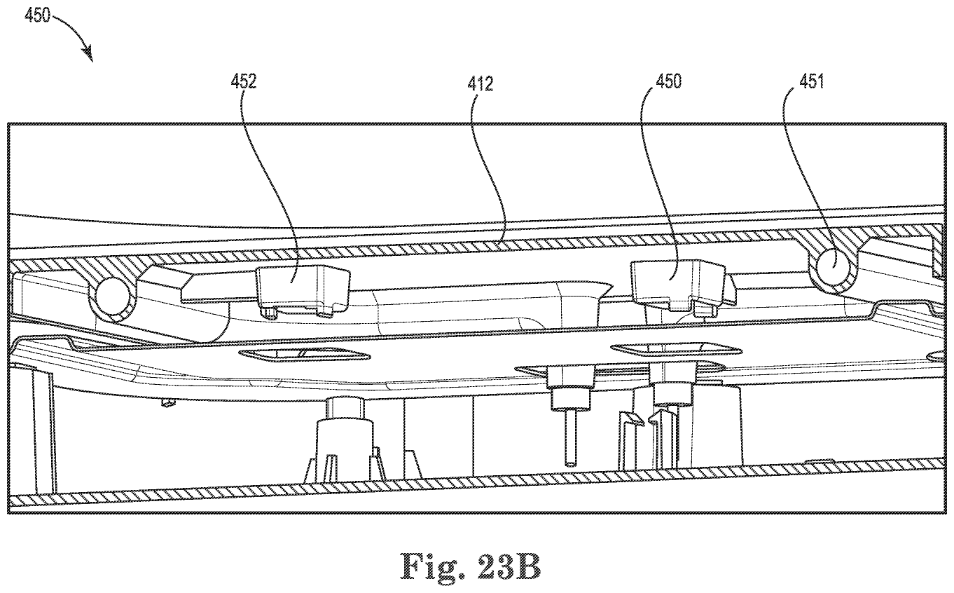

The bowl unit 338 can be a single unit comprising various layers and/or substances, such as polytetrafluoroethylene (PTFE), enamel, aluminum (e.g., anodized), stainless steel, among various other materials and compositions. In some embodiments, the interior 340 of the bowl unit 338 is coated, with e.g., a non-stick coating to reduce adhesion to a food product during cooking. With reference to FIG. 16, the lower portion 349 of the bowl unit 338 also preferably includes one or more channel(s) 368 that is a recess in the base unit 336 that is shaped and contoured to substantially conform to the heating unit 360 and optionally an indirect temperature sensor (not shown; see FIGS. 23A and 23B for examples). Such an arrangement allows the heating unit 360 to be properly positioned for use and the heating unit 360 can be separably removed from the channel 368 of the bowl unit 338. The channel 368 is preferably formed of the same material and integral with the bowl unit 338 and can improve conductive heat transfer from the heating unit 360 to the bowl 338 and a food product therein. In other embodiments, the heating unit 360 can instead be fully hidden and/or integrated with the bowl unit 338. Still with reference to FIG. 16, the bowl unit 338 can include one or more center bowl supports 343 (one as shown) that can also interface with the base unit 336 to support a food product within the interior 340 of the bowl unit 338.

With reference now to FIG. 18, one or more center openings 345 of the base unit 336 are shown with certain other components removed. Center openings 345 can be shaped, sized, and configured to allow portions of the heating unit 360 to pass through the base unit 336. The center openings 345 can permit the heating unit 360 to connect to the power unit 350 (see, e.g., FIGS. 21 and 22) mounted below a raised channel portion 353 of the base unit 336. The center openings 345 of the base unit 336 can further support the heating unit 360 and guide placement of the heating unit 360 during and/or after assembly of the modular heating appliance 310. In some embodiments, one or more of the center openings 345 can also permit at least some convective thermal transfer between various components and/or parts of the modular heating appliance 310. Control housing 332 is preferably formed with the base unit 336 and provides a space open from below within which components of the control unit 324 (discussed below) can fit, or which user features can be mounted. The control housing 332 also preferably is formed to include a space open from above or front through which a knob 330 of the control unit 324 can protrude and/or be accessed by a user.

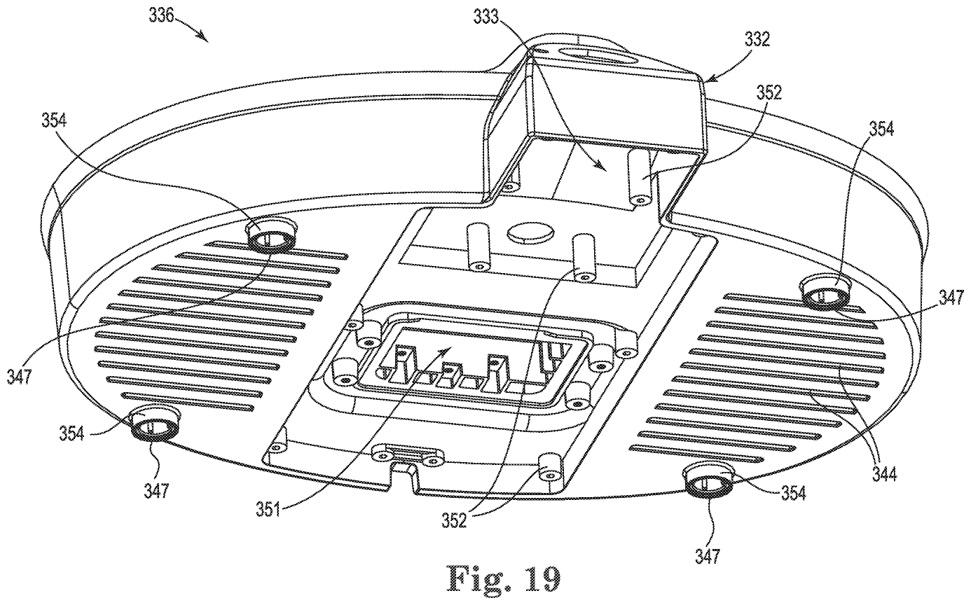

A simple, detachable interface between a separable bowl portion 338 and base unit 336 is contemplated. Still with reference to FIG. 19, as shown, one or more generally cylindrical supporting feet 354 protrude downward (and optionally upward) from the base unit 336 to elevate the base unit 336. Each supporting foot 354 can be substantially cylindrical and/or hollow and can also include a female portion 347 at an upper portion of the supporting foot 354. Alternatively, the supporting foot 354 and/or the female portion 347 and standoff can be prismatic, pyramid-like, frustoconical, or other non-cylindrical shapes. Therefore, the supporting feet 354 can beneficially serve both the purpose of stably supporting the base unit 336 on a resting surface, and also the purpose of providing a guiding female portion 347 for precise positioning of the bowl unit 338 with respect to the base unit 336. Each supporting foot 354 can include an opening that penetrates the base unit 336, and each female portion 347 can be shaped and configured to receive a corresponding bowl unit standoff 342. In some examples each female portion 347 can have a frustoconical opening configured to receive a corresponding, complementary frustoconical bowl unit standoff 342. A frustoconical interface can beneficially facilitate positioning and attachment of the bowl unit 338 to the base unit 336. Other corresponding female portion 347 and bowl unit standoff shapes and configurations are also contemplated herein. A corresponding number of bowl unit standoffs 342 and female portion 347 are shown; however, any number of either is also contemplated. The female portions 347 can be independently provided without association with the supporting feet 354. Preferably, the base unit 336 comprises at least one female portion 347 corresponding to each bowl unit standoff 342. In other embodiments, the bowl portion 338 can include one or more female portions 347 that instead receive a corresponding standoff from the base unit 336, among other contemplated combinations, variations, and alternative configurations.

In FIG. 19, a bottom side of the base unit 336 is shown with the control unit removable panel 346 removed, exposing a plurality of control assembly standoffs 352, a control recess 333, and a center recess 351 of the base unit 336. The control assembly standoffs 352 can receive fasteners 348 for attachment of control unit removable panel 346 (and control unit 324) to the base unit 336. A plurality of control assembly standoffs 352 can provide a more rigid and/or secure assembly when the removable panel 346 is installed and fastened to the base unit 336. As shown, a bottom side of the base unit 336, including the control recess 333 and the center recess 351, is shaped and sized to receive control unit 324 components. The center recess 351 in base unit 336 is preferably shaped and sized to receive power unit 350 and/or at least part of the heating unit 360 when assembled. The center recess 351 can be adjacent to center openings 345 in the base unit 336. The control recess 333 is also accessible when the removable panel 346 is removed. The control recess 333 is preferably shaped and sized to receive control components 326 or 328, and/or control knob 330 of the control unit 324.

As shown best with reference to FIGS. 15 and 17, the lid 316 is removable from a resting position upon an upper rim 356 of the bowl unit 338 of the cooking vessel 334. The lid 316, when installed or removed, can selectively expose or cover the interior 340 of the bowl unit 338. With the lid 316 at least partially removed from the bowl unit 338, a user can then add or remove food to/from the cooking vessel 334 accordingly. Lid 316 preferably includes a handle 320 and optionally includes an aperture 318, which can be configured to receive a direct temperature probe (e.g., probe 48) in certain embodiments. In other embodiments no direct temperature probe passes through the lid 316 or into the bowl unit 338. The handle 320 can be textured in order to improve gripping characteristics. The lid 316 can comprise a lid hanger, e.g., the handle 320, itself. Aperture 318 can further include a grommet 322 fitted to the aperture 318. The grommet 322 can be silicone, rubber, or any other elastomeric substance. Lid 316 can be transparent and can comprise glass for other non-handle 320 portions. The glass of lid 316 can preferably be tempered glass.

With reference now to FIG. 14, the base unit 336 is shown from below with the removable panel 346 installed. A bottom surface of the base unit 336 can include side vents 344, supporting feet 354 (which can be connected to or integrated with female portions 347 that are configured to receive bowl unit standoffs 342), and control unit removable panel 346 attached to the base unit 336 by one or more fasteners 348. One or more parts of the modular heating appliance 310 can produce heat, which in some cases could lead to undesirable hot spots. For example, a power unit 350 and/or control components 326 or 328 (see, e.g., FIGS. 21 and 22) can be fastened to the removable panel 346, and can create heat when in use. The heating unit 360 will also create or otherwise emit heat. Therefore, for example, to reduce certain hot spots throughout the modular cooking appliance 310, various vents, such as side vents 344, can be beneficially included in various embodiments. In some embodiments, the base unit 336 is configured to thermally insulate and/or separate the heated cooking vessel 334 and heating unit 360 from a supporting surface, such as a counter top or table. The base unit 336 can be composed of various plastics, metals, phenolic materials, or any other suitable material. The base unit 336 as shown comprises the control housing 332 that protrudes from the cooking vessel 334, and provides a bezel for control knob 330 in embodiments that utilize manual adjustments of control unit 324. The control knob 330 can penetrate the control housing 332 and can protrude for easy adjustment by the user. Also shown is a portion of a power cord 366 that connects the control unit 324 to a wall power outlet via a plug (not shown). The power cord 366 can be fixed to control unit 324 or removable in various embodiments. In alternative embodiments, any appliance or device contemplated herein can be portable and/or powered by a battery power source, e.g., when not plugged in.

With reference now to FIG. 21, an example of an analog control unit 324A is shown. FIG. 22 shows a digital control unit 324B, which differs from control unit 324A only by including digital control components 328 in place of analog (and/or mechanical) control components 326. The analog control components 326 or digital control components 328 contemplated herein can also comprise a combination analog/digital control unit 324. The control unit 324 can include various programmed or programmable cooking functions. For example, cooking functions and modes can include a slow-cooker setting, a higher-heat setting, a lower-heat setting, a roast setting, a sous-vide setting, a sauté setting, a sear setting, a rice setting, a boil setting, a manual temperature setting, manual or automatic timed settings, among various other multi-cooker settings ranging from general to specific, fully manual to fully automatic, and the like. The control units 324A or 324B can be programed in accordance with various PI/PID control schemes described herein.

For various functions of embodiments described herein, an on/off duty cycle can be selected through the control unit 324. For the digital control unit 324B of FIG. 22, the power unit 350 is electrically connected with various digital components 328 that may not be physically connected to knob 330. Control unit 324B can operate at least partially automatically according to various inputs. The digital components can include one or more circuits, such as one or more microprocessors, application-specific integrated circuits, controllers, or other circuitry. In such digital control unit 324B various cooking functions and modes can be controlled from various firmware, software, and/or any programmable computer or electronic storage or processing components, etc. In some examples, the digital control unit 324B can lack a physical connection between the knob 330 and the power unit 350. For the analog control unit 324A, various mechanical and/or analog components can provide a signal to the heating unit 360 and the power unit 350 without the use of digital or computer-based components. Various components of the analog control unit 324A can include various manual controls, mechanical linkages, switches, sensors, snap-action or thermally-activated components, analog circuitry, etc. Yet further embodiments can utilize some digital and some analog components in a control unit 324.

Control unit 324 (collectively for control unit 324A and 324B), can also comprise the power cord 366, the heating unit 360, and heating unit electrical leads 362 used to selectively power the heating unit 360. Example control units 324 can be partially integrated with the removable panel 346 in various embodiments. Digital control unit 324B as shown can include a non-mechanical, linkage-free digital control between control knob 330 and power unit 350. The power unit 350 or other part of the control unit 324 can include a controller configured to regulate power produced by the power unit 350. The power unit 350 can be fastened directly or indirectly to removable panel 346. The power unit 350 can interface with the heating unit 360 and the power cord 366. The power unit 350 can receive alternating current electrical power via power cord 366 and transform/rectify (if necessary) alternating current to direct current for use with heating unit 360. Heating unit 360 can include a Calrod, quartz, or any other resistive heating unit can be used herein. In one embodiment, the heating unit 360 includes a Calrod (Joule or “Ohmic” resistive) heating element with a rating of 800 Watts or more, as powered by the power unit 350. An additional electrical lead 364 can also be included in control unit 324, and can provided additional power, grounding, and/or sensing functionality to control unit 324.

As described in greater detail below, various proportional and integral based control schemes can be implemented (e.g., into control unit 324) using the modular cooker 310 described above. In this example, as contrasted with the slow cooker 10 with direct temperature probe feedback described above, an indirect temperature sensing probe or device can detect and cause the cooker to implement a PI (or PID) based control of the cooker heating unit without introducing a direct temperature sensor, probe, or thermistor into the cooking cavity itself. Instead, a sensing probe or device can detect temperature somewhere within the cooker as an indirect indication of an expected temperature of the food or liquid within the cooker. Compensation between the measured indirect temperature and the food or liquid temperature can be determined theoretically or empirically.

FIGS. 23A and 23B show cross-section views of a cooker 400 (e.g., 310, above) where an indirect temperature sensing probe 410 (e.g., similar to probe 376 described above) is internal to the cooker 400 itself and in this example contacts a lower portion of the bowl 412 from below, where the bowl is configured to hold a food product to be cooked. Various springs 414 or other contact enhancing features can be included such that the probe 410 receives thermal transmission from the bowl 412, itself during cooker 400 operation. Preferably and according to various embodiments, the heating element (not shown) is spaced or at least partially thermally insulated from the indirect probe 410 such that the probe 410 senses the temperature of the bowl 412 and not only the temperature of the heating element itself.

As shown in FIG. 23A, the sensing probe 410 is isolated from a heating element (see 451 of FIG. 23B) by, e.g., the surrounding aluminum of the bowl 412. Preferably, the probe 410 is only exposed to and in contact with the bowl 412 and is relatively unaffected by radiative energy from the heating element 451 or any other unintended inputs. Additionally, the heating element 451 preferably has one or more “cold pins” or non-heated portions (not shown) near the probe 410 that do not produce heat like the majority of the heating element 451 does along its length. This feature allows the heating element 451 in combination with the thermostat to achieve a more accurate representation of the average bowl 412 temperature. This is in contrast to the thermostat or sensor heating up too quickly by being located directly next to the heating element 451.

As shown in FIG. 23B, the thermostat location can be somewhat centrally located on the bowl 412 so that it is reading closer to an average temperature as opposed to reading the temperature directly next to the heating element 451 of the bowl 412. Sensor contacts 450 and 452, as shown in FIG. 23B show one possible arrangement for negative temperature coefficient (NTC) sensor/thermistor to contact bowl 412. In some embodiments, the heating element 451 can be cast into a plate of the bowl 512, reducing radiative effects. As described herein, an NTC sensor can take the form of a removable probe or a fixed sensor, e.g., that remains attached or in contact with an underside of the bowl 412. Any other suitable sensor/bowl arrangement is also contemplated herein.

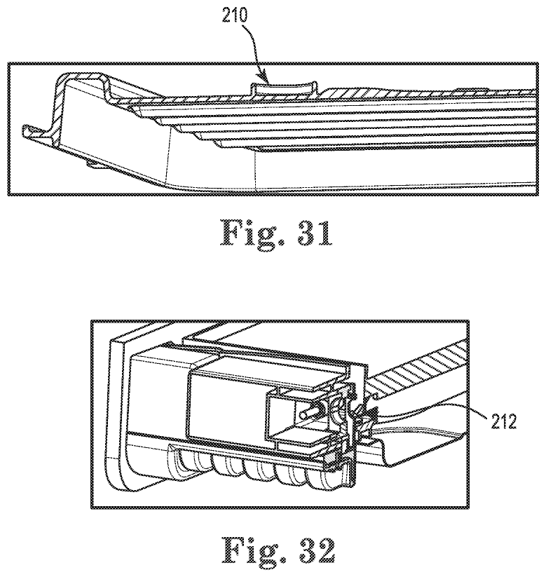

Additional NTC sensor locations for an appliance are also shown in FIGS. 31 and 32. FIG. 31 shows an NTC contact location 210 for a removable plate contact grill, and FIG. 32 shows an NTC measurement location 212 for a removable probe surface grill.

Another example of a modular cooking appliance 374 in shown with respect to FIGS. 24-28. Unless specifically stated otherwise, it is understood that the alternative modular cooking appliance 374 can include any features and/or functionality as the modular cooking appliance 310 also described above. Modular cooking appliance 374 is an example of a probe control-based example of the present disclosure. An alternative embodiment of a cooking vessel 387 including a base unit 386 with an open bottom end 388 and base structural cross-member 396 is also shown.

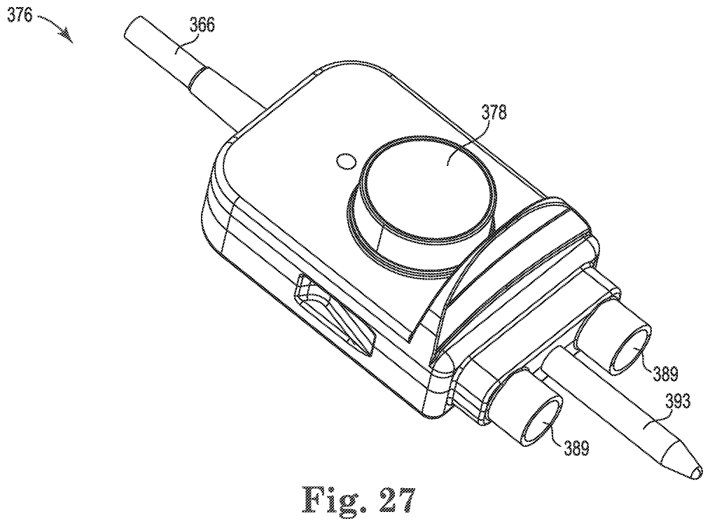

It may be desirable to have an easily disconnectable connection between control/power componentry and various other portions of the modular cooking appliance 374. For example, a user may desire to clearly separate components of the modular cooking appliance 374 that are safe for washing in a dishwasher, versus components that should not be washed in a dishwasher. A removable probe-based configuration can facilitate disconnection of various components in some embodiments. As shown with reference to FIG. 27, a removable probe unit 376 can include a knob 378 (or digital or automatic control input panel), a power cord 366, probe power interfaces 389, and a probe thermistor protrusion 393 or other component or connection. The probe unit 376 can utilize a friction fit to provide a secure, yet removable connection to the modular cooking appliance 374.

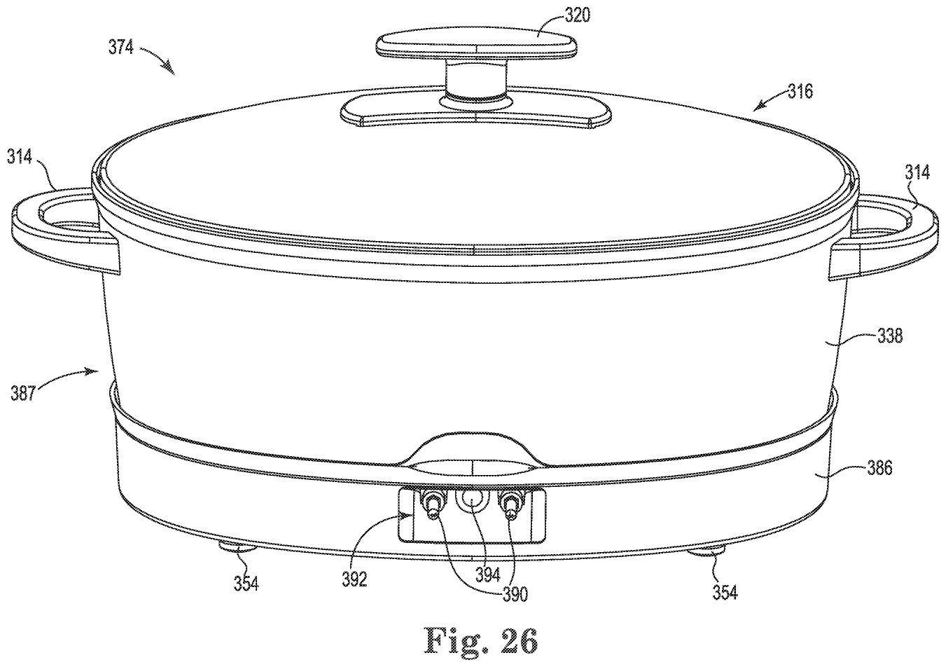

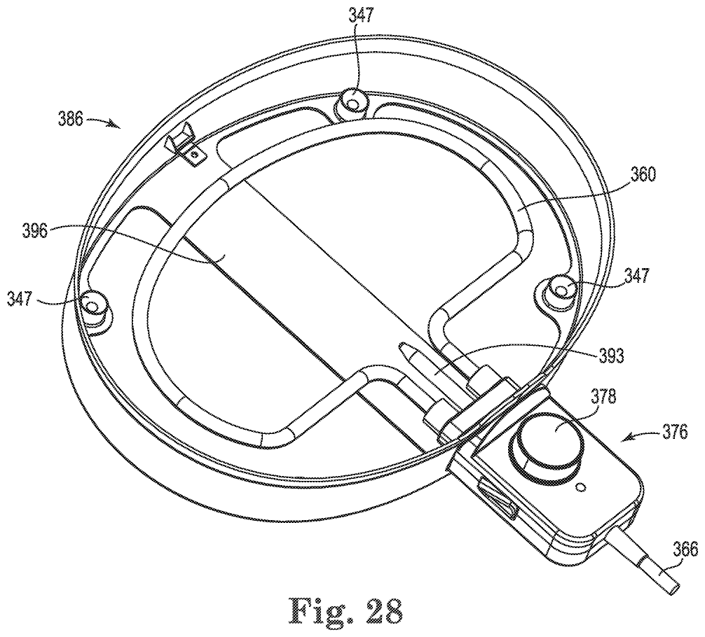

As shown with reference to FIG. 26, the modular cooking appliance 374 when the probe unit 376 is removed reveals an opening 392 in the base unit 386 configured to receive at least a portion of the probe unit 376. Also shown are probe-receiving interface connections 390, which are configured for use in transferring power from the probe unit 376 to the heating unit 360. A probe thermistor protrusion receiving opening or cavity 394 is also shown and configured to receive the probe thermistor protrusion 393 of the probe unit 396. The probe thermistor protrusion 393 can thermally interface with the receiving opening 394 in order to create a conductive thermal connection between the bowl unit 338 and the probe unit 376. With reference to FIG. 28, the heating unit 360 is shown directly connected to the probe unit 376, e.g., to sense a cooking temperature during operation. In such an embodiment, the probe unit 376 would then include the function of the control unit 324, power unit 350, and all other user interfaces.

Furthermore, and with reference to FIG. 29, a defined (and/or determined) “offset equation” can be introduced in particular to indirect sensing control embodiments and according to various implementations. Such offset equations can include a step, function, ratio, or the like that relates a measured variable to a desired control variable in order to relate an indirectly sensed variable to an equivalent direct measurement, e.g., inside a cooking vessel. For example, a sensor (e.g., NTC thermistor) can be located a distance and be partially thermally isolated or distant from a desired sensing location. The offset equation can relate an actual measurement location (e.g., underneath a cooking vessel) to a desired measurement location (e.g., inside the cooking vessel). The offset equation generally only applies when the two variables of measured and set point variables are not the same. An example offset equation can indirectly relate a measured pot temperature to a controlled water temperature in various multi-cooker embodiments. Offset equations can be derived through empirical data, can be determined using “guess and check” methods, or can be determined using simulation data, among others. In some embodiments, the offset equation can create a correlation between a measured variable and a set variable to define the output variable (e.g., duty cycle D).

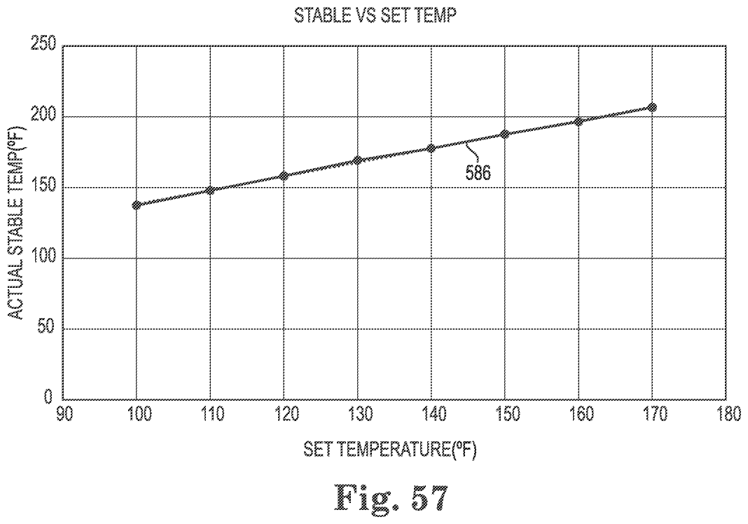

In testing, a prototype appliance with an example PI control scheme as described herein was implemented. The appliance was then tested to control at a range of temperatures, and in testing the actual corresponding water temperature was measured as compared to set temperature, an offset equation relation was derived from the results, e.g., Tₛₑₜ=(Tᵢₙₚᵤₜ−39.25)*1.012. Offset equations can also be derived from thermal simulations, where a fixed power input is assumed, along with known material properties and measurement point(s), In other embodiments, empirical data is optimal to account for the actual performance characteristics. See also FIG. 57 for an example graphical correlation 586 between a measured variable (actual stable temperature in ° F.) a set variable (temperature in ° F.) for an appliance such as a modular multi cooker.

FIG. 29 shows an example control scheme similar to 50 of FIG. 4, adapted for use in a sous-vide slow cooker (e.g., slow cooker 10 in sous-vide mode or a stand-along sous-vide appliance) embodiment as described herein. The control scheme of FIG. 29 can be adapted for use in any sous-vide cooking system or appliance. FIG. 30 provides for example variables or inputs for use in the control scheme of FIG. 29 and can be similar to the inputs of FIGS. 5 and 6, while more specifically adapted for use in a sous-vide embodiment. In particular, the beginning setup of the sous-vide control of FIG. 29 is modified in view of the indirect temperature sensing and control aspects. As shown at 518, an offset equation of Tₛₑₜ=(Tᵢₙₚᵤₜ−39.25)*1.012 is one example of an offset used in a modular cooker as described herein. FIG. 30 shows variables and constants that can be used for an entire set of functions. However, not every function and instance would require each and every variable shown.

In more detail, FIG. 29 shows a flowchart of a process 500 for sous-vide control according to various embodiments, herein. The process starts at a beginning set up 510, which includes operations 514-520, and continues at main loop 512, which includes operations 522-560.

The beginning set up first includes operation 514, in which T_{probe} is read. Next, at operation 516, variable starting values are set as E_{I}=0, I_{flag}=0, and switch time=current time. Next, at operation 518, Tₛₑₜ is defined as (Tᵢₙₚᵤₜ−39.25)*1.012, an example offset equation. Next, at operation 520, the duty cycle (D) is set as K_{P}*(Tₛₑₜ−T_{probe})+(K_{I}*E_{I}). The process then continues to operations of the main loop 512.

The main loop 512 starts at operation 522, in which T_{probe} is read. Next, if T_{probe} is determined to be greater than Tₘₐₓ at operation 524, then the process proceeds to operation 542. At operation 542, the relay output is set to OFF. If T_{probe} is determined to be less than Tₘₐₓ at operation 526, then the process proceeds to on 528, 544, or 546. The process proceeds to operation 528 if Tₛₑₜ−(1/K_{P})+(K_{I}*E_{I}/K_{P}) is less than T_{probe}, and T_{probe} is less than Tₛₑₜ+(K_{I}*E_{I}/K_{P}). Following operation 528, the I_{flag} is set to 1 at operation 530. The process proceeds to operation 544 if T_{probe} is less than or equal to Tₛₑₜ−(1/K_{P})+(K_{I}*E_{I}/K_{P}). The process proceeds to operation 546 if T_{probe} is greater than or equal to Tₛₑₜ+(K_{I}*E_{I}/K_{P}). Following operations 544 or 546, the I_{flag} is set to 0 at operation 548. Following operations 530 or 548, the process proceeds to operation 532, where integral error (E_{I}) is set to E_{I}+(I_{flag}*(Tₛₑₜ−T_{probe})*dt). Following operation 532, the process continues to operation 534 where the duty cycle (D) is set. At operation 534, the duty cycle (D) is set as K_{P}*(Tₛₑₜ−T_{probe}) (K_{I}*E_{I}), if D>1, D=1, and If D<1, D=0. Next, at operation 536, time (t) is set as current time−switch time. It is next determined if relay output is on or off. If the relay output is on, the process proceeds to operation 538. If the relay output is off, the process proceeds to operation 550.

After operation 540, it is determined if t is greater than D*cycle time, or at operation 558, if t is less than or equal to D*cycle time. If it is determined at operation 540 that t is greater than D*cycle time, then the relay output is set to off at operation 542, and the process returns to operation 522. If at operation 558 it is determined that t is less than or equal to D*cycle time, then the process returns directly to operation 522.

After operation 550, it is determined if t is greater than cycle time at operation 552, or t is less than or equal to cycle time at operation 554. If at operation 554, t is less than or equal to cycle time, then the process returns to operation 522. If at operation 552, t is greater than cycle time, then the process proceeds to operation 556, when switch time is set as equal to current time. After operation 556, relay output is set to on at operation 560, and the process returns to operation 522. Any number of cycles of main loop 512 are contemplated according to various embodiments.

There may be a steady linear relationship between the steady measured water temperature and temp at the temperature-sensing NTC (see FIG. 57) but other relationships are also contemplated. Depending on the locations of the measurement and set points, this could be any type of relation. The relation could also be transient, depending on the amount of time the heating element (or other active element) is turned on to determine the offset between the set and measured temperature values. A pre-heat period where the heating element is powered on for a substantial time can allow materials such as metal surrounding the sensing probe to rise relatively higher than would occur in a normal duty cycle (e.g., 30 seconds). The above can be a difference between the control scheme of FIG. 4 and what is being used in other embodiments, such as the modular cooker 310. Various other changes between appliances and configurations can be effected by adjusting the offset equation constants to fit the particular construction.

In addition to the embodiments described above that utilize improved PI control schemes, certain examples and usages based on the improved PI control schemes can further add in a derivative control element (the “D” of PID control schemes). Therefore, improved PID control schemes are also described herein that build upon the PI schemes described above. Some further examples of PI and PID control schemes are therefore described below, which can include various multi-cooker and sous-vide cookers described above as applied to a wide range of applications and appliances. Certain differences and unique characteristics of the improved control schemes are noted, including those that would necessitate modifications of the control schemes and explanations therewith. Although some factors are noted and discussed, it should be understood that other factors may also need addressing and/or modification according to various embodiments. For example, derivative control with derivative constant (K_{D}) can be added for some cases. The derivative constant and control can be added in particular in cases where minimal overshoot or improved steady state precision are more notably beneficial to performance.

Sous-vide cooking can particularly benefit from high-precision (low temperature variance) temperature control for optimal cooking results. In particular embodiments disclosed herein enable superior control and a narrow-controlled range of temperature for sous-vide cooking within a vessel without a need for a separate probe internal to the vessel. As described in embodiments herein, an appliance (e.g., slow cooker 10 or modular cookers 310 or 374) can utilize sensed temperature conditions underneath the vessel and use and offset equation and PI/PID control to perform effective sous-vide cooking, including with the introduction of a cold food product to the cooking vessel during operation.

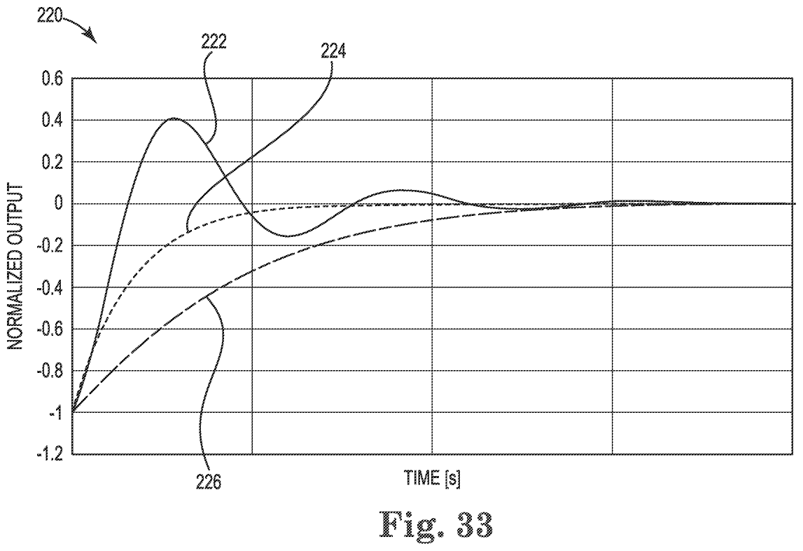

With reference to FIG. 33, various appliances and the like have different damping, under- and over-shoot characteristics. It is known that various levels of damping can be used in various control schemes, such as critical damping 224, underdamping 222, and overdamping 226, and shown in chart 220 of FIG. 33. Some examples of critical damping include one-tenth critical damping, half critical damping, and twice critical damping. When the derivative control element is used, it can assist with control in certain appliances particularly with characteristics that make PI control challenging. However, introducing the derivative control element can require optimization based on demand and tuning as compared to a PI control scheme. Therefore, where possible it may be desirable to employ on PI control instead of PID control for time and cost savings. Throughout, examples of PI and PID control schemes are contemplated, and each can be used with any particular embodiment discussed herein.

Container cookers as used herein can include e.g., sous-vide slow cookers, low-cost multi-cookers, modular multi-cookers, multi-cookers with air fry, kettles, rice cookers, among others. Slow cooker 10 and modular cookers 310/374 are examples of container cookers. A multi-cooker with air fry can function similarly to a modular multi-cooker described above, with, e.g., a fixed NTC thermistor measuring a pot surface temperature either from above or below. See examples shown in FIGS. 31 and 32. See also FIGS. 23A and 23B. Variables such as cycleTime, K_{I}, K_{P} will be similar with an offset equation defined based on physical testing or simulation data. It is contemplated that a rice cooker can be equipped with control and operation similar to the sous-vide and low-cost, modular multi-cooker embodiments described herein with similar constants and offsets and without significant hardware changes.

Electric kettles share many characteristics with container cookers (e.g., slow, multi, dry, wet, etc.) but typically operate at higher power. PID control may have some benefit when implemented in traditional kettles and could be beneficially implemented in “precision” kettles that quickly bring water up to temperatures below boiling for different beverages and hold that temperature constant over time. For a kettle, high wattage and low water load (about 2 L) may use short cycleTime (about 10 seconds) to maintain temperature control. Kettles can preferably use indirect temperature control disclosed herein. This high switching frequency could utilize a switching device such as a silicon-controlled rectifier (SCR) or bilateral triode thyristor (TRIAC) as hardware in place of a mechanical relay switching device to keep pace and last for the product's intended design life. Because the water heats up significantly faster than it can cool, tuning parameters would need to be set close to a critically-damped system to prevent overshoot without sacrificing time to reach the set temperature. Derivative control could be added to the control loop to better maintain steady state temperatures. If derivative control is added, a derivative error (E_{D}) term would be added to the process, and the definition for the duty cycle (D) would include the terms: E_{D}=(T_{probe,1}−T_{probe,2})/cycleTime where D=K_{P}*(Tₛₑₜ−T_{probe})+(K_{I}*E_{I})+(K_{D}*E_{D}). As used herein, E_{D} is derivative error, K_{D} is the derivative constant, K_{I} is the integral constant, and E_{I} is the integral error.

For dry container cookers, such as some toaster ovens and air fryers, these are functionally substantially the same for the purpose of (e.g., PID) control. In some examples, air temperature within the container cookers would be measured and the heating element's duty cycle would be regulated to control to a set temperature. For an example toaster oven contemplated herein, the temperature outside the cooking cavity can be measured indirectly, such as at a point that contacts an underside of a cooking surface or where a temperature sensor is placed on an outside side wall of the cooking cavity, e.g., inside a control panel cavity, but outside the cooking cavity. An offset equation can relate this measured temperature to a temperature internal to the cavity. Pressure cookers could similarly measure steam temperature as the input to the closed loop system. However, temperature control may not be as sensitive as in ovens. Ovens are often subject to rapid temperature drops due to the door opening during use and operation. Improved control schemes disclosed herein and allow for fast recovery from temperature drops in the heating cavity due to door opening, e.g., using PID control. This example would be a case where the integral error accumulation flag (defined in the steps described herein) would be beneficial, preventing windup when the duty cycle cannot surpass operating at full power. No significant hardware or control process changes would be needed to implement PID control in a digital toaster oven or air fryer. Furthermore, “bagless” sous-vide cooking can be performed using a dry container cooker embodying improved control schemes disclosed herein.

Therefore, the addition of derivative control to PI control could be useful to maintain highly precise temperatures however measurement noise would need to be considered, possibly adding a step when calculating E_{D} to average the measured air temperatures over a determined period of time. A steam/humidity controlling oven or other cooker appliance is also contemplated in which a PI/PID control scheme is used to control the humidity levels in the chamber in conjunction with the temperature control. Nevertheless, as used herein, any instance of “PID” control can be replaced with “PI” control (and vice-versa), as applicable to each example provided.

With reference to FIGS. 31 and 32, and for electric grills and griddles, e.g., contact grills, surface grills, waffle makers, temperature control operates in a similar manner to the cooker 310 described above, including for indirect temperature sensing according to various embodiments. A temperature is measured at the bottom of a cooking surface (e.g., underneath the cooking surface) and using an offset function, the measured temperature is related to the surface temperature. A contact grill can use proportional only control with D=K_{P}*(Tₛₑₜ−T_{measured})+D_{O}, where D_{O} is an offset defined for each set temperature according to physical testing, and T_{measured} (measured temperature, e.g., container temperature) is functionally equivalent to T_{probe} as used herein, but without the use of a probe. This basic control scheme can work to some extent as the acceptable temperature range is much larger than sous-vide applications and the temperature is typically not displayed to the user. However, grills and grills still benefit from PI/PID control, e.g., to speed up initial heating, provide precise temperature control, and with reducing the likelihood that a food product would be overcooked, burned, or the like. Smoke production during operation can therefore also be reduced. Therefore, PI/PID control is useful for more precise applications. Grills and griddles can be modified to incorporate PI/PID control with no significant hardware changes, and Kₚ, K_{I}, and the cycleTime could be tuned to achieve positive results. The cooking surface can be a plate, including a thermally conductive plate.

With reference again to FIG. 29, and according to various embodiments where one or multiple “main loops” are performed, a loop time (dtₗₒₒₚ) can be set or determined separately, independently, and optionally irrespectively of the main loop cycle time (cycleTime). A loop time is preferably shorter and therefore faster repeating than the duty cycle, main loop cycle time. In some examples, the loop time can be somewhat or significantly shorter than the cycle time. In certain particular examples, the loop time can be half the cycle time. In other examples the loop time can be a third, a fourth, a fifth, a sixth, a seventh, an eighth, a ninth, a tenth, or any other fraction of the duty cycle time. In other examples, the loop time can be set to be shorter or irrespective of the duty cycle time, and can be unrelated yet shorter than the duty cycle time. A shorter loop time compared to a cycle time and allow for more agile control and adjustments while retaining a relatively slow switching duty cycle if desired. A slower switching duty cycle can have benefits in particular where a mechanical relay is utilized and minimizing a total number of switching cycles can extend appliance life. Therefore, utilizing a relatively slow switching duty cycle time with better ability to correct for shocks or changing to a system can be advantageous.

Having a loop time that is shorter than the duty cycle time is therefore preferable over calculating the duty cycle only at the beginning of the cycle time. In another example, a duty cycle is set to refresh and reset at and interval of 20 seconds. However, a frozen or low temperature piece of food is introduced to a cooking appliance at 5 seconds into a duty cycle cycleTime. Using a shorter loop time (e.g., every second), would allow the appliance to adjust a duty cycle sooner than the 15 seconds that remain, particularly where the heating element is actuated on or off during a current duty cycle and in some embodiments prior to another duty cycle starting. In other embodiments, a future duty cycle can be calculated during a time between a loop time and the present duty cycle completing.

For example, the E_{D} can be defined as (T_{probe}−T_{probe,old})/dtₗₒₒₚ where T_{probe} is the probe temperature at the present time, T_{probe,old} is the probe temperature at the previous loop, and dtₗₒₒₚ is the time since the previous loop. As shown in FIG. 29, the duty cycle can be updated until D*cycleTime has elapsed. One benefit is that it allows D*cycleTime to increase or decrease as the temperature response changes, making the control scheme more reactive even where a duty cycle has relatively few and infrequent updates or completed duty cycles.

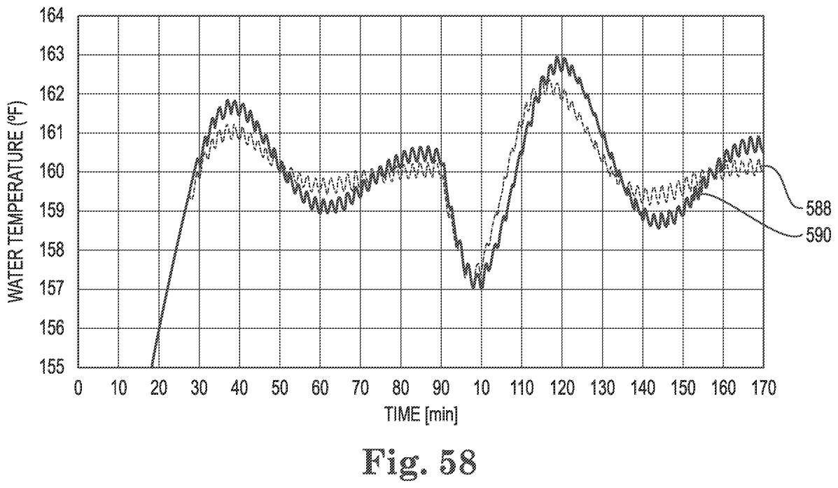

With reference to FIG. 58, water temperature vs. time performance is shown as a chart for an example cooking appliance, such as a container cooker (e.g., sous-vide slow cooker) that is equipped with a control scheme as shown and described with reference to FIG. 29. As shown in the comparative chart of FIG. 58, two lines are shown that represent 1. one embodiment where duty cycle is equal to loop time (No DUpdate) at 590 and 2. one embodiment where loop time is shorter than duty cycle (DUpdate) as shown at 588. As shown, with DUpdate (588) water temperature overshoot and undershoot are lower (smaller) on the initial heat up and when a cold food load is added at about 90 minutes. The DUpdate line 588 recovers more quickly and again overshoots and undershoots less than the No DUpdate line 590. Therefore, as shown, when the control schemes described herein are configured to use a shorter loop time (DUpdate, 588), the water temperature responds more quickly to changes such that control is yet further optimized. With a constant duty cycle time, therefore, embodiments can be configured to a shorter interval loop time to improve control performance, tightness of temperature range, and response.

In another example, T_{probe,1}−T_{probe,2} can represent a difference in measured temperatures at a temperature probe between two consecutive power cycle loops. Calculating E_{D} for each about 10 second power cycle instead of each about 10 millisecond control loop can be preferable to help reduce error due to measurement noise. There are also other ways the filter the derivative signal. Optimizing the interval time (dt) for the derivative may beneficially reduce noise. For example, where a loop frequency is 5 Hz (5 loops per second) and the cycleTime is 10 seconds, (e.g., 5*10=50 loops per cycle) a time interval/segment (dt) of 20 ms for derivative control may be disadvantageously noisy, and 10 seconds may relatively slow to react. In preferable embodiments, therefore, the interval time (dt) can be determined and tuned separately from other parameters. Loop time as described above can be implemented with any electrical appliances, devices, or method described above or below, herein.

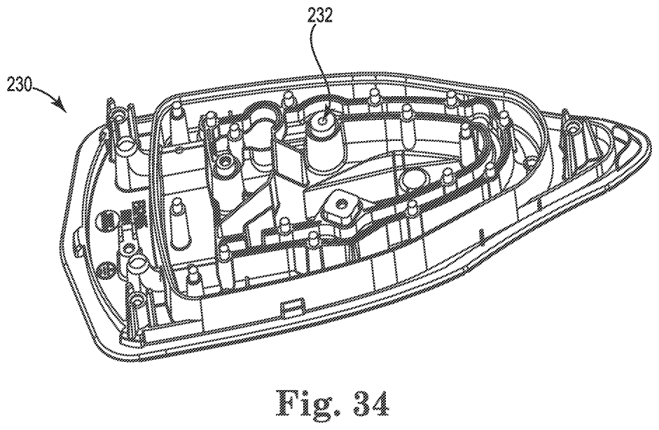

With reference now to FIG. 34 and for electrical clothes irons, indirectly-sensed PI/PID temperature control can share many similarities to the other examples of indirect temperature control as implemented in multi-cookers or grills. The iron's boiler temperature can be measured on top of the soleplate 230 (e.g., at example temperature feedback location 232) to control the bottom surface, e.g., via duty cycle regulation. In certain examples, high power and fast cycle time could benefit from an SCR in place of a mechanical relay to meet the product lifetime requirements. In other cases, a mechanical relay is preferable. For example, some irons contemplated use a cycle time (cycleTime) of about 10 seconds. At this frequency, the mechanical relay life may exceed the expected product life. However, if the cycleTime were to be reduced, a solid-state switching device such as an SCR could become more beneficial.

The temperature offset equation relating the measured boiler temperature to the predicted bottom surface temperature will change depending on whether the iron is set to a steaming function (or not). For example, an iron set to steam would typically operate at maximum heating power. This can be accounted for within the program, but different thermal profiles would need to be developed for each setting. PI/PID control in an iron can enhance thermal control to better understand and compensate for variances between measured temperature and set temperature. The example temperature feedback location 232 for an iron soleplate 230 is shown at FIG. 34. An offset equation can relate a measured temperature above the soleplate surface to the actual soleplate temperature. More precise temperature control for irons can allow for better and more consistent garment care results, lower risk of overheating or burning of fabric, enhanced performance, better flexibility and adaptability for varying fabric types, improved temperature recovery while steaming including reduction or elimination of water dripping, and improved user satisfaction. Electrical irons can be controlled using lower-cost, analog circuitry. Also contemplated and related to irons are various steaming appliances, such as steamers, steam stations, and the like.

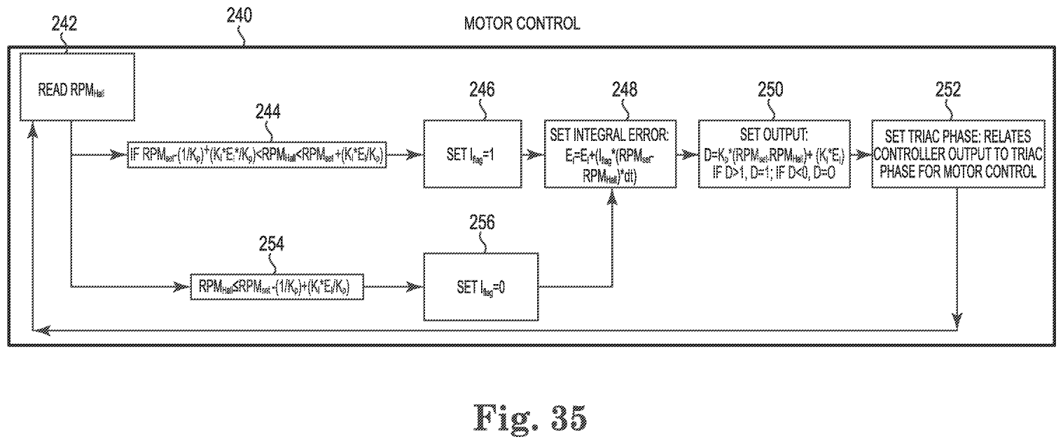

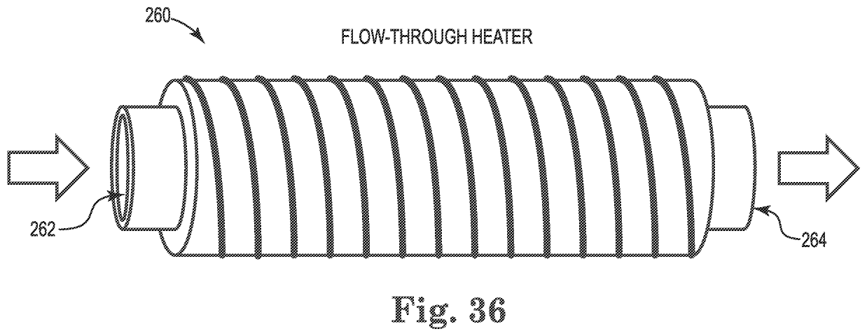

With regard to electric motors and control of motors, an example motor control scheme for an example appliance is shown at FIG. 35. Although the following is intended to describe motor control for mixers in particular, similar schemes also apply to any other motor-based embodiment, including food processors, blenders, and other variations, such as hand mixers and any other motor-driven applications, such as devices, appliances, or electrified vehicles. This category of motor-based device and control using disclosed PI/PID control can differ from other applications in that a PI/PID controller would be used to measure and control for rotation speed by varying the AC (or DC) power delivery to a motor, e.g., by varying current and/or voltage. Improved motor control as described herein can accurately control motor RPM and power for optimal performance and can maintain a smooth rotation performance while in operation irrespective of resistance/load. Cavitation and undesirable speed fluctuations can also be reduced using control schemes disclosed herein. In the example of a mixer, repeatability and consistency of mixing and recipe directions can also be improved with more accurate control described herein. Offset equations and indirect speed measurement may not always apply to electric motor-based appliances. However, in other embodiments a motor speed can be measured indirectly, in other words other than directly through a motor itself, and any PI/PID control schemes described herein with or without an offset equation can be implemented in these examples.

For motor control, the main control loop can be adjusted with temperature readings being substituted for the rotation speed (e.g., revolutions per minute, “RPM”) measured by the Hall-effect sensor. In place of a duty cycle being output for a set cycle time, a switching device (e.g., TRIAC) phase could be updated continuously. The main control loop would roughly be as shown in FIG. 35. Because the controller is determining the motor's operating power, the system is not bound by the same physical limitations such as maximum heating rates or depending on natural convection for cooling, instead being limited by the range of the motor. The steps flagging integral error accumulation are useful in cases of sudden changes to the system such as blending or mixing cavitation, mixing food with varying consistency, etc. In the example flowchart of FIG. 35, a motor control may not turn the motor “off” when setting motor speed, but may instead simply modify the output RPM based on a set point and measured RPM. Existing mixers and other motor-based appliances can be adapted to incorporate improved control schemes disclosed herein without substantial hardware changes. Food processors and mixers can beneficially have improved speed precision and control, including to account for sudden loads. In various embodiments, a blender configuration can be adapted for use as a food processor, which can reduce noise, gearbox complexity, and the like. Motors contemplated herein include AC motors, DC motors, brushed motors, brushless motors, variable reluctance motors, synchronous motors, asynchronous motors, universal motors, and combinations and variations thereof.

In more detail, a flowchart for a motor control process 240 is shown at FIG. 35. The process starts by reading a motor RPM using a Hall-effect sensor (RPM_{Hall}) at operation 242. If it is determined at operation 244 that an RPM setting (RPMₛₑₜ)−(1/K_{P})+(K_{I}*E_{I}/K_{P}) is less than RPM_{Hall}, which is also less than RPMₛₑₜ+(K_{I}*E_{I}/K_{P}), then the process proceeds to operation 246. If it is determined at operation 254 that RPM_{Hall} is less than or equal to (RPMₛₑₜ)−(1/K_{P})+(K_{I}*E_{I}/K_{P}), then the process proceeds to operation 256. At operation 246, the I_{flag} is set to 1, and at operation 256, the I_{flag} is set to 0. Operations 246 and 256 next proceed to operation 248, where integral error (E_{I}) is set to E_{I}+(I_{flag}*(RPMₛₑₜ−RPM_{Hall})*dt). Next, at operation 250, the output duty cycle (D) is set to K_{P}*(RPMₛₑₜ−RPM_{Hall})+(K_{I}*E_{I}), where if D>1, D=1; and if D<0, D=0. Next, at operation 252, a TRIAC phase can be set, which relates controller output to TRIAC phase for motor control, and the process can return to operation 242.

With reference now to FIG. 36, and with respect to certain electric heaters, and more specifically “flow-through” fluid heaters, various control aspects herein can be applied. A flow-through fluid heaters 260 can include a cool water intake 262 and a hot water outlet 264, and can be generally tubular and operatively heated by a heating element, e.g., a heating coil. Flow-through heaters 260 can be utilized in appliances such as coffeemakers, which can utilize such a flow-through water or other fluid heater that can control flow rate and/or heating rate in order to accurately control an output water temperature, e.g., for a precise coffee brew. Other uses of precision-controlled flow-through fluid heaters include hot water dispensing, taps, and water heaters in general, such as on-demand, tank-less water heaters. PID control is typically not utilized in conventional coffee makers which depend on boiling water and typically operate at continuous full power. Instead, it could be beneficially implemented in appliances which use flow-through water heaters, measuring output water temperature to control flow rate by regulating the pump speed, including other types of coffeemakers. Some embodiments provide a constant full power output from the heater, and vary the flow speed (e.g., using a separate pump unit). However, either the heater duty cycle or flow rate can be controlled to reach the set temperature, the very fast (about 1 second) response time would require very short heating cycles. Using a switching device (e.g., TRIAC) to control the power delivered to the pump could lead to smooth operation. With a modified heating design, this system can be applied to a precision kettle control scheme.

Derivative control and heavy damping could help to ensure that water does not boil and is maintained at a steady temperature of 92-96° C. (197.6-204.8° F.) or other targeted preferred temperature and/or range. Although the system is not subject to random temperature spikes, considerations would need to be made concerning the initial heating period. The water temperature sensor will start at ambient temperature and quickly climb near the set temperature once water flow begins. Therefore, improved water temperature consistency can be achieved by managing a fluid-heating device's (e.g., flow-through heater 260) flow rate over the heating element, leading to a smoother all-around operation.

Various embodiments of the flow-through heater 260 shown in FIG. 36 can be used to achieve coffee production temperatures that satisfy the European Coffee Brewing Centre (ECBC), Specialty Coffee Association (SCA), e.g., “Golden Cup Standard,” or other beverage regulation and/or certification bodies and/or standards, which are each incorporated by reference herein as applicable. According to various embodiments, the flow-through heater control can provide improved coffee flavor, and upgraded performance in relating to temperature consistency and control in addition to the total dissolved solids and general quality of beverage that results. Finally, embodiments herein can more quickly bring water to a desired heated but sub-boiling temperature and can in some cases hold the desired temperature for an extended period of time (e.g., as in a kettle). Undesirable steam pulsing or production at and end of a brew cycle can also be reduced. Precision temperature control and flow control can also be beneficially employed in coffeemakers that provide dual-brew functionality, e.g., single-serve and carafe brew modes.

Now with reference to hair care and more specifically hair or blow driers, various control aspects above can be applied. This application shares many similarities with the above flow through water heater 260 of FIG. 36. Air temperature at the outlet is the measured variable however two factors, blower speed and heater duty cycle, could be the regulated outputs. An additional control step can relate the output air temperature to the expected hair temperature. Derivative control can provide fast response time, overshoot mitigation, and potential temperature spikes due to appliance use. Low heat capacity and high convection rate can quickly respond to changes in temperature setting as needed. PI/PID control disclosed herein can improve regulation of blower speed and/or temperature control. Therefore, disclosed blow driers can also relate output air temperature to the expected hair temperature and control a fan speed or heating element temperature accordingly for optimal control. Natural convection and forced convection space heaters can also utilize the principles applied to the blow driers described above, with or without an active fan and/or oil or other liquid circulation features.

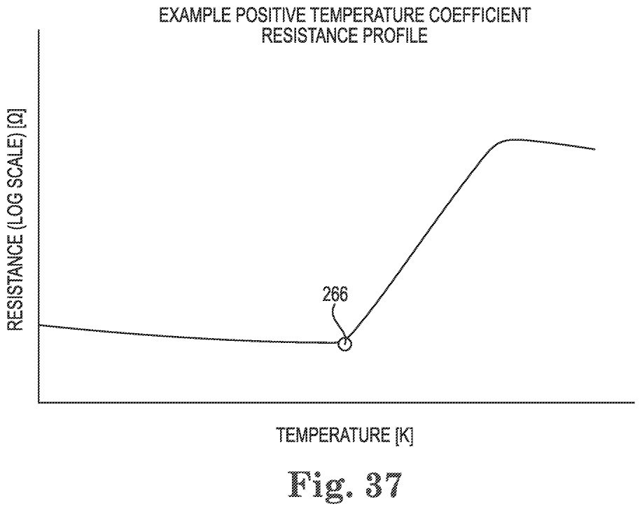

With reference to contact-based heating appliances such as curling irons and hair straighteners (can be referred to collectively as “stylers”) the disclosed direct or indirect sensing control schemes can also be applied. Stylers configured to use improved PI/PID control disclosed herein can measure a difference in set temperature and a measured temperature value to provide a corrective heating action. Stylers contemplated herein preferably utilized a positive temperature coefficient (PTC) heating element with a resistance profile as shown in FIG. 37. As shown, a transition temperature 266 is shown where a minimum resistance is achieved of the PTC heating element. PTC heating elements provide for fast initial heating due to high power and lower resistance, and resistance increases with temperature thus limiting power flow over time. For the purpose of PI control, hair straighteners and curling irons can be functionally the same. Both appliances use SCRs to regulate power draw with a very fast (under 5 seconds, or even about 1-2 seconds) cycle time. This cycle time (cycleTime) can be restricted from being too low per certain agency requirements (e.g., IEC 6100-3-3), which limits the switching frequency to prevent affects to the electrical grid. In addition, if the calculated duty cycle is greater than 0.5 (50%), full wave control can be implemented with the calculated duty cycle. If the calculated duty cycle is less than or equal to 0.5, half wave control can be implemented with twice the calculated duty cycle (e.g., D=0.4, where a first half of wave is kept on for D=0.8, and a second half of the wave does not turn on, and D=0.)

In various embodiments, such as indirect sensing embodiments, a predefined, constant offset equation preferably relates the measured temperature at the heater to the set plate or barrel temperatures for hair straighteners or curling irons. These appliances use a PTC heater, meaning the electrical resistance increases and the power draw decreases as the material temperature increases. This relation can be determined and used to configure and set the duty cycle. Stylers can benefit from improved PI/PID control to reduce hair damage and improve styling efficacy, including for varying hair types and styling options. For example, stylers disclosed herein and provide tighter temperature control, and can respond to contact with hair and more quickly respond to changes to temperature settings and the like.

The following is an example duty cycle for use with a PTC-based appliance that varies based on temperature. Set duty cycle: D=A_{PTC}(T_{probe})*(K_{P}*(Tₛₑₜ−T_{probe})+(K_{I}*E_{I})); If D>1, D=1; if D<0, D=0.

Here, A_{PTC} represents a temperature dependent multiplying variable that would be defined by the heater's specific resistance profile and empirical testing. This is one example of a possible approach. Some appliances can reset the integral error (E_{I}) value for each set temperature and make use of an integral error (E_{I}) accumulation band to prevent or reduce integral wind-up from sudden changes such as the heated surface making contact with the user's hair.

With reference to appliances or devices such as electric shavers, a similar control design is used compared to mixers (see FIG. 35) in that a PI/PID controller can measure rotation (or oscillation) speed in order to control a motor's duty cycle (or voltage/power output) using a switching device (e.g., TRIAC) with a continuous output. The output can provide at general duty cycle control instead of phase control where the motor is a DC motor. PI/PID control can be used in a shaver to maintain a smooth cutter rotation/oscillation performance while in use including when subject to variable loads. Improved control disclosed herein can provide improved performance to shavers including over a variety of hair types and densities. More consistent results including over a long term are thus achieved. In place of direct rotation speed measurement (e.g., using a Hall-effect sensor), the controller can instead use the rate of voltage spikes of the motor's commutator as the input variable. For cordless, DC-power embodiments such as shavers, using the voltage spike speed measurement can reduce complexity and cost compared to using Hall-effect sensing. These spikes can be isolated and have been found to be proportional to the motor RPM. Shaver cutter rotation (or oscillation) speed is highly subject to disturbances as the resistive load changes frequently in operation. This property makes derivative control and integral error accumulation bands useful in maintaining smooth performance.

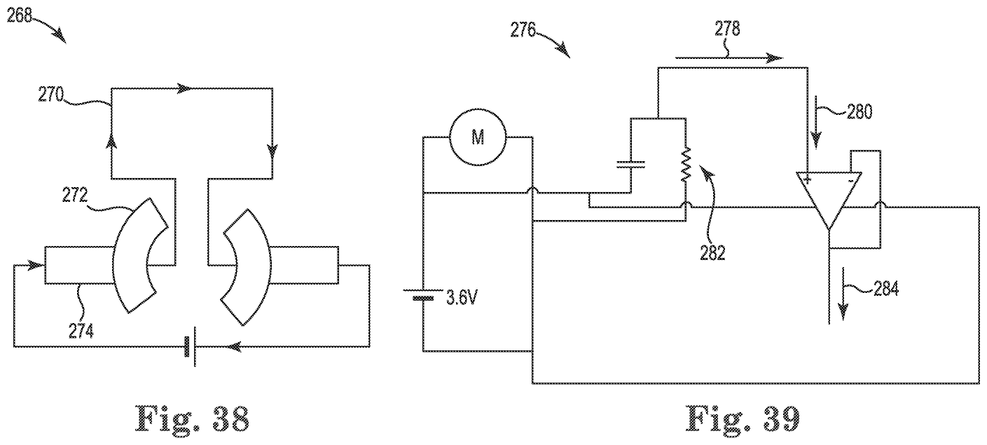

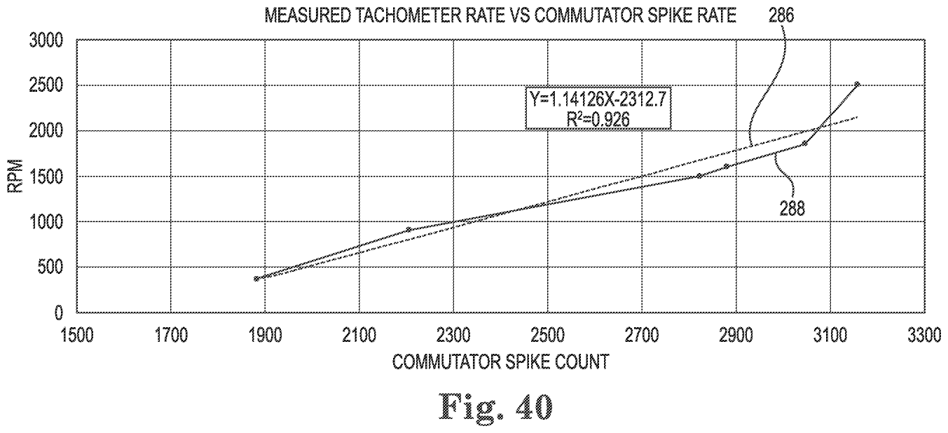

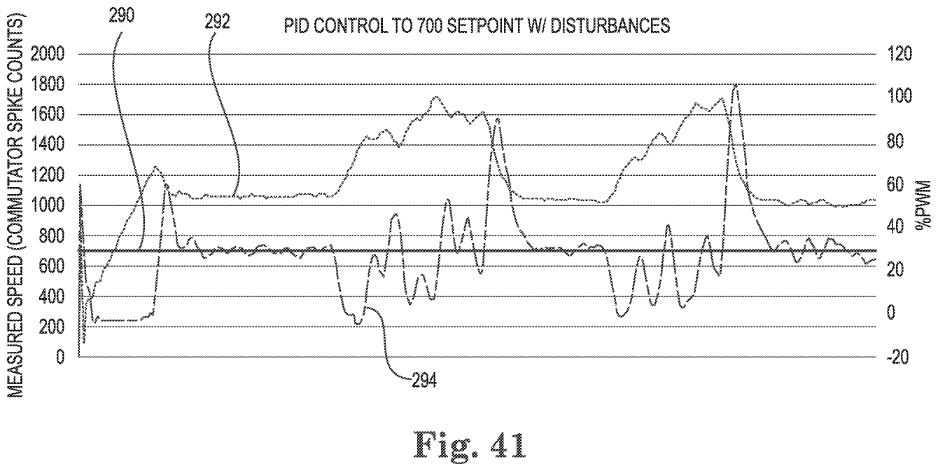

See also FIGS. 38-41 and associated description below for more detail relating to rotation speed measurement using voltage spikes. As described below, motor speed can be determined based on a commutator spike count, as shown in the shaver motor example of FIG. 40. This commutator spike count for motor speed determination in a shaver is an example of indirect measurement of rotation speed and can be effectively an offset relation for motors. Direct speed measurement using a Hall-effect sensor is another motor speed measurement approach that may not utilize an offset equation. Commutator spike counting is therefore an example of an offset equation as described herein, and can be theoretically derived. For example, the motor speed in RPM=N_{spikeCounts}/samplingPeriod/N_{motorPoles}). A more indirect measurement approach for motor speed can also be utilized. For example, control based on current level, such as where constant load can be assumed and/or held constant.

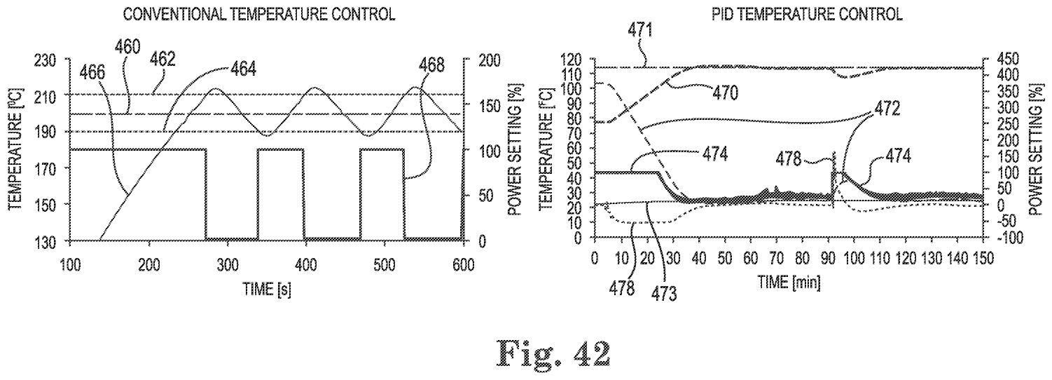

FIG. 42 shows a conventional temperature control scheme compared graphically to an example PID temperature control scheme contemplated herein.

As shown in the conventional temperature control scheme of FIG. 42, a set temperature is shown at 460, temperature limits (upper and lower) and shown as 462 and 464, respectively, temperature is shown at 466, and power is shown at 468. As shown, the power 468 is cycled between 100% and 0%. The control shown is simple, and reactive rather than predictive. The convention temperature control scheme shown therefore has oscillating, imprecise behavior.

As shown in the PID temperature control scheme of FIG. 42, a set temperature is shown at 471, temperature is shown at 470, a proportional power setting is shown at 472, an overall power setting is shown at 474, an integral power setting is shown at 473, and a derivative power setting is shown at 478. As shown, the power setting is adjusted in real time in order to more finely control the temperature response. Also as shown, three components, including proportional, integral, and derivative, are used to predict the behavior of the system. The result is smooth, precise behavior as shown.

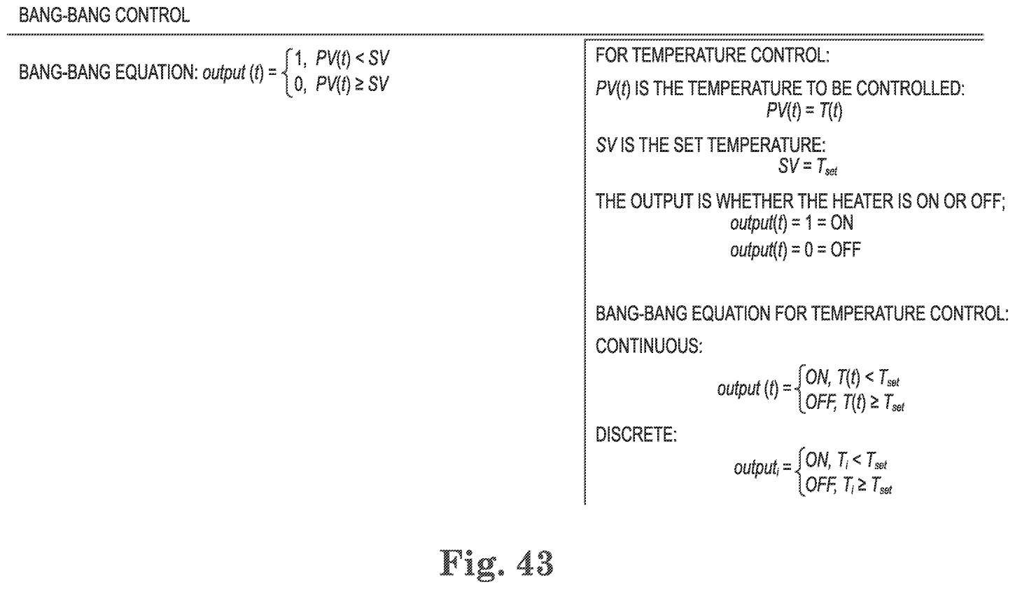

FIGS. 43-47 show various examples of “bang-bang” control. Bang-bang control is an example of a control scheme to which performance of PI/PID control can be compared. Bang-bang control can include full on or full off power to an active element. Bang-bang control works by having a set temperature, below which power is set to 100% and above which, the power is shut off. If there is a dead band, there are two different set points for these on and off points. This is how traditional thermostats operate but it can also be used in digital applications. For example, the slow cook high, low, and warm settings on a modular multi-cooker can use bang-bang control with an NTC because temperature precision & reaction is less sensitive compared to sous-vide cooking. The low switching frequency helps extend the lifetime of a mechanical relay.

According to FIG. 43, bang-bang control can utilize an equation as shown. According to the equation, PV(t) is the process variable, i.e., the variable that is being controlled. As shown, SV is the set value, i.e., the desired value for the process variable. With bang-bang control, the output is either high (1) or low (0) since only these discrete extreme output values are used, and the process variable generally oscillates.

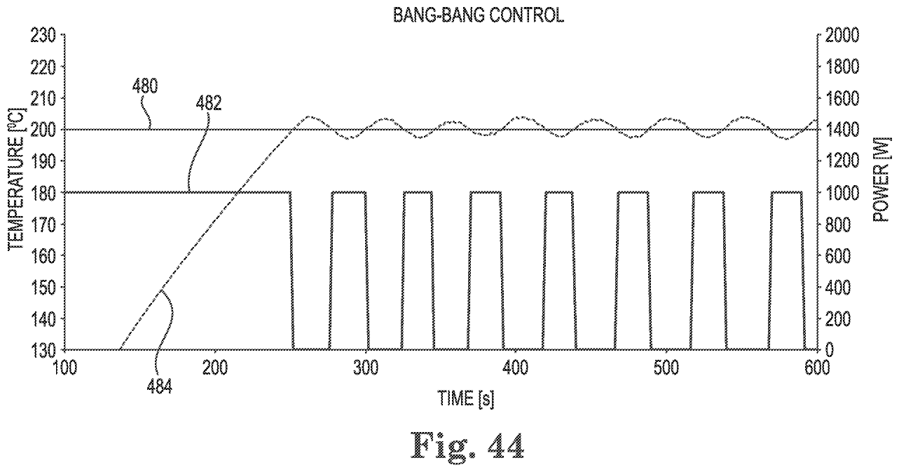

As shown in FIG. 44, bang-bang control is illustrated, including a set temperature 480, an (actual) temperature 484, and a power level 482.

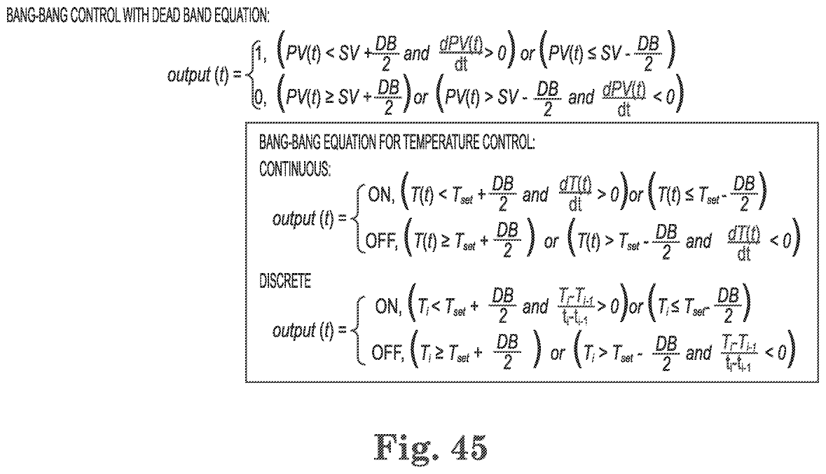

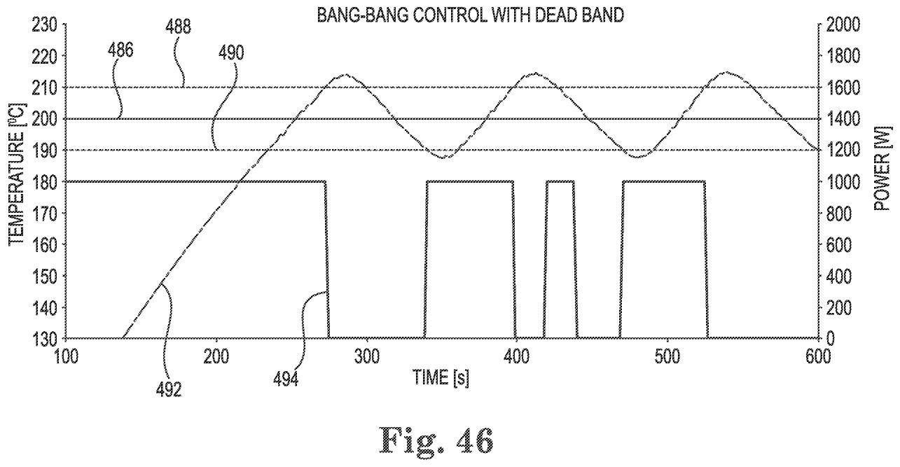

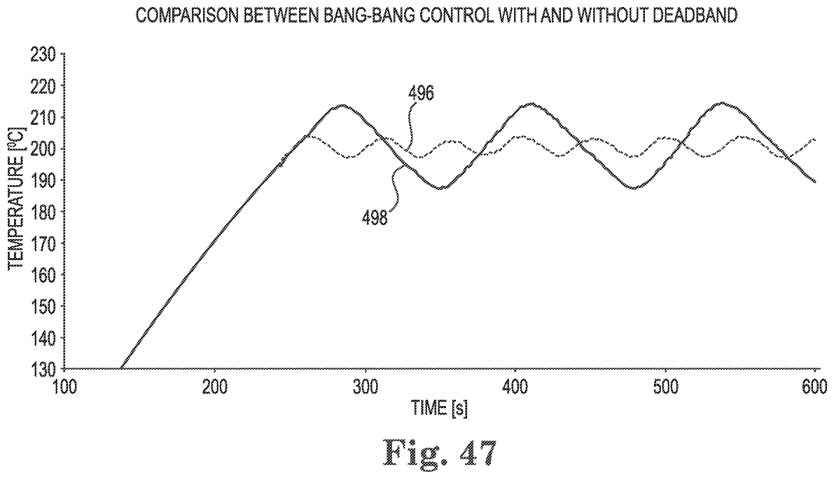

As shown in FIGS. 45 and 46, a dead band can be incorporated in which the bang-bang on/off operation is delayed within a certain range, e.g., temperature range. Using a dead band can reduce oscillation frequency and can lead to larger temperature variations over time as shown in FIG. 47. When a dead band is added, the control output does not switch until the process variable deviates from the set value by (DB)/2. This works hysteresis into the controller, reducing switching frequency, but increasing the oscillation amplitude. As shown in FIG. 46, bang-bang control with dead band can produce results as shown. According to FIG. 46, the set temperature is shown at 486, an upper dead band limit is shown at 488, a lower dead band limit is shown at 490, an (actual) temperature is shown at 492, and a power level is shown at 494. Referring again to FIG. 47, a comparison is shown between bang-bang control with and without a dead band, and resulting temperature with dead band (without dead band) is shown at 496, and resulting temperature with 20° C. dead band is shown at 498.

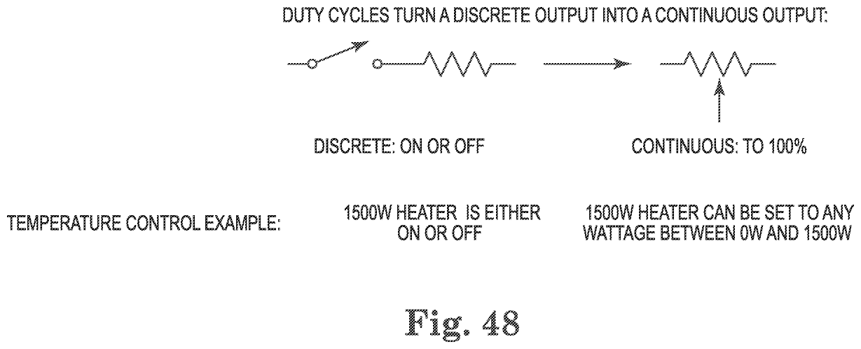

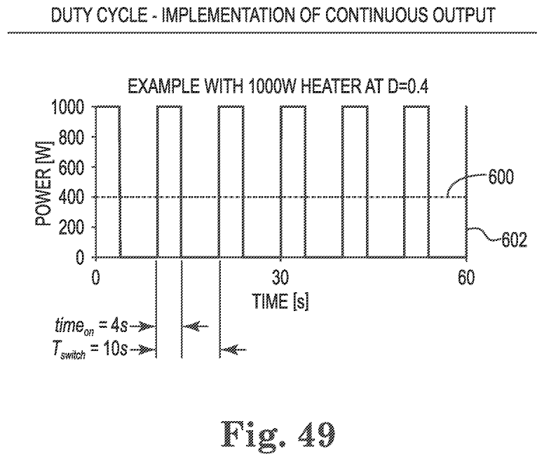

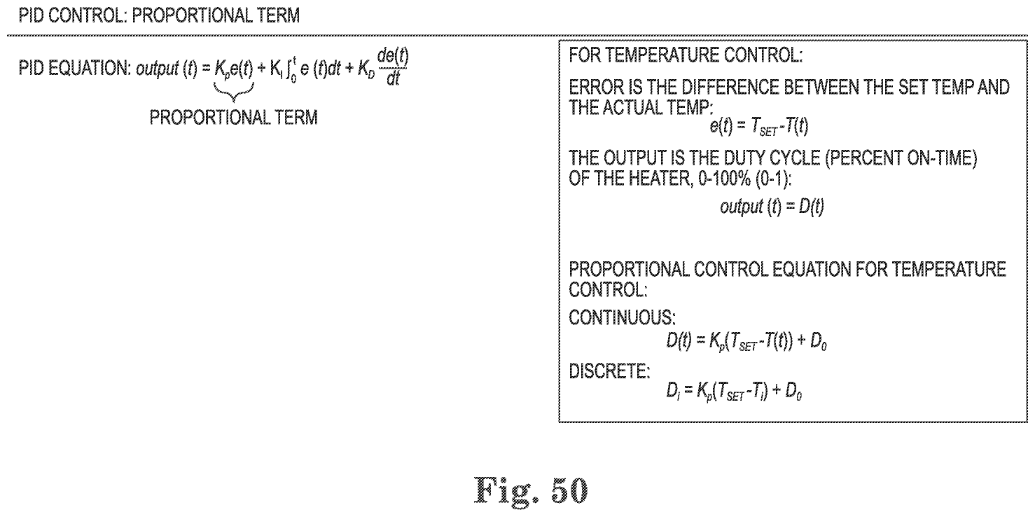

FIGS. 48 and 49 show an example of duty cycle used to turn a discrete output into a continuous output is shown, according to various embodiments.

In more detail, FIG. 48 shows a duty cycle, including an implementation of a continuous output. With reference to FIG. 49, and as shown, to vary power output of a resistive heater, the voltage is varied as follows: P=V²/R. In some cases, it can be impractical to vary voltage, so cycling a heater on/off at a first frequency 1/T_{switch} can give a desired average power: timeₒₙ=DT_{switch}, where: T_{switch} is the switching period (cycle time), D is the duty cycle (percentage of time on), and time_{ON} is the time the heater is on during each cycle. In various embodiments, a T_{switch} should be selected such that performance is sufficient, but also such that the switching device does not fail during the life of the product. As shown in FIG. 49, average power (W) is shown at 600, and output power (W) is shown at 602.

FIGS. 50-56 show various control equations and details for continuous and discrete examples.

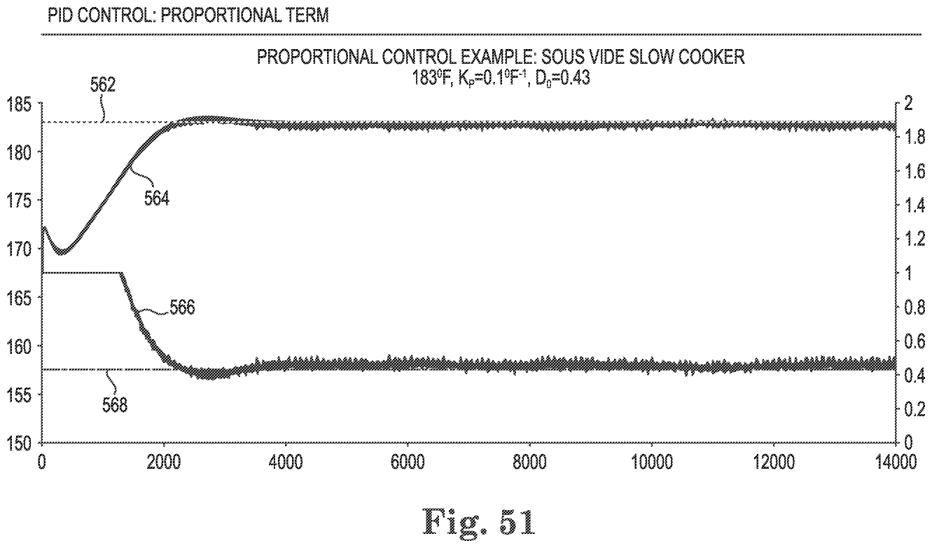

FIGS. 50 and 51 illustrate the proportional term of PID control in additional detail, according to various embodiments. As shown in FIG. 50, the proportional term of PID control is shown in greater detail. As shown, K_{P} is the proportional gain, which directly multiplies the error e(t) to define the output. Also, as the error approaches zero, so does the output. Because of this, when proportional control is used without integral and derivative terms, and the addition of a constant to the output is usually needed to maintain the desired set point when there is no error: output(t)=K_{P}*e(t)+output₀. Without combination with integral or derivative terms, proportional control generally has some steady state error. As shown in FIG. 51, a proportional control example of a sous-vide slow cooker is shown. A set temperature is shown at 562, a D₀ is shown at 568, a temperature is shown at 564, and a duty cycle D is shown at 566. Also as shown in the example of FIG. 51, the set temperature is 180° F. (82.2° C.), K_{P}=0.1° F.⁻¹, and D₀=0.43.

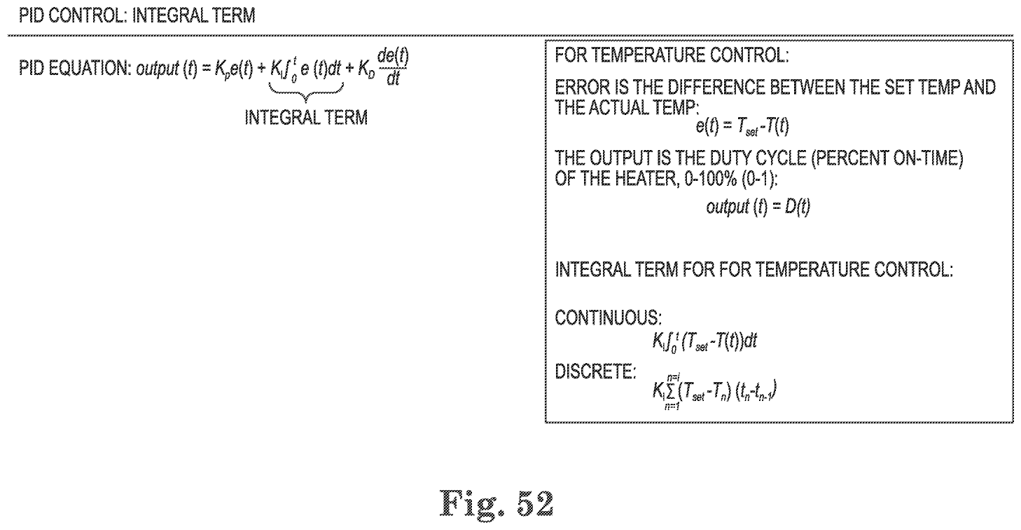

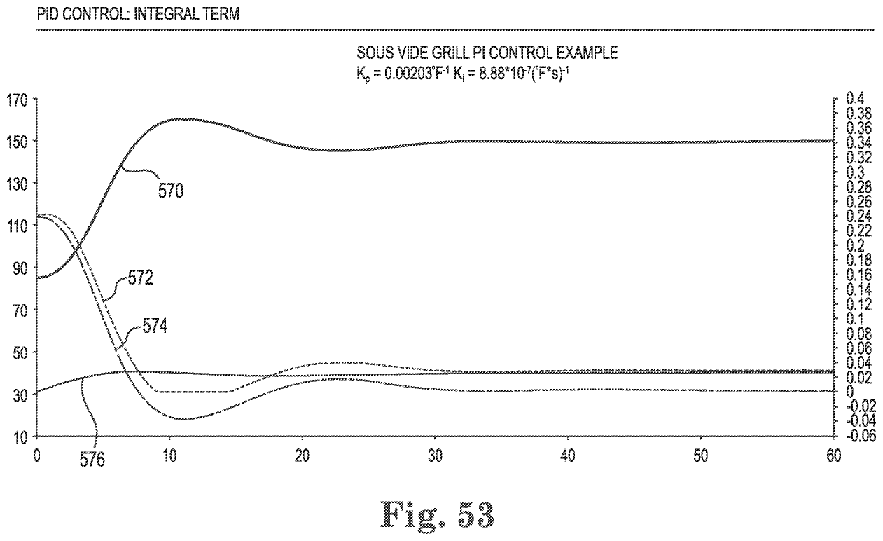

FIGS. 52 and 53 illustrate the illustrate term of PID control in additional detail, according to various embodiments.

FIG. 52 shows an example integral term of a PID equation in greater detail. As shown, the integral error, ∫₀^{t}e(t)dt, is the sum of the error from the time the controller started until the present time, t. K_{I} is the integral gain and multiplies the integral. As error is accumulated, the integral term adjusts the output to approach the set point. When proportional and integral terms are combined, there will be no steady state error.

FIG. 53 shows a sous-vide PI control example. Temperature is shown at 570, D is shown at 572, D contribution from K_{P} is shown at 574, and D contribution from K_{I} is shown at 576. Also, in the example as shown, K_{P}=0.00203° F.⁻¹, K_{I}=8.88*10⁻⁷ (° F.*s)⁻¹.

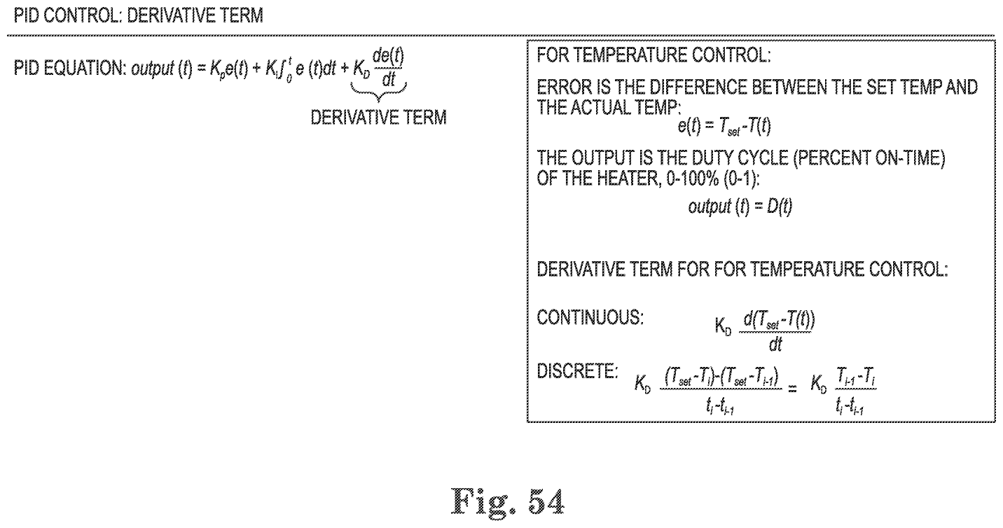

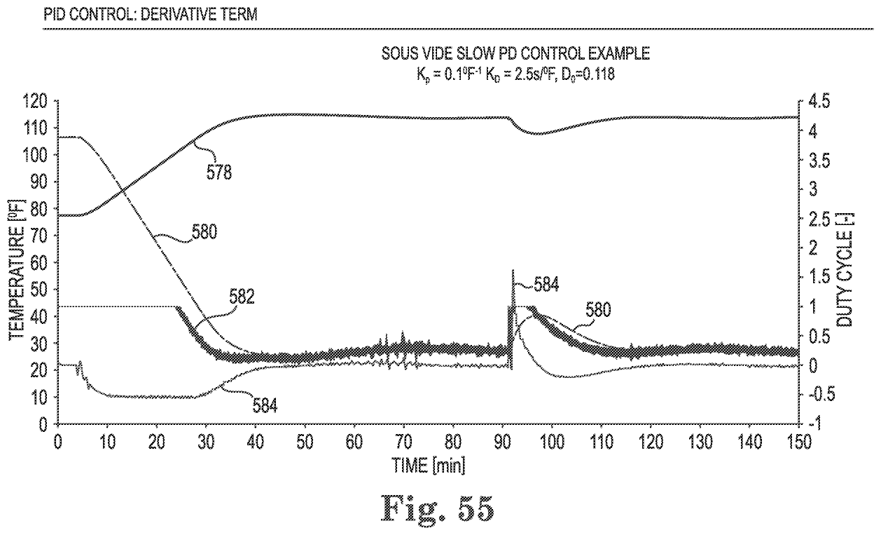

FIGS. 54 and 55 illustrate the derivative term of PID control in additional detail, according to various embodiments.

FIG. 54 shows an example derivative term of a PID equation in greater detail. The derivative error, de(t)/dt, is the rate of change of the error as a function of time, t. K_{I} is the integral gain and multiplies the integral. As error is accumulated, the integral term adjusts the output to approach the setpoint. When proportional and integral terms are combined, there will be no steady state error.

FIG. 55 shows a sous-vide PD control example (e.g., at least proportional and derivative components of PID control). Temperature is shown at 578, D is shown at 582, D contribution from K_{P} and D₀ shown at 580, and D contribution from K_{D} is shown at 584. Also, in the example as shown, K_{P}=0.1° F.⁻¹, K_{D}=2.5 (s/° F.), and D₀ is 0.118.

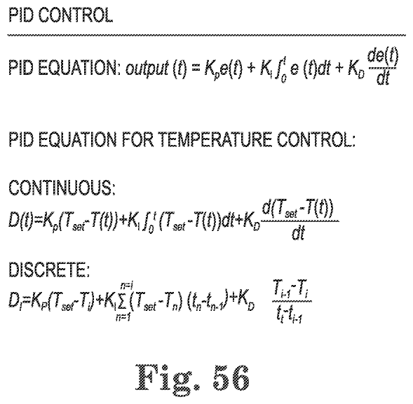

FIG. 56 shows continuous and discrete equations for PID temperature control, according to various embodiments.

For the examples that follow, the following terms can be defined as follows:

Measured Variable: The input to the control loop. Set Variable: the variable that is sought to be controlled. Output Variable: The output of the control loop. E.g., designed to vary a duty cycle or other variable(s) to achieve suitable or similar results. Output Hardware: Hardware switching device or method to be used to control power output, e.g., mechanical relay, SCR, TRIAC, high-frequency PWM, and the like. Response Delay Time: how quickly a change in power can be measured. This can be important with regard to determining relay cycle time and K_{I}. Response Delay Time can be provided in general, order of magnitude ranges. Subject to Measured Variable Spikes? Whether sudden spikes or drops in the measured variable are expected, e.g., a load added or removed. Important for K_{I} and consideration of duty cycle (D) control. Measurement Offset: How does the measured variable relate to the set variable? Heating Rate/Power: how quickly the controller can reach a set point at full power. This can be useful for K_{P} and cycleTime. Cooling Rate: how limited is the system by depending on natural convection to respond to overshoot and the like? This can be important toward K_{I} measurement offset, and cycleTime. Usefulness of Derivative Control: used to eliminate steady state oscillations, to decrease overshoot, and better respond to sudden changes in the measured variable. Measurement Noise: is there a high Measurement error to consider? This is generally applicable where duty cycle D control is used or needed. Other Considerations: anything else to note that unique or special to a particular application or varies from other use cases (e.g., multiple measured variables, removable probe, flow-through application, etc.)

We turn now to several examples of the improved control schemes described above in more specific embodiments. The embodiments are not meant to be construed as limited and merely represent some possible combinations and features of contemplated examples.

The following Examples describe appliances may each operate and have control similar to the container cookers, such as slow cooker 10, or modular cooking appliances 310 or 374 described above and may include one or more or all of the features described in connection with FIGS. 1 to 30, including direct or indirect temperature or other measured variable sensing. For example, the features described with respect to the slow cooker 10, or modular cooking appliances 310 or 374, such as direct or indirect temperature sensing and control with or without an offset equation, may apply to each of the following appliances. The features described with respect to the following appliances may be combined and adapted to each appliance, and are not meant to be construed as limiting.

Example 1: Sous-Vide Slow Cooker. A sous-vide slow cooker can be similar to the above examples of container cookers, such as slow or multi-cookers. A measured variable of the sous-vide slow cooker may be a water temperature and set variable may be a water temperature. The output variable can be a duty cycle, on the output hardware can include a mechanical relay. Measured variable spikes can be experienced in the form of cold food load added to the cooker. A cooling rate can be relatively high and an enclosed pot/vessel can be used. An example cycle time can be about 1-2 minutes. In some embodiments, a temperature sensor is user-removable. The integral constant K_{I} can be a function of Tₛₑₜ. Both PI and PID control options are contemplated. Either direct or indirect temperature detection are contemplated in accordance with FIGS. 1-30.

Example 2: “Low-Cost” Multi-cooker. For this example, and as discussed above, a measured variable can include a pot surface temperature, and a set temperature can include a water temperature. An output variable can include a duty cycle, and example output hardware can include a mechanical relay. Example response delay time can be about 15-90 seconds. Measured variable spikes can include receiving a cold food load during operation. A measurement offset can be a defined equation relating Tₛₑₜ and Tₚₒₜ. A cooling rate can be relatively low with lower heat capacity and a relatively large exposed convection surface area. Examples of cycle times can range from about 10 to about 90 seconds. Both PI and PID control options are contemplated. A removable direct temperature-sensing probe can be included. Either direct or indirect temperature detection are contemplated in accordance with FIGS. 1-30.

Example 3: Multi-cooker (e.g., with Air Fry function). An example multi-cooker with an air fry function can be functionally similar to Example 2, above. Either direct or indirect temperature detection are contemplated in accordance with FIGS. 1-30.

Example 4: Contact Grill. An example contact grill can be similar to the appliances of Examples 2 and 3, and a measured variable can be a temperature of a top plate, e.g., a back side of the top plate. An example response delay time can be 5-90 seconds. Some measurement offset can be present. For example, the set temperature of a program or process can be calibrated such that a temperature at a plate surface is at a desired temperature. An offset equation such as described above can be implemented for indirect temperature control. A contract grill can cool slower than it heats. An example cycle time can be about 5-90 seconds. Both PI and PID control options are contemplated. Precision of temperature control can acceptably include some error, and a user may not receive a display of an actual temperature during operation. Either direct or indirect temperature detection are contemplated in accordance with FIGS. 1-30.

Example 5: Surface Grill. An example surface grill can be similar to the contact grill of Example 4, and the multi-cooker of Example 2. A measured variable can be a plate temperature, e.g., measured with a probe at an end of the plate, and a set variable can be a plate surface temperature. The output variable can be a duty cycle, and output hardware can include a mechanical relay. A response delay time can be about 5-60 seconds. A temperature feedback location is contemplated off to a side compared to Example 4, and thus reactions can be slower than the contact grill example, and a measurement offset can also be greater than the contact grill due to feedback location being further from bulk of heat source. Cold food load can lead to measured variable spikes. Cooling rate can be slower than heating rate but faster than contact grill because cooking surface is directly exposed for free convection. A cycle time can be about 5-60 seconds. Both PI and PID control options are contemplated. A removable probe can be utilized, and some temperature precision uncertainty can be considered acceptable. Either direct or indirect temperature detection are contemplated in accordance with FIGS. 1-30.

Example 6: Rice Cooker. An example rice cooker can be similar to the multi-cooker of Example 2, and configured for rice cooking. Either direct or indirect temperature detection are contemplated in accordance with FIGS. 1-30.

Example 7: Waffle Iron. An example waffle iron can be similar to the contact grill of Example 4, and configured to waffle cooking. Either direct or indirect temperature detection are contemplated in accordance with FIGS. 1-30.

Example 8: Pressure Cooker. A pressure cooker can also be configured to utilize improved control schemes described herein. For example, a measured variable and set variable can both be air temperature and/or steam temperature. An output variable can be a duty cycle and output hardware can include a mechanical relay. A response delay time can be about 10-90 seconds. A measurement offset may not be utilized as same measured and set variables. A relatively slow cooling rate can be observed with a relatively high heat capacity and an enclosed pot. Both PI and PID control options are contemplated. Either direct or indirect temperature detection are contemplated in accordance with FIGS. 1-30.

Example 9: Iron. An electric clothes iron can also utilize control schemes described herein, e.g., for heating a soleplate of the iron and/or heating steam within the iron. See also FIG. 34. A measured variable can be a boiler and/or upper soleplate temperature. A set variable can be a soleplate temperature. An output variable can be a duty cycle, and output hardware can include a mechanical relay. A response delay time can be about 2-60 seconds. A measured variable spike can be observed, e.g., when the iron soleplate contacts a cool garment or fabric. A measurement offset can be present as the boiler temperature can be different than the soleplate temperature, and can be related using an offset equation. A measurement offset can be affected by a steaming function of the iron being active or inactive. A cycle time can be about 5-90 seconds. Both PI and PID control options are contemplated. Either direct or indirect temperature detection are contemplated in accordance with FIGS. 1-30.

Example 10: Kettle. A water-heating or water-boiling kettle can have measured and set variable of a water temperature. Output variable for control can be a duty cycle or limited power regulation. A cooling rate can be relatively slow with a large heat capacity and an enclosed pot. Both PI and PID control options are contemplated. Either direct or indirect temperature detection are contemplated in accordance with FIGS. 1-30.

Example 11: Flow-through Water Heater. Flow-through water heaters (see also FIG. 36) can be used for heating water, such as for household uses and coffeemakers, etc. A measured variable can be, e.g., a water output temperature or a heater temperature in various embodiments. A set variable can be water output temperature. An output variable can be a pump voltage or duty cycle. In preferable embodiment, a pump operation can be modulated with a constant power level at a heater of the flow-through water heater. Output hardware can include TRIAC, SCR, or mechanical relays. A response delay can be very short, such as less than 5 seconds. Measured variable spikes can be observed, e.g., ambient temperature before water flow commences. Measurement offset can be included in not same variable, such as heater temperature with offset compared to output water temperature. A cooling rate can be relatively fast since ambient temperature water is input and flowed through heater unit. Cycle time can be less than 5 seconds, or even less than one second. Both PI and PID control options are contemplated. Liquid is forced through a heater by a pump. The output temperature of the water is measured, and the pump speed and/or heater power is be regulated to control to the water output set temperature. The heater power is typically held constant at 100% and the pump speed is varied to control the output water temperature. ECBC coffee maker certification requirement: The temperature at the grounds must reach 92° C. (197.6° F.) within 1 min and then remain in the range of 92-96° C. (197.6-204.8° F.) for the remainder of the cycle. It may be easier to meet this requirement with a flow-through heating application. Conventional coffee maker operation: Gravity-driven flow generally to the heater; Boiling in the heater forces the water to the shower head. There is a check valve upstream of heater so that boiling water is forced to shower head instead of back into the tank; Temperature feedback location is generally on the heater body, and takes the form of a temperature sensor or NTC. Therefore, in conventional coffeemakers, there is no temperature regulation, just 100% power on the heater until reservoir or water feed runs dry and temperature runs away; at which point the temperature sensor stops the brew cycle. Either direct or indirect pump motor speed, torque, power, or other parameter detection are contemplated. Either direct or indirect temperature detection are contemplated in accordance with FIGS. 1-30.

Example 12: Hair Straightener or Curling Iron. Electric hair straighteners and curling irons are similar devices with a heating plate or barrel for straightening or curling hair, respectively. A measured variable can be a heater temperature, and a set variable can be a plate/barrel surface temperature. An output variable can be a heater duty cycle, with output hardware of SCR, TRIAC, or other solid-state control. A response delay time can be very short, under 5 seconds or even under one second. A measured variable spike can be observed based on a received hair load at the barrel/plate being heated. A measurement offset can be included with a defined equation relating Tₕₑₐₜₑᵣ and T_{plate/barrel}. A PTC heater can be used to heat the plate/barrel. Cycle time can be about 1-10 seconds. Integral error can be reset for every set temperature to some initial value and an integral accumulation band can also be used to prevent wind-up. Both PI and PID control options are contemplated. Either direct or indirect temperature detection are contemplated in accordance with FIGS. 1-30.

Example 12: Toaster Oven (or Air Fryer). A toaster oven or air fryer can also use the PI/PID schemes discussed herein, and can have operation that is similar to the Examples above, with some changes. Various heating, such as resistive or other heating elements can be used. A measured variable can be air temperature (within a cooking cavity) and a set variable can also be the air temperature. An output variable can be duty cycle or power regulation in various embodiments. Response delay time can be about 2-45 seconds, and the cooking process can be subject to measured variable (temperature) spikes, such as by the introduction of cold food to the cavity or by a user opening a door to the cavity. As the air temperature is the set and measured variable, an offset equation may not be utilized in some embodiments accordingly. The example toaster oven or air fryer can have a rate of cooling that increases as the temperature increases, such as at higher set temperatures. A cycle time can be about 20-90 seconds. In various embodiments, various steam detection and/or control aspects can also be introduced. Fan speed, particularly in example of convection cooking and air frying can also be controlled using schemes described herein. Both PI and PID control options are contemplated. Either direct or indirect temperature detection are contemplated in accordance with FIGS. 1-30.

The following appliances and devices may each operate and have control similar to the motor aspects described with reference to any of FIGS. 35 and 38-41 herein and may include one or more of the features described in connection with FIGS. 1 to 30 (or any other Fig. herein) as applicable to motor control. For example, the features described with respect to the motor control flowchart of FIG. 35 may apply to each of the following appliances. The features described with respect to the following appliances may be combined and adapted to each appliance, and are not meant to be construed as limiting.

Example 13: Blender (e.g., a Smart Blender). As a first example of a motor-controlled embodiment, a blender or smart blender is contemplated. A blender motor can have motor speed measured in revolutions per minute (RPM) using, e.g., a Hall-effect sensor or the like. Thus, a measured variable is the motor RPM, and the set variable can also be the motor RPM. As discussed herein, motor speed can be detected directly or indirectly, and in indirect cases, an offset equation can be used to related set and measured variables for motor control. Output variable can be, e.g., a TRIAC phase and the output hardware can be a TRIAC. Response delay time can be very fast, such as under 5 seconds. Measured variable spikes can be experienced, such as hard objects and cavitation within the blender's jar. Both PI and PID control options are contemplated. Either direct or indirect motor speed, torque, power, EMF, back-EMF, or other parameter detection are contemplated.

Example 14: Mixer. A motor-based mixer or mixing appliance can have similar control characteristics to the blender of Example 13, above. A mixer may use less power during operation, and may be subject to measured variable spikes based on dough or other substances to be mixed. Either direct or indirect motor speed, torque, power, or other parameter detection are contemplated.

Example 15: Food Processor. A motor-based food processor can have similar control characteristics to the blender of Example 13, above. A food processor may use less power during operation than the blender. Either direct or indirect motor speed, torque, power, or other parameter detection are contemplated.

Example 16: Blow Dryer. A blow dryer is an example of a forced-air and heating appliance. A blow dryer can be similar to the flow-through water heater of Example 11, above. A quantity of heat to be transferred to a user's hair can be modulated based on heater or blower fan operation. In one example, a measured variable can be air temperature, and a set variable can be air temperature (same as measured variable) or hair temperature. Where the measured and set variables are different, an offset equation can be utilized to relate the two variables. An output variable can include duty cycle or power regulation, and output hardware can be any of several options, such as solid-state or mechanical relays, and can control temperature and/or flow rate of the air being heated. Response delay time can be very fast, including 5 seconds or less and operation can be subject to variations in ambient temperature but relatively few spikes as hair to be heated is at a distance from the blow dryer. A cooling rate can be very fast due to configuration of high flow through the appliance. Both PI and PID control options are contemplated. Either direct or indirect motor speed, torque, power, or other parameter detection are contemplated. Either direct or indirect temperature detection are contemplated in accordance with FIGS. 1-30.

Example 17: Shaver. An electric shaver is a motor-based device that can operate according to various motor control schemes of the above examples. In some cases, a shaver can use Hall-effect sensors for RPM detection. Alternatively, and as described further below, commutation spikes can be counted to operate as a proxy for motor speed detection within a shaver. The measured variable can be motor RPM, and set variable can also be motor RPM. Preferably, output hardware within the saver is solid-state, such as a TRIAC. Response delay is preferably less than about 5 seconds. Varying shaver load can subject the shaver to measured variable spikes. A cycle time is preferably fast, such as less than 5 seconds to reduce or prevent oscillation. Either direct or indirect motor speed, torque, power, or other parameter detection are contemplated.

We next turn to aspects of motor control involving counting of commutation spikes for a DC motor, in greater detail. In particular, counting of commutation spikes for DC motor control can be applied to electric shavers. However, counting on commutation spikes can be used for any electric motor-based implementation including other motor-based appliances and devices.

With reference to FIG. 38, an example DC motor 268 is shown schematically that works by passing a current through coils of wire. This creates a magnetic field that makes the rotors align with permanent magnets mounted in the stator. However, the magnetic fields of the rotor flip at a certain point in the rotation. If they did not flip, the rotor would align to a fixed rotation. Flipping this direction is done by a commutator 272. While spinning in the motor the commutator 272 disconnects from the positive and negative terminals, e.g., via brushes 274, then reconnects with the opposite polarity brush 274. It does this in a manner that flips the magnetic fields. This act of disconnecting the commutator 272 causes a quick discharge of the magnetic field stored in a motor winding 270. This can be seen as a spike in voltage across the motor terminals. Voltage spikes are present in the power supply due to the motor spinning. The frequency of the spikes is logically, therefore, also proportional to the motor speed.

With reference now to FIG. 39, a circuit 276 is shown. Knowing the frequency is proportional to the motor speed (see also FIG. 40), the first step in the circuit 276 is to filter the spikes. These spikes are very fast, so a high-pass filter 282 can be used to separate the signal from the DC voltage. Next, the filtered signal 278 is passed through either an op-amp or a transistor at 280. This isolates the signal so it can be measured with a microcontroller without affecting the filter circuit. Finally, just the voltage (commutator) spikes from the motor are left at 284 and can be read to give motor RPM output signal.

Most microcontrollers have one or more feature called “external interrupts.” These external interrupts can trigger functions in the programming when voltage passes a certain threshold on a specific pin of the microcontroller. These external interrupts can happen in the background, so the microcontroller can continue operating while these external interrupts are being counted. This means the commutation spike counter can be connected to a pin on the microcontroller for counting spikes. Ultimately, a value that's proportional to the speed of the motor is the result. The actual RPM of the motor is the number of spikes per minute divided by the number of commutator sections, e.g., 2 as shown in FIG. 38. An example of program code for counting commutator spikes is shown below at Table 1. Table 1 is an example of pseudo code for measuring a motor speed using commutation power spikes according to the circuitry of FIG. 39, according to various embodiments. The function of Table 1 is triggered whenever a microcontroller senses a falling voltage. In the present example, the microcontroller is sensing commutation spikes.

TABLE 1

uint16_t commutation spikes ;
ISR (INTO_vect)
{
Commutation_spikes ++;
}

FIG. 40 is a chart showing measured tachometer rate 286 vs. commutator spike rate 288. As shown, a linear relationship results and can be verified between tachometer read RPM and commutator counts. This provides further evidence that commutator counts can be used as the process variable for closed-loop speed control system.

FIG. 41 shows DC motor commutation spikes and PID performance. As shown, a setpoint 290 is shown, along with measured speed 294 and PWM 292. As shown, the implementation of a PID control loop verifies that the commutation spike count value can be used as the process variable to control a motor speed, e.g., of an electric shaver as contemplated herein.

In various embodiments, to count commutator spikes, components to be utilized can include a resistor, a capacitor, an op-amp, a transistor, and a microprocessor with 2 kHz interrupt, or the like, and combinations thereof.

Applicant hereby incorporates by reference the filed U.S. Provisional Patent Application with Ser. No. 63/084,826 entitled “APPLIANCE WITH MODIFIED PROPORTIONAL-INTEGRAL CONTROL” filed Sep. 29, 2020, and U.S. Provisional Patent Application with Ser. No. 62/992,528 entitled “MODULAR MULTI-COOKER” filed Mar. 20, 2020 in their entireties for all purposes.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. The implementations described above and other implementations are within the scope of the following claims.

1. An electrical appliance, comprising:
a controller operatively connected to a power circuit, a control circuit, a power source, a sensor for sensing a parameter level, and an active element; and
the controller configured to receive an input of the parameter level from the sensor and to output a duty cycle for controlling a power level of the active element via the control circuit at various times to achieve a target set point of the parameter, the duty cycle based on proportional and integral control,
wherein the controller uses the proportional control and the integral control when the control circuit is energized, and accumulates integral error only when a parameter process variable sensed by the sensor is determined to be within an interval of the target set point.

2. The electrical appliance of claim 1, wherein the interval is defined based on at least a proportional constant, an integral constant, and an integral error.

3. The electrical appliance of claim 2, wherein the interval is further defined based on the target set point and the sensed process variable.

4. The electrical appliance of claim 3,
wherein the interval is defined as having a minimum defined as the target set point minus a reciprocal of a proportional gain constant plus the integral constant times the integral error divided by the proportional constant, and
wherein the interval is defined as having a maximum defined as the target set point plus the integral constant times the integral error divided by the proportional constant.

5. The electrical appliance of claim 2, wherein the interval is defined as having a maximum based on a reciprocal of the proportional constant.

6. The electrical appliance of claim 2, wherein the interval is defined as having a maximum based on a product of the integral constant and integral error.

7. The electrical appliance of claim 2, wherein the interval is defined as having a maximum based on an addition of a value to the target set point, wherein the value is based on a product of the integral constant and integral error divided by the proportional constant.

8. The electrical appliance of claim 2, wherein the interval is defined as having a minimum based on an addition of a value from the target set point, the value based on a product of the integral constant and integral error divided by the proportional constant.

9. The electrical appliance of claim 1, wherein the integral error is calculated based on a parameter level reading at the sensor, the target set point, and a time interval.

10. The electrical appliance of claim 1, further comprising a switching device operatively connected to the controller and the active element, such that a signal received by the controller selectively powers the active element.

11. The electrical appliance of claim 10, wherein the switching device is a relay, a silicon-controlled rectifier, or a TRIAC.

12. The electrical appliance of claim 1, wherein the target set point of the parameter is set by a user.

13. The electrical appliance of claim 1, wherein the sensor is a probe comprising a negative thermal coefficient thermistor.

14. The electrical appliance of claim 1, wherein the controller sets a power level of the active element using the reading of the parameter at the sensor using a lookup table.

15. The electrical appliance of claim 1, wherein the active element is an electrically powered heating element.

16.-21. (canceled)

22. The electrical appliance of claim 15, wherein the controller is further configured to relate the input of the parameter level from the sensor and to the target set point of the parameter using a predefined offset equation.

23. The electrical appliance of claim 1, wherein the duty cycle is further based on derivative control.

24.-25. (canceled)

26. A controller for use with an electrical appliance, comprising:
a processor operatively connected to a memory;
the controller operatively connected to a power circuit, a control circuit, a power source, a sensor for sensing a parameter level, and an active element; and
the controller configured to receive an input of the parameter level from the sensor and to output a control signal for controlling a power level of the active element at various times via the control circuit to achieve a target set point of the parameter, the control signal output based on proportional and integral control;
wherein the controller uses the proportional control and the integral control when the control circuit is powered on, and accumulates integral error only when a process variable sensed by the sensor is determined to be within an interval of the target set point.

27.-30. (canceled)

31. An electrical heating appliance, comprising:
a controller operatively connected to a power circuit, a control circuit, a power source, a sensor for sensing a parameter level, and an active element; and
the controller configured to receive an input of the temperature level from the sensor and to output a control signal for controlling a power level of the heating element at various times via the control circuit to achieve a target set point of the temperature, the control signal output based on proportional and integral control,
wherein the controller uses the proportional control and the integral control when the control circuit is powered on, and accumulates integral error only when a temperature process variable sensed by the sensor is determined to be within an interval of the target set point temperature.

32. The appliance of claim 31, wherein the control signal output comprises a duty cycle, a voltage level, or a pulse-width modulation signal.

33.-45. (canceled)
